(19) United States
(12) Patent Application Publication
(10) Pub. No.: US 2011/0123866 A1
(43) Pub. Date: May 26, 2011

(54) Methods and systems for making electrodes having at least one functional gradient therein and devices resulting therefrom

(76) Inventors: Lawrence S. Pan, Los Gatos, CA (US); Shufu Peng, Sunnyvale, CA (US); Anna Lynne Heinkel, Coyote, CA (US)

(21) Appl. No.: 12/876,035

(22) Filed: Sep. 3, 2010

Related U.S. Application Data
(60) Provisional application No. 61/275,900, filed on Sep. 3, 2009.

(51) Int. Cl. H01M 4/525; H01M 4/62; H01M 4/485; H01M 4/04

(52) U.S. Cl. 429/221; 429/232; 429/231.5; 427/58; 427/458

(57) ABSTRACT

The invention disclosed herein provides for methods and apparatuses that yield electrodes having at least one functional gradient therein. In many embodiments, the electrodes comprise an electrode matrix having a plurality of layers, where at least two of the layers differs functionally, in composition, structure, or, organization. High-throughput electrode screening apparatuses are disclosed that include array formers and testers. Electrodes and battery cells arising from the methods and apparatuses disclosed herein are likewise disclosed. The methods, apparatuses, and resulting electrode and cell devices are, in some embodiments, ideally suited for use in lithium-ion batteries.

### CROSS-REFERENCE TO RELATED APPLICATIONS

Not Applicable

### STATEMENT REGARDING FEDERALLY SPONSORED RESEARCH OR DEVELOPMENT

Not Applicable

### NAMES OF PARTIES TO A JOINT RESEARCH AGREEMENT

Not Applicable

### SEQUENCE LISTING

Not Applicable

### FIELD OF THE INVENTION

The invention generally relates to the field of battery electrode manufacturing, preferably lithium-ion battery electrode manufacturing. The invention generally pertains to the field of energy storage, batteries, lithium-ion (Li-ion) batteries, advanced vehicles technology, and reduction of national reliance upon foreign petroleum products. The invention also relates to manufacturing systems for applying a coating or coatings to surfaces of substrates. The invention further relates to the field of energy efficiency, and environmental protection.

### BACKGROUND

Lithium ion batteries play an important part in today's high-technology world. Reaching new markets, lithium ion batteries offer the promise of high energy capacity/high power output in relatively lightweight and compact formats when compared to traditional lead acid, nickel metal hydride, or nickel cadmium batteries

Secondary batteries, also know as rechargeable batteries, generally comprise the following eight components: 1) a cathode current collector; 2) a cathode in electrical communication with the cathode current collector; 3) an anode current collector; 4) an anode in electrical communication with the anode current collector; 5) a separator situated between the anode and cathode to prevent their direct contact, the separator being ion permeable and electrically non-conductive; 6) an electrolyte salt; 7) a solvent capable of solvating the electrolyte salt; and, 8) a housing to contain and protect the preceding seven parts. Lithium-ion batteries are very popular for portable electronic devices and handheld power tools. A growing interest in lithium ion batteries has emerged in the transportation industry in an effort to reduce emissions and reliance on foreign sources of oil by improving vehicle fuel efficiency. Lithium ion batteries typically are manufactured by coating aluminum and copper foils with cathode and anode materials, respectively. To form a cell, the electrodes are mated with the separator therebetween with the cathode and anode materials facing separator. The separator typically is a one or three ply polymer sheet that is ion porous and is electrically non-conductive. The electrodes must not come in contact, otherwise, electrical short circuit between the electrodes may arise potentially resulting in thermal runaway.

Electrodes of the prior art are homogenous matrices comprising active material particles, conductive particles, and, optionally, a binder polymer. The particles and other constituents are blended in a solvent to form a slurry. The slurry is then coated onto a support, typically a current collector foil, often by a roll-to-roll coating process. Popular coating processes include doctor blade coating where a blade is maintained at a given distance from the support material as it moves along, usually perpendicular to the length of the doctor blade. The slurry is fed to the upstream side of the doctor blade and the support material, as it travels by the doctor blade, takes up a thickness of material correlating to the distance of the doctor blade to the surface of the support material.

Typically, the electrodes of the prior art are coated in a single coating step, because multiple coatings steps using a doctor blade can cause delamination and irregular coating thicknesses. The resulting electrodes have a uniform composition throughout the thickness of the electrode.

Storage battery capacity is dependent, in large part, on the amount of coating applied per square unit area of electrode support. The density of a coating is often increased by calendaring the electrode after deposition and drying. Because the electrodes are made in one step, the entire thickness of the electrodes of the prior art are thus subjected to the same amount of compressive force.

The electrodes, and cells arising therefrom, of the prior art have then limitations wherein electrode density is a compromise of density between upper and lower regions of the electrode with respect to the electrode support surface. The prior art electrodes does not optimize for densification in different regions of the electrode. Moreover, because the electrodes of the prior art are cast from a single slurry, the composition of the electrode in different regions is uniform. Again, the prior art electrodes are not optimized for composition in different regions of the electrode. The regions may be distributed along the x, y, or z axis, or any combination thereof. Accordingly, there is a need for a method for making electrodes, and the electrodes arising therefrom having improved performance attributed to optimization of the above mentioned parameters, including, but not limited to, electrode composition, structure, organization, as well as others disclosed herein among different regions within an electrode in any one or combination of x, y, and z dimensions within the electrode. To this end, there is also a need for high-throughput screening methods and apparatus for rapidly screening electrodes having therein differences in electrode composition, structure, organization, as well as others parameters disclosed herein, among different regions within an electrode in any one or combination of x, y, and z dimensions within the electrode.

### SUMMARY OF THE INVENTION

The invention provides for methods and apparatuses that produce electrodes having improved performance attributed to optimization electrode composition, structure, organization, among different regions within an electrode in any one or combination of x, y, and z dimensions within the electrode. The invention further provides for high-throughput screening methods and apparatuses for rapidly screening electrodes having therein differences in electrode composition, structure, organization, as well as others parameters disclosed herein, among different regions within an electrode in any one or combination of x, y, and z dimensions within the electrode.

The invention provides, in one aspect, for an electrode comprising a plurality of layers, each layer comprising active material particles capable of reversibly storing ions; and, conductive particles, wherein the plurality of layers has at least one layer being functionally different from at least one other layer. In some embodiments, the functional difference between layers is a difference in composition, structure, and, organization of the constituents of each layer.

In preferred embodiments, the conductive particles may comprise one or a combination of: buckyballs; buckminsterfullerenes; carbon; carbon black; ketjan black; carbon nanostructures; carbon nanotubes; carbon nanoballs; carbon fiber; graphite; graphene; graphitic sheets; graphite nanoparticles; and, potato graphite. In some embodiments, the functional difference may comprise one or a combination of a compositional difference, an organizational difference; a structural difference, a compositional difference and a structural difference, a compositional difference and an organizational difference, a structural difference and an organizational difference, a compositional difference, a structural difference, and an organizational difference.

In some embodiments, at least one layer may have electrical impedance greater than at least one other layer or an electrical resistance greater than at least one other layer, or both. In some embodiments, at least one layer may be more ionically permeable than at least one other layer.

In some embodiments, at least one layer may have more ion storage capacity than at least one other layer. In some embodiments, the electrode may further comprise at least two of the plurality of layers, wherein at least one layer may comprise more binder polymer than at least one other layer. In some embodiments, at least one layer may comprise more conductive particles than at least one other layer, or, at least one layer may comprise more active material particles than at least one other layer, or both.

In some embodiments, the active material particles may comprise lithium, or the active material particles may comprise a non-lithium metal, or the active material particles may comprise both lithium and non-lithium metals. In some embodiments, the non-lithium metal may be one or a combination of: aluminum; chromium; cobalt; iron; nickel; magnesium; manganese; molybdenum; titanium; and, vanadium. In some embodiments, the active material particles may comprise an oxide of a metal selected from the group consisting of: aluminum; chromium; cobalt; iron; nickel; magnesium; manganese; molybdenum; titanium; and, vanadium. In highly preferred embodiments, the active material may further comprise iron phosphate or lithium iron phosphate. In some embodiments, the active material particles may comprise a conventional cathode active material used in lithium ion secondary batteries.

In some embodiments, the active material particles may comprise a lithium-transition metal-phosphate compound, or the active material particles may comprise LiCoO₂, or where the active material particles may comprise LiNiO₂, or the active material particles may comprise LiMn₂O₄, or a combination thereof. In some embodiments, the active material particles may comprise a lithium-transition metal-phosphate compound doped with a material selected from the group consisting of: metals, metalloids, and, halogens, In some embodiments, the active material particles may comprise an olivine structure LiMPO₄ compound, where M is selected from the group of metals consisting of: vanadium, chromium, manganese, iron, cobalt, and nickel. In some embodiments, the olivine structure LiMPO₄ compound may have lithium sites with deficiencies, the deficiencies being compensated by the addition of a metal or metalloid. In some embodiments, the olivine structure LiMPO₄ compound may be doped at the metal sites. In some embodiments, the olivine structure LiMPO₄ compound may be doped at the oxygen sites deficiencies at the oxygen sites are compensated by the addition of a halogen.

In some embodiments, at least one of the layers comprises active material particles having a nitrogen adsorption Brunauer-Emmett-Teller (BET) method surface area that is greater than 10 m²/g, or where the active material particles have a nitrogen adsorption BET method surface area that is greater than BET 20 m²/g, or where the active material particles have a nitrogen adsorption BET method surface area greater than 10 m²/g, or where the active material particles have a nitrogen adsorption BET method surface area greater than 15 m²/g, or where the active material particles have a nitrogen adsorption BET method surface area greater than 20 m²/g, or where the active material particles have a nitrogen adsorption BET method surface area greater than 30 m²/g.

In some embodiments the active material comprises an anode active material selected from the group comprising: carbon; graphite; graphite coated graphite; graphene; mesocarbon micobeads; carbon nanotubes; silicon; porous silicon; nanostructured silicon; nanometer scale silicon; micrometer scale silicon; alloys containing silicon; carbon coated silicon; carbon nanotube coated silicon; tin; alloys containing tin; mesocarbon microbeads; and, Li₄Ti₅O₁₂.

In some embodiments, the layer may have an average thickness selected from the group of thicknesses consisting of: about 1 μm; about 2 μm; about 3 μm; about 4 μm; about 5 μm; about 6 μm; about 7 μm; about 8 μm; about 9 μm; about 10 μm; about 11 μm; about 12 μm; about 13 μm; about 14 μm; about 15 μm; about 16 μm; about 17 μm; about 18 μm; about 19 μm; about 20 μm; about 21 μm; about 22 μm; about 23 μm; about 24 μm; about 25 μm; about 26 μm; about 27 μm; about 28 μm; about 39 μm; about 30 μm; about 31 μm; about 32 μm; about 33 μm; about 34 μm; about 35 μm; about 36 μm; about 37 μm; about 38 μm; about 39 μm; about 40 μm; about 41 μm; about 42 μm; about 43 μm; about 44 μm; about 45 μm; about 46 μm; about 47 μm; about 48 μm; about 49 μm; about 50 μm; about 51 μm; about 52 μm; about 53 μm; about 54 μm; about 55 μm; about 56 μm; about 57 μm; about 58 μm; about 59 μm; about 60 μm; about 61 μm; about 62 μm; about 63 μm; about 64 μm; about 65 μm; about 66 μm; about 67 μm; about 68 μm; about 69 μm; about 70 μm; about 71 μm; about 72 μm; about 73 μm; about 74 μm; about 75 μm; about 76 μm; about 77 μm; about 78 μm; about 79 μm; about 80 μm; about 81 μm; about 82 μm; about 83 μm; about 84 μm; about 85 μm; about 86 μm; about 87 μm; about 88 μm; about 89 μm; about 90 μm; about 91 μm; about 92 μm; about 93 μm; about 94 μm; about 95 μm; about 96 μm; about 97 μm; about 98 μm; about 99 μm; about 100 μm; about 101 μm; about 102 μm; about 103 μm; about 104 μm; about 105 μm; about 106 μm; about 107 μm; about 108 μm; about 109 μm; about 110 μm; about 111 μm; about 112 μm; about 113 μm; about 114 μm; about 115 μm; about 116 μm; about 117 μm; about 118 μm; about 119 μm; about 120 μm; about 121 μm; about 122 μm; about 123 μm; about 124 μm; about 125 μm; about 126 μm; about 127 μm; about 128 μm; about 129 μm; about 130 μm; about 131 μm; about 132 μm; about 133 μm; about 134 μm; about 135 μm; about 136 μm; about 137 μm; about 138 μm; about 139 μm; about 140 μm; about 141 μm; about 142 μm; about 143 μm; about 144 μm; about 145 μm; about 146 μm; about 147 μm; about 148 μm; about 149 μm; about 150 μm; about 151 μm; about 152 μm; about 153 μm; about 154 μm; about 155 μm; about 156 μm; about 157 μm; about 158 μm; about 159 μm; about 160 μm; about 161 μm; about 162 μm; about 163 μm; about 164 μm; about 165 μm; about 166 μm; about 167 μm; about 168 μm; about 169 μm; about 170 μm; about 171 μm; about 172 μm; about 173 μm; about 174 μm; about 175 μm; about 176 μm; about 177 μm; about 178 μm; about 179 μm; about 180 μm; about 181 μm; about 182 μm; about 183 μm; about 184 μm; about 185 μm; about 186 μm; about 187 μm; about 188 μm; about 189 μm; about 190 μm; about 191 μm; about 192 μm; about 193 μm; about 194 μm; about 195 μm; about 196 μm; about 197 μm; about 198 μm; about 199 μm; about 200 μm; about 201 μm; about 202 μm; about 203 μm; about 204 μm; about 205 μm; about 206 μm; about 207 μm; about 208 μm; about 209 μm; about 210 μm; about 211 μm; about 212 μm; about 213 μm; about 214 μm; about 215 μm; about 216 μm; about 217 μm; about 218 μm; about 219 μm; about 220 μm; about 221 μm; about 222 μm; about 223 μm; about 224 μm; about 225 μm; about 226 μm; about 227 μm; about 228 μm; about 239 μm; about 230 μm; about 231 μm; about 232 μm; about 233 μm; about 234 μm; about 235 μm; about 236 μm; about 237 μm; about 238 μm; about 239 μm; about 240 μm; about 241 μm; about 242 μm; about 243 μm; about 244 μm; about 245 μm; about 246 μm; about 247 μm; about 248 μm; about 249 μm; about 250 μm; about 251 μm; about 252 μm; about 253 μm; about 254 μm; about 255 μm; about 256 μm; about 257 μm; about 258 μm; about 259 μm; about 260 μm; about 261 μm; about 262 μm; about 263 μm; about 264 μm; about 265 μm; about 266 μm; about 267 μm; about 268 μm; about 269 μm; about 270 μm; about 271 μm; about 272 μm; about 273 μm; about 274 μm; about 275 μm; about 276 μm; about 277 μm; about 278 μm; about 279 μm; about 280 μm; about 281 μm; about 282 μm; about 283 μm; about 284 μm; about 285 μm; about 286 μm; about 287 μm; about 288 μm; about 289 μm; about 290 μm; about 291 μm; about 292 μm; about 293 μm; about 294 μm; about 295 μm; about 296 μm; about 297 μm; about 298 μm; about 299 μm; about 300 μm.

In some embodiments, the active material particles may have a cross-sectional dimension ranging from about 20 nm to about 20 μm. In some embodiments, the active material particles may have a cross-sectional dimension ranging from the following ranges from about 1 nm to about 10 nm; from about 10 nm to about 20 nm; from about 20 nm to about 30 nm; from about 30 nm to about 40 nm; from about 40 nm to about 50 nm; from about 50 nm to about 60 nm; from about 60 nm to about 70 nm; from about 70 nm to about 80 nm; from about 80 nm to about 90 nm; from about 90 nm to about 100 nm; from about 100 nm to about 110 nm; from about 110 nm to about 120 nm; from about 120 nm to about 130 nm; from about 130 nm to about 140 nm; from about 140 nm to about 150 nm; from about 150 nm to about 160 nm; from about 160 nm to about 170 nm; from about 170 nm to about 180 nm; from about 180 nm to about 190 nm; from about 190 nm to about 200 nm; from about 5 nm to about 10 nm; from about 10 nm to about 15 nm; from about 15 nm to about 20 nm; from about 20 nm to about 25 nm; from about 25 nm to about 30 nm; from about 30 nm to about 35 nm; from about 35 nm to about 40 nm; from about 40 nm to about 45 nm; from about 45 nm to about 50 nm; from about 50 nm to about 55 nm; from about 55 nm to about 60 nm; from about 60 nm to about 65 nm; from about 65 nm to about 70 nm; from about 70 nm to about 75 nm; from about 75 nm to about 80 nm; from about 80 nm to about 85 nm; from about 85 nm to about 90 nm; from about 90 nm to about 95 nm; from about 95 nm to about 100 nm; from about 100 nm to about 105 nm; from about 105 nm to about 110 nm; from about 110 nm to about 115 nm; from about 115 nm to about 120 nm; from about 120 nm to about 125 nm; from about 125 nm to about 130 nm; from about 130 nm to about 135 nm; from about 135 nm to about 140 nm; from about 140 nm to about 145 nm; from about 145 nm to about 150 nm; from about 150 nm to about 155 nm; from about 155 nm to about 160 nm; from about 160 nm to about 165 nm; from about 165 nm to about 170 nm; from about 170 nm to about 175 nm; from about 175 nm to about 180 nm; from about 185 nm to about 190 nm; from about 190 nm to about 195 nm; from about 195 nm to about 200 nm; from about 0 nm to about 50 nm; from about 10 nm to about 60 nm; from about 20 nm to about 70 nm; from about 30 nm to about 80 nm; from about 40 nm to about 90 nm; from about 50 nm to about 100 nm; from about 60 nm to about 110 nm; from about 70 nm to about 120 nm; from about 80 nm to about 130 nm; from about 90 nm to about 140 nm; from about 100 nm to about 150 nm; from about 110 nm to about 160 nm; from about 120 nm to about 170 nm; from about 130 nm to about 180 nm; from about 140 nm to about 190 nm; from about 150 nm to about 200 nm; from about 160 nm to about 210 nm; from about 170 nm to about 220 nm; from about 180 nm to about 230 nm; from about 190 nm to about 240 nm; from about 240 nm to about 1.0 μm; from 1.0 μm to about 10 μm; from about 10 μm to about 100 μm; and, from about 100 μm to about 250 μm.

In some embodiments, the electrode may further comprise a current collector having first and second sides; and, a first electrode comprising a plurality of layers, each layer comprising active material particles capable of reversibly storing ions; and, conductive particles, wherein the plurality of layers has at least one layer being functionally different from at least one other layer, wherein the first electrode is attached to, and/or in electrical communication with, the first side of the current collector.

In some embodiments, the active material particles may have a pore volume fraction ranging from about 20% to about 30% by volume. In some embodiments, the active material particles may have a pore volume fraction having a range selected from one or a combination of the following ranges: ranges from about 1% to about 10%; ranges from about 1% to about 5%; ranges from about 5% to about 10%; ranges from about 10% to about 15%; ranges from about 10% to about 20%; ranges from about 15% to about 20%; ranges from about 20% to about 25%; ranges from about 20% to about 30%; ranges from about 25% to about 30%; ranges from about 30% to about 35%; ranges from about 30% to about 40%; ranges from about 35% to about 40%; ranges from about 40% to about 45%; ranges from about 40% to about 50%; ranges from about 45% to about 50%; ranges from about 50% to about 55%; ranges from about 50% to about 60%; ranges from about 55% to about 60%; ranges from about 60% to about 65%; ranges from about 60% to about 70%; ranges from about 65% to about 70%; ranges from about 70% to about 75%; ranges from about 70% to about 80%; ranges from about 75% to about 80%; ranges from about 80% to about 85%; ranges from about 80% to about 90%; ranges from about 85% to about 90%; ranges from about 90% to about 95%; ranges from about 90% to about 95%; ranges from about 95% to about 97%

In some embodiments, the electrode may have a loading density ranging from about 0.5 mg/cm² to about 1.0 mg/cm²; 1.0 mg/cm² to about 2.0 mg/cm²; or from about 1.5 mg/cm² to about 2.5 mg/cm²; or from about 2.0 mg/cm² to about 2.5 mg/cm²; or from about 2.0 mg/cm² to about 3.0 mg/cm²; or from about 1.0 mg/cm² to about 3.0 mg/cm²; or from about 2.0 mg/cm² to about 4.0 mg/cm²; or from about 1.0 mg/cm² to about 5.0 mg/cm²; or from about 3.0 mg/cm² to about 5.0 mg/cm²; or from about 4.5 mg/cm² to about 5.0 mg/cm²; or from about 5.0 mg/cm² to about 10 mg/cm²; or from about 6.0 mg/cm² to about 7.0 mg/cm²; or from about 7.0 mg/cm² to about 8.0 mg/cm²; or from about 8.0 mg/cm² to about 9.0 mg/cm²; or from about 9.0 mg/cm² to about 10 mg/cm²; or from about 10 mg/cm² to about 11 mg/cm²; or from about 11 mg/cm² to about 12 mg/cm²; or from about 12 mg/cm² to about 13 mg/cm²; or from about 13 mg/cm² to about 14 mg/cm²; or from about 14 mg/cm² to about 15 mg/cm²; or from about 15 mg/cm² to about 20 mg/cm²; or from about 20 mg/cm² to about 30 mg/cm²; or from about 30 mg/cm² to about 40 mg/cm²; or from about 40 mg/cm² to about 50 mg/cm²; or from about 1.5 mg/cm² to about 3.5 mg/cm²; or from about 2.0 mg/cm² to about 4.5 mg/cm²; or from about 1.0 mg/cm² to about 8.0 mg/cm²; from about 5.0 mg/cm² to about 8.0 mg/cm². or from about 1.0 mg/cm² to about 5.0 mg/cm²; or from about 3.0 mg/cm² to about 5.0 mg/cm²; or from about 1.5 mg/cm² to about 3.5 mg/cm²; or from about 2.0 mg/cm² to about 4.5 mg/cm²; or from about 1.0 mg/cm² to about 8.0 mg/cm²; from about 5.0 mg/cm² to about 8.0 mg/cm². or from about 1.0 mg/cm² to about 20 mg/cm²; or from about 1.5 mg/cm² to about 25 mg/cm²; or from about 2.0 mg/cm² to about 25 mg/cm²; or from about 1.0 mg/cm² to about 25 mg/cm²; or from about 1.0 mg/cm² to about 30 mg/cm²; or from about 1.0 mg/cm² to about 35 mg/cm²; or from about 1.0 mg/cm² to about 40 mg/cm²; or from about 1.0 mg/cm² to about 50 mg/cm²; or from about 15 mg/cm² to about 35 mg/cm²; or from about 20 mg/cm² to about 45 mg/cm²; or from about 10 mg/cm² to about 80 mg/cm²; from about 50 mg/cm² to about 80 mg/cm². In some embodiments, the electrode may have a loading density ranging from about 11 mg/cm² to about 15 mg/cm². In some embodiments, the electrode has a loading density of about 12.5 mg/cm² to about 15 mg/cm².

In some embodiments, the active material particles may comprise an olivine lithium metal phosphate material having the formula LixM′yM″zPO4, wherein M′ comprises a metal selected from the group consisting of: manganese and iron, wherein M′ comprises a metal selected from the group consisting of: manganese; cobalt; and, nickel, wherein M′ is not the same as M″, and, wherein x is greater than or equal to 0, and x is less than or equal to 1.2; y is greater than or equal to 0.7, and y is less than or equal to 0.95; z is greater than or equal to 0.02, and z is greater than or equal to 0.3; and, the sum of y and z is greater than or equal to 0.8, and the sum of y and z is less than or equal to 1.2. In some embodiments, z may be greater than or equal to 0.02, and z may be less than or equal to 0.1, or the sum of y and z may equal 1. In some embodiments, M′ may be iron, and z may be greater than or equal to 0.02, and z may be less than or equal to 0.1, or the sum of y and z may equal 1. In some embodiments, the sum of y and z may be greater than or equal to 0.8, and the sum of y and z may be less than or equal to 1.

In some embodiments, the active material particles may comprise a lithium transition metal phosphate material having an overall composition of Li_{1-X} MPO₄, wherein M comprises at least one first row transition metal selected from the group consisting of titanium, vanadium, chromium, manganese, iron, cobalt and nickel, and wherein in use x ranges from 0 to 1. In some embodiments, M may be iron and the active material particles may form a stable solid solution when x ranges from about 0.1 to about 0.3. In some embodiments, M may be iron and the active material particles may form a stable solid solution when x has a range selected from one or a combination of the following ranges: from: about 0 to about 0.15; from about 0.00 to about 0.01; from about 0.00 to about 0.02; from about 0.00 to about 0.03; from about 0.00 to about 0.04; from about 0.00 to about 0.05; from about 0.00 to about 0.06; from about 0.00 to about 0.07; from about 0.00 to about 0.08; from about 0.00 to about 0.09; from about 0.00 to about 0.10; from about 0.00 to about 0.11; from about 0.00 to about 0.12; from about 0.00 to about 0.13; from about 0.00 to about 0.14; from about 0.00 to about 0.15; from about 0.00 to about 0.16; from about 0.00 to about 0.17; from about 0.00 to about 0.18; from about 0.00 to about 0.19; from about 0.00 to about 0.20; from about 0.00 to about 0.21; from about 0.00 to about 0.22; from about 0.00 to about 0.23; from about 0.00 to about 0.24; from about 0.00 to about 0.25; from about 0.00 to about 0.26; from about 0.00 to about 0.27; from about 0.00 to about 0.28; from about 0.00 to about 0.29; from about 0.00 to about 0.30; from about 0.00 to about 0.31; from about 0.00 to about 0.32; from about 0.00 to about 0.33; from about 0.00 to about 0.34; from about 0.00 to about 0.35; from about 0.00 to about 0.36; from about 0.00 to about 0.37; from about 0.00 to about 0.38; from about 0.00 to about 0.39; from about 0.00 to about 0.40; from about 0.00 to about 0.41; from about 0.00 to about 0.42; from about 0.00 to about 0.43; from about 0.00 to about 0.44; from about 0.00 to about 0.45; from about 0.00 to about 0.46; from about 0.00 to about 0.47; from about 0.00 to about 0.48; from about 0.00 to about 0.49; from about 0.00 to about 0.50; from about 0.00 to about 0.51; from about 0.00 to about 0.52; from about 0.00 to about 0.53; from about 0.00 to about 0.54; from about 0.00 to about 0.55; from about 0.00 to about 0.56; from about 0.00 to about 0.57; from about 0.00 to about 0.58; from about 0.00 to about 0.59; from about 0.00 to about 0.60; from about 0.00 to about 0.61; from about 0.00 to about 0.62; from about 0.00 to about 0.63; from about 0.00 to about 0.64; from about 0.00 to about 0.65; from about 0.00 to about 0.66; from about 0.00 to about 0.67; from about 0.00 to about 0.68; from about 0.00 to about 0.69; from about 0.00 to about 0.70; from about 0.00 to about 0.71; from about 0.00 to about 0.72; from about 0.00 to about 0.73; from about 0.00 to about 0.74; from about 0.00 to about 0.75; from about 0.00 to about 0.76; from about 0.00 to about 0.77; from about 0.00 to about 0.78; from about 0.00 to about 0.79; from about 0.00 to about 0.80; from about 0.00 to about 0.81; from about 0.00 to about 0.82; from about 0.00 to about 0.83; from about 0.00 to about 0.84; from about 0.00 to about 0.85; from about 0.00 to about 0.86; from about 0.00 to about 0.87; from about 0.00 to about 0.88; from about 0.00 to about 0.89; from about 0.00 to about 0.90; from about 0.00 to about 0.91; from about 0.00 to about 0.92; from about 0.00 to about 0.93; from about 0.00 to about 0.94; from about 0.00 to about 0.95; from about 0.00 to about 0.96; from about 0.00 to about 0.97; from about 0.00 to about 0.98; from about 0.00 to about 0.99; from about 0.00 to about 0.10; from about 0.10 to about 0.11; from about 0.10 to about 0.12; from about 0.10 to about 0.13; from about 0.10 to about 0.14; from about 0.10 to about 0.15; from about 0.10 to about 0.16; from about 0.10 to about 0.17; from about 0.10 to about 0.18; from about 0.10 to about 0.19; from about 0.10 to about 0.20; from about 0.10 to about 0.21; from about 0.10 to about 0.22; from about 0.10 to about 0.23; from about 0.10 to about 0.24; from about 0.10 to about 0.25; from about 0.10 to about 0.26; from about 0.10 to about 0.27; from about 0.10 to about 0.28; from about 0.10 to about 0.29; from about 0.10 to about 0.30; from about 0.10 to about 0.31; from about 0.10 to about 0.32; from about 0.10 to about 0.33; from about 0.10 to about 0.34; from about 0.10 to about 0.35; from about 0.10 to about 0.36; from about 0.10 to about 0.37; from about 0.10 to about 0.38; from about 0.10 to about 0.39; from about 0.10 to about 0.40; from about 0.10 to about 0.41; from about 0.10 to about 0.42; from about 0.10 to about 0.43; from about 0.10 to about 0.44; from about 0.10 to about 0.45; from about 0.10 to about 0.46; from about 0.10 to about 0.47; from about 0.10 to about 0.48; from about 0.10 to about 0.49; from about 0.10 to about 0.50; from about 0.10 to about 0.51; from about 0.10 to about 0.52; from about 0.10 to about 0.53; from about 0.10 to about 0.54; from about 0.10 to about 0.55; from about 0.10 to about 0.56; from about 0.10 to about 0.57; from about 0.10 to about 0.58; from about 0.10 to about 0.59; from about 0.10 to about 0.60; from about 0.10 to about 0.61; from about 0.10 to about 0.62; from about 0.10 to about 0.63; from about 0.10 to about 0.64; from about 0.10 to about 0.65; from about 0.10 to about 0.66; from about 0.10 to about 0.67; from about 0.10 to about 0.68; from about 0.10 to about 0.69; from about 0.10 to about 0.70; from about 0.10 to about 0.71; from about 0.10 to about 0.72; from about 0.10 to about 0.73; from about 0.10 to about 0.74; from about 0.10 to about 0.75; from about 0.10 to about 0.76; from about 0.10 to about 0.77; from about 0.10 to about 0.78; from about 0.10 to about 0.79; from about 0.10 to about 0.80; from about 0.10 to about 0.81; from about 0.10 to about 0.82; from about 0.10 to about 0.83; from about 0.10 to about 0.84; from about 0.10 to about 0.85; from about 0.10 to about 0.86; from about 0.10 to about 0.87; from about 0.10 to about 0.88; from about 0.10 to about 0.89; from about 0.10 to about 0.90; from about 0.10 to about 0.91; from about 0.10 to about 0.92; from about 0.10 to about 0.93; from about 0.10 to about 0.94; from about 0.10 to about 0.95; from about 0.10 to about 0.96; from about 0.10 to about 0.97; from about 0.10 to about 0.98; from about 0.10 to about 0.99; from about 0.10 to about 1.00; from about 0.20 to about 0.21; from about 0.20 to about 0.22; from about 0.20 to about 0.23; from about 0.20 to about 0.24; from about 0.20 to about 0.25; from about 0.20 to about 0.26; from about 0.20 to about 0.27; from about 0.20 to about 0.28; from about 0.20 to about 0.29; from about 0.20 to about 0.30; from about 0.20 to about 0.31; from about 0.20 to about 0.32; from about 0.20 to about 0.33; from about 0.20 to about 0.34; from about 0.20 to about 0.35; from about 0.20 to about 0.36; from about 0.20 to about 0.37; from about 0.20 to about 0.38; from about 0.20 to about 0.39; from about 0.20 to about 0.40; from about 0.20 to about 0.41; from about 0.20 to about 0.42; from about 0.20 to about 0.43; from about 0.20 to about 0.44; from about 0.20 to about 0.45; from about 0.20 to about 0.46; from about 0.20 to about 0.47; from about 0.20 to about 0.48; from about 0.20 to about 0.49; from about 0.20 to about 0.50; from about 0.20 to about 0.51; from about 0.20 to about 0.52; from about 0.20 to about 0.53; from about 0.20 to about 0.54; from about 0.20 to about 0.55; from about 0.20 to about 0.56; from about 0.20 to about 0.57; from about 0.20 to about 0.58; from about 0.20 to about 0.59; from about 0.20 to about 0.60; from about 0.20 to about 0.61; from about 0.20 to about 0.62; from about 0.20 to about 0.63; from about 0.20 to about 0.64; from about 0.20 to about 0.65; from about 0.20 to about 0.66; from about 0.20 to about 0.67; from about 0.20 to about 0.68; from about 0.20 to about 0.69; from about 0.20 to about 0.70; from about 0.20 to about 0.71; from about 0.20 to about 0.72; from about 0.20 to about 0.73; from about 0.20 to about 0.74; from about 0.20 to about 0.75; from about 0.20 to about 0.76; from about 0.20 to about 0.77; from about 0.20 to about 0.78; from about 0.20 to about 0.79; from about 0.20 to about 0.80; from about 0.20 to about 0.81; from about 0.20 to about 0.82; from about 0.20 to about 0.83; from about 0.20 to about 0.84; from about 0.20 to about 0.85; from about 0.20 to about 0.86; from about 0.20 to about 0.87; from about 0.20 to about 0.88; from about 0.20 to about 0.89; from about 0.20 to about 0.90; from about 0.20 to about 0.91; from about 0.20 to about 0.92; from about 0.20 to about 0.93; from about 0.20 to about 0.94; from about 0.20 to about 0.95; from about 0.20 to about 0.96; from about 0.20 to about 0.97; from about 0.20 to about 0.98; from about 0.20 to about 0.99; from about 0.20 to about 1.00; from about 0.30 to about 0.31; from about 0.30 to about 0.32; from about 0.30 to about 0.33; from about 0.30 to about 0.34; from about 0.30 to about 0.35; from about 0.30 to about 0.36; from about 0.30 to about 0.37; from about 0.30 to about 0.38; from about 0.30 to about 0.39; from about 0.30 to about 0.40; from about 0.30 to about 0.41; from about 0.30 to about 0.42; from about 0.30 to about 0.43; from about 0.30 to about 0.44; from about 0.30 to about 0.45; from about 0.30 to about 0.46; from about 0.30 to about 0.47; from about 0.30 to about 0.48; from about 0.30 to about 0.49; from about 0.30 to about 0.50; from about 0.30 to about 0.51; from about 0.30 to about 0.52; from about 0.30 to about 0.53; from about 0.30 to about 0.54; from about 0.30 to about 0.55; from about 0.30 to about 0.56; from about 0.30 to about 0.57; from about 0.30 to about 0.58; from about 0.30 to about 0.59; from about 0.30 to about 0.60; from about 0.30 to about 0.61; from about 0.30 to about 0.62; from about 0.30 to about 0.63; from about 0.30 to about 0.64; from about 0.30 to about 0.65; from about 0.30 to about 0.66; from about 0.30 to about 0.67; from about 0.30 to about 0.68; from about 0.30 to about 0.69; from about 0.30 to about 0.70; from about 0.30 to about 0.71; from about 0.30 to about 0.72; from about 0.30 to about 0.73; from about 0.30 to about 0.74; from about 0.30 to about 0.75; from about 0.30 to about 0.76; from about 0.30 to about 0.77; from about 0.30 to about 0.78; from about 0.30 to about 0.79; from about 0.30 to about 0.80; from about 0.30 to about 0.81; from about 0.30 to about 0.82; from about 0.30 to about 0.83; from about 0.30 to about 0.84; from about 0.30 to about 0.85; from about 0.30 to about 0.86; from about 0.30 to about 0.87; from about 0.30 to about 0.88; from about 0.30 to about 0.89; from about 0.30 to about 0.90; from about 0.30 to about 0.91; from about 0.30 to about 0.92; from about 0.30 to about 0.93; from about 0.30 to about 0.94; from about 0.30 to about 0.95; from about 0.30 to about 0.96; from about 0.30 to about 0.97; from about 0.30 to about 0.98; from about 0.30 to about 0.99; from about 0.30 to about 1.00; from about 0.40 to about 0.40; from about 0.40 to about 0.41; from about 0.40 to about 0.42; from about 0.40 to about 0.43; from about 0.40 to about 0.44; from about 0.40 to about 0.45; from about 0.40 to about 0.46; from about 0.40 to about 0.47; from about 0.40 to about 0.48; from about 0.40 to about 0.49; from about 0.40 to about 0.50; from about 0.40 to about 0.51; from about 0.40 to about 0.52; from about 0.40 to about 0.53; from about 0.40 to about 0.54; from about 0.40 to about 0.55; from about 0.40 to about 0.56; from about 0.40 to about 0.57; from about 0.40 to about 0.58; from about 0.40 to about 0.59; from about 0.40 to about 0.60; from about 0.40 to about 0.61; from about 0.40 to about 0.62; from about 0.40 to about 0.63; from about 0.40 to about 0.64; from about 0.40 to about 0.65; from about 0.40 to about 0.66; from about 0.40 to about 0.67; from about 0.40 to about 0.68; from about 0.40 to about 0.69; from about 0.40 to about 0.70; from about 0.40 to about 0.71; from about 0.40 to about 0.72; from about 0.40 to about 0.73; from about 0.40 to about 0.74; from about 0.40 to about 0.75; from about 0.40 to about 0.76; from about 0.40 to about 0.77; from about 0.40 to about 0.78; from about 0.40 to about 0.79; from about 0.40 to about 0.80; from about 0.40 to about 0.81; from about 0.40 to about 0.82; from about 0.40 to about 0.83; from about 0.40 to about 0.84; from about 0.40 to about 0.85; from about 0.40 to about 0.86; from about 0.40 to about 0.87; from about 0.40 to about 0.88; from about 0.40 to about 0.89; from about 0.40 to about 0.90; from about 0.40 to about 0.91; from about 0.40 to about 0.92; from about 0.40 to about 0.93; from about 0.40 to about 0.94; from about 0.40 to about 0.95; from about 0.40 to about 0.96; from about 0.40 to about 0.97; from about 0.40 to about 0.98; from about 0.40 to about 0.99; from about 0.40 to about 1.00; from about 0.50 to about 0.51; from about 0.50 to about 0.52; from about 0.50 to about 0.53; from about 0.50 to about 0.54; from about 0.50 to about 0.55; from about 0.50 to about 0.56; from about 0.50 to about 0.57; from about 0.50 to about 0.58; from about 0.50 to about 0.59; from about 0.50 to about 0.60; from about 0.50 to about 0.61; from about 0.50 to about 0.62; from about 0.50 to about 0.63; from about 0.50 to about 0.64; from about 0.50 to about 0.65; from about 0.50 to about 0.66; from about 0.50 to about 0.67; from about 0.50 to about 0.68; from about 0.50 to about 0.69; from about 0.50 to about 0.70; from about 0.50 to about 0.71; from about 0.50 to about 0.72; from about 0.50 to about 0.73; from about 0.50 to about 0.74; from about 0.50 to about 0.75; from about 0.50 to about 0.76; from about 0.50 to about 0.77; from about 0.50 to about 0.78; from about 0.50 to about 0.79; from about 0.50 to about 0.80; from about 0.50 to about 0.81; from about 0.50 to about 0.82; from about 0.50 to about 0.83; from about 0.50 to about 0.84; from about 0.50 to about 0.85; from about 0.50 to about 0.86; from about 0.50 to about 0.87; from about 0.50 to about 0.88; from about 0.50 to about 0.89; from about 0.50 to about 0.90; from about 0.50 to about 0.91; from about 0.50 to about 0.92; from about 0.50 to about 0.93; from about 0.50 to about 0.94; from about 0.50 to about 0.95; from about 0.50 to about 0.96; from about 0.50 to about 0.97; from about 0.50 to about 0.98; from about 0.50 to about 0.99; from about 0.50 to about 1.00; from about 0.60 to about 0.61; from about 0.60 to about 0.62; from about 0.60 to about 0.63; from about 0.60 to about 0.64; from about 0.60 to about 0.65; from about 0.60 to about 0.66; from about 0.60 to about 0.67; from about 0.60 to about 0.68; from about 0.60 to about 0.69; from about 0.60 to about 0.70; from about 0.60 to about 0.71; from about 0.60 to about 0.72; from about 0.60 to about 0.73; from about 0.60 to about 0.74; from about 0.60 to about 0.75; from about 0.60 to about 0.76; from about 0.60 to about 0.77; from about 0.60 to about 0.78; from about 0.60 to about 0.79; from about 0.60 to about 0.80; from about 0.60 to about 0.81; from about 0.60 to about 0.82; from about 0.60 to about 0.83; from about 0.60 to about 0.84; from about 0.60 to about 0.85; from about 0.60 to about 0.86; from about 0.60 to about 0.87; from about 0.60 to about 0.88; from about 0.60 to about 0.89; from about 0.60 to about 0.90; from about 0.60 to about 0.91; from about 0.60 to about 0.92; from about 0.60 to about 0.93; from about 0.60 to about 0.94; from about 0.60 to about 0.95; from about 0.60 to about 0.96; from about 0.60 to about 0.97; from about 0.60 to about 0.98; from about 0.60 to about 0.99; from about 0.60 to about 1.00; from about 0.70 to about 0.71; from about 0.70 to about 0.72; from about 0.70 to about 0.73; from about 0.70 to about 0.74; from about 0.70 to about 0.75; from about 0.70 to about 0.76; from about 0.70 to about 0.77; from about 0.70 to about 0.78; from about 0.70 to about 0.79; from about 0.70 to about 0.80; from about 0.70 to about 0.81; from about 0.70 to about 0.82; from about 0.70 to about 0.83; from about 0.70 to about 0.84; from about 0.70 to about 0.85; from about 0.70 to about 0.86; from about 0.70 to about 0.87; from about 0.70 to about 0.88; from about 0.70 to about 0.89; from about 0.70 to about 0.90; from about 0.70 to about 0.91; from about 0.70 to about 0.92; from about 0.70 to about 0.93; from about 0.70 to about 0.94; from about 0.70 to about 0.95; from about 0.70 to about 0.96; from about 0.70 to about 0.97; from about 0.70 to about 0.98; from about 0.70 to about 0.99; from about 0.70 to about 1.00; from about 0.80 to about 0.80; from about 0.80 to about 0.81; from about 0.80 to about 0.82; from about 0.80 to about 0.83; from about 0.80 to about 0.84; from about 0.80 to about 0.85; from about 0.80 to about 0.86; from about 0.80 to about 0.87; from about 0.80 to about 0.88; from about 0.80 to about 0.89; from about 0.80 to about 0.90; from about 0.80 to about 0.91; from about 0.80 to about 0.92; from about 0.80 to about 0.93; from about 0.80 to about 0.94; from about 0.80 to about 0.95; from about 0.80 to about 0.96; from about 0.80 to about 0.97; from about 0.80 to about 0.98; from about 0.80 to about 0.99; from about 0.80 to about 1.00; from about 0.90 to about 0.91; from about 0.90 to about 0.92; from about 0.90 to about 0.93; from about 0.90 to about 0.94; from about 0.90 to about 0.95; from about 0.90 to about 0.96; from about 0.90 to about 0.97; from about 0.90 to about 0.98; from about 0.90 to about 0.99; from about 0.90 to about 1.00 at room temperature.

In some embodiments, M is iron and the active material particles can form a stable solid solution when x ranges from about 0 to at least about 0.07 at room temperature.

In some embodiments, M may be iron and the active material particles may form a stable solid solution when x has ranges from one or a combination of the following ranges: from about 0 to about 0.05; from about 0.00 to about 0.01; from about 0.00 to about 0.02; from about 0.00 to about 0.03; from about 0.00 to about 0.04; from about 0.00 to about 0.05; from about 0.00 to about 0.06; from about 0.00 to about 0.07; from about 0.00 to about 0.08; from about 0.00 to about 0.09; from about 0.00 to about 0.10; from about 0.00 to about 0.11; from about 0.00 to about 0.12; from about 0.00 to about 0.13; from about 0.00 to about 0.14; from about 0.00 to about 0.15; from about 0.00 to about 0.16; from about 0.00 to about 0.17; from about 0.00 to about 0.18; from about 0.00 to about 0.19; from about 0.00 to about 0.20; from about 0.00 to about 0.21; from about 0.00 to about 0.22; from about 0.00 to about 0.23; from about 0.00 to about 0.24; from about 0.00 to about 0.25; from about 0.00 to about 0.26; from about 0.00 to about 0.27; from about 0.00 to about 0.28; from about 0.00 to about 0.29; from about 0.00 to about 0.30; from about 0.00 to about 0.31; from about 0.00 to about 0.32; from about 0.00 to about 0.33; from about 0.00 to about 0.34; from about 0.00 to about 0.35; from about 0.00 to about 0.36; from about 0.00 to about 0.37; from about 0.00 to about 0.38; from about 0.00 to about 0.39; from about 0.00 to about 0.40; from about 0.00 to about 0.41; from about 0.00 to about 0.42; from about 0.00 to about 0.43; from about 0.00 to about 0.44; from about 0.00 to about 0.45; from about 0.00 to about 0.46; from about 0.00 to about 0.47; from about 0.00 to about 0.48; from about 0.00 to about 0.49; from about 0.00 to about 0.50; from about 0.00 to about 0.51; from about 0.00 to about 0.52; from about 0.00 to about 0.53; from about 0.00 to about 0.54; from about 0.00 to about 0.55; from about 0.00 to about 0.56; from about 0.00 to about 0.57; from about 0.00 to about 0.58; from about 0.00 to about 0.59; from about 0.00 to about 0.60; from about 0.00 to about 0.61; from about 0.00 to about 0.62; from about 0.00 to about 0.63; from about 0.00 to about 0.64; from about 0.00 to about 0.65; from about 0.00 to about 0.66; from about 0.00 to about 0.67; from about 0.00 to about 0.68; from about 0.00 to about 0.69; from about 0.00 to about 0.70; from about 0.00 to about 0.71; from about 0.00 to about 0.72; from about 0.00 to about 0.73; from about 0.00 to about 0.74; from about 0.00 to about 0.75; from about 0.00 to about 0.76; from about 0.00 to about 0.77; from about 0.00 to about 0.78; from about 0.00 to about 0.79; from about 0.00 to about 0.80; from about 0.00 to about 0.81; from about 0.00 to about 0.82; from about 0.00 to about 0.83; from about 0.00 to about 0.84; from about 0.00 to about 0.85; from about 0.00 to about 0.86; from about 0.00 to about 0.87; from about 0.00 to about 0.88; from about 0.00 to about 0.89; from about 0.00 to about 0.90; from about 0.00 to about 0.91; from about 0.00 to about 0.92; from about 0.00 to about 0.93; from about 0.00 to about 0.94; from about 0.00 to about 0.95; from about 0.00 to about 0.96; from about 0.00 to about 0.97; from about 0.00 to about 0.98; from about 0.00 to about 0.99; from about 0.00 to about 0.10; from about 0.10 to about 0.11; from about 0.10 to about 0.12; from about 0.10 to about 0.13; from about 0.10 to about 0.14; from about 0.10 to about 0.15; from about 0.10 to about 0.16; from about 0.10 to about 0.17; from about 0.10 to about 0.18; from about 0.10 to about 0.19; from about 0.10 to about 0.20; from about 0.10 to about 0.21; from about 0.10 to about 0.22; from about 0.10 to about 0.23; from about 0.10 to about 0.24; from about 0.10 to about 0.25; from about 0.10 to about 0.26; from about 0.10 to about 0.27; from about 0.10 to about 0.28; from about 0.10 to about 0.29; from about 0.10 to about 0.30; from about 0.10 to about 0.31; from about 0.10 to about 0.32; from about 0.10 to about 0.33; from about 0.10 to about 0.34; from about 0.10 to about 0.35; from about 0.10 to about 0.36; from about 0.10 to about 0.37; from about 0.10 to about 0.38; from about 0.10 to about 0.39; from about 0.10 to about 0.40; from about 0.10 to about 0.41; from about 0.10 to about 0.42; from about 0.10 to about 0.43; from about 0.10 to about 0.44; from about 0.10 to about 0.45; from about 0.10 to about 0.46; from about 0.10 to about 0.47; from about 0.10 to about 0.48; from about 0.10 to about 0.49; from about 0.10 to about 0.50; from about 0.10 to about 0.51; from about 0.10 to about 0.52; from about 0.10 to about 0.53; from about 0.10 to about 0.54; from about 0.10 to about 0.55; from about 0.10 to about 0.56; from about 0.10 to about 0.57; from about 0.10 to about 0.58; from about 0.10 to about 0.59; from about 0.10 to about 0.60; from about 0.10 to about 0.61; from about 0.10 to about 0.62; from about 0.10 to about 0.63; from about 0.10 to about 0.64; from about 0.10 to about 0.65; from about 0.10 to about 0.66; from about 0.10 to about 0.67; from about 0.10 to about 0.68; from about 0.10 to about 0.69; from about 0.10 to about 0.70; from about 0.10 to about 0.71; from about 0.10 to about 0.72; from about 0.10 to about 0.73; from about 0.10 to about 0.74; from about 0.10 to about 0.75; from about 0.10 to about 0.76; from about 0.10 to about 0.77; from about 0.10 to about 0.78; from about 0.10 to about 0.79; from about 0.10 to about 0.80; from about 0.10 to about 0.81; from about 0.10 to about 0.82; from about 0.10 to about 0.83; from about 0.10 to about 0.84; from about 0.10 to about 0.85; from about 0.10 to about 0.86; from about 0.10 to about 0.87; from about 0.10 to about 0.88; from about 0.10 to about 0.89; from about 0.10 to about 0.90; from about 0.10 to about 0.91; from about 0.10 to about 0.92; from about 0.10 to about 0.93; from about 0.10 to about 0.94; from about 0.10 to about 0.95; from about 0.10 to about 0.96; from about 0.10 to about 0.97; from about 0.10 to about 0.98; from about 0.10 to about 0.99; from about 0.10 to about 1.00; from about 0.20 to about 0.21; from about 0.20 to about 0.22; from about 0.20 to about 0.23; from about 0.20 to about 0.24; from about 0.20 to about 0.25; from about 0.20 to about 0.26; from about 0.20 to about 0.27; from about 0.20 to about 0.28; from about 0.20 to about 0.29; from about 0.20 to about 0.30; from about 0.20 to about 0.31; from about 0.20 to about 0.32; from about 0.20 to about 0.33; from about 0.20 to about 0.34; from about 0.20 to about 0.35; from about 0.20 to about 0.36; from about 0.20 to about 0.37; from about 0.20 to about 0.38; from about 0.20 to about 0.39; from about 0.20 to about 0.40; from about 0.20 to about 0.41; from about 0.20 to about 0.42; from about 0.20 to about 0.43; from about 0.20 to about 0.44; from about 0.20 to about 0.45; from about 0.20 to about 0.46; from about 0.20 to about 0.47; from about 0.20 to about 0.48; from about 0.20 to about 0.49; from about 0.20 to about 0.50; from about 0.20 to about 0.51; from about 0.20 to about 0.52; from about 0.20 to about 0.53; from about 0.20 to about 0.54; from about 0.20 to about 0.55; from about 0.20 to about 0.56; from about 0.20 to about 0.57; from about 0.20 to about 0.58; from about 0.20 to about 0.59; from about 0.20 to about 0.60; from about 0.20 to about 0.61; from about 0.20 to about 0.62; from about 0.20 to about 0.63; from about 0.20 to about 0.64; from about 0.20 to about 0.65; from about 0.20 to about 0.66; from about 0.20 to about 0.67; from about 0.20 to about 0.68; from about 0.20 to about 0.69; from about 0.20 to about 0.70; from about 0.20 to about 0.71; from about 0.20 to about 0.72; from about 0.20 to about 0.73; from about 0.20 to about 0.74; from about 0.20 to about 0.75; from about 0.20 to about 0.76; from about 0.20 to about 0.77; from about 0.20 to about 0.78; from about 0.20 to about 0.79; from about 0.20 to about 0.80; from about 0.20 to about 0.81; from about 0.20 to about 0.82; from about 0.20 to about 0.83; from about 0.20 to about 0.84; from about 0.20 to about 0.85; from about 0.20 to about 0.86; from about 0.20 to about 0.87; from about 0.20 to about 0.88; from about 0.20 to about 0.89; from about 0.20 to about 0.90; from about 0.20 to about 0.91; from about 0.20 to about 0.92; from about 0.20 to about 0.93; from about 0.20 to about 0.94; from about 0.20 to about 0.95; from about 0.20 to about 0.96; from about 0.20 to about 0.97; from about 0.20 to about 0.98; from about 0.20 to about 0.99; from about 0.20 to about 1.00; from about 0.30 to about 0.31; from about 0.30 to about 0.32; from about 0.30 to about 0.33; from about 0.30 to about 0.34; from about 0.30 to about 0.35; from about 0.30 to about 0.36; from about 0.30 to about 0.37; from about 0.30 to about 0.38; from about 0.30 to about 0.39; from about 0.30 to about 0.40; from about 0.30 to about 0.41; from about 0.30 to about 0.42; from about 0.30 to about 0.43; from about 0.30 to about 0.44; from about 0.30 to about 0.45; from about 0.30 to about 0.46; from about 0.30 to about 0.47; from about 0.30 to about 0.48; from about 0.30 to about 0.49; from about 0.30 to about 0.50; from about 0.30 to about 0.51; from about 0.30 to about 0.52; from about 0.30 to about 0.53; from about 0.30 to about 0.54; from about 0.30 to about 0.55; from about 0.30 to about 0.56; from about 0.30 to about 0.57; from about 0.30 to about 0.58; from about 0.30 to about 0.59; from about 0.30 to about 0.60; from about 0.30 to about 0.61; from about 0.30 to about 0.62; from about 0.30 to about 0.63; from about 0.30 to about 0.64; from about 0.30 to about 0.65; from about 0.30 to about 0.66; from about 0.30 to about 0.67; from about 0.30 to about 0.68; from about 0.30 to about 0.69; from about 0.30 to about 0.70; from about 0.30 to about 0.71; from about 0.30 to about 0.72; from about 0.30 to about 0.73; from about 0.30 to about 0.74; from about 0.30 to about 0.75; from about 0.30 to about 0.76; from about 0.30 to about 0.77; from about 0.30 to about 0.78; from about 0.30 to about 0.79; from about 0.30 to about 0.80; from about 0.30 to about 0.81; from about 0.30 to about 0.82; from about 0.30 to about 0.83; from about 0.30 to about 0.84; from about 0.30 to about 0.85; from about 0.30 to about 0.86; from about 0.30 to about 0.87; from about 0.30 to about 0.88; from about 0.30 to about 0.89; from about 0.30 to about 0.90; from about 0.30 to about 0.91; from about 0.30 to about 0.92; from about 0.30 to about 0.93; from about 0.30 to about 0.94; from about 0.30 to about 0.95; from about 0.30 to about 0.96; from about 0.30 to about 0.97; from about 0.30 to about 0.98; from about 0.30 to about 0.99; from about 0.30 to about 1.00; from about 0.40 to about 0.40; from about 0.40 to about 0.41; from about 0.40 to about 0.42; from about 0.40 to about 0.43; from about 0.40 to about 0.44; from about 0.40 to about 0.45; from about 0.40 to about 0.46; from about 0.40 to about 0.47; from about 0.40 to about 0.48; from about 0.40 to about 0.49; from about 0.40 to about 0.50; from about 0.40 to about 0.51; from about 0.40 to about 0.52; from about 0.40 to about 0.53; from about 0.40 to about 0.54; from about 0.40 to about 0.55; from about 0.40 to about 0.56; from about 0.40 to about 0.57; from about 0.40 to about 0.58; from about 0.40 to about 0.59; from about 0.40 to about 0.60; from about 0.40 to about 0.61; from about 0.40 to about 0.62; from about 0.40 to about 0.63; from about 0.40 to about 0.64; from about 0.40 to about 0.65; from about 0.40 to about 0.66; from about 0.40 to about 0.67; from about 0.40 to about 0.68; from about 0.40 to about 0.69; from about 0.40 to about 0.70; from about 0.40 to about 0.71; from about 0.40 to about 0.72; from about 0.40 to about 0.73; from about 0.40 to about 0.74; from about 0.40 to about 0.75; from about 0.40 to about 0.76; from about 0.40 to about 0.77; from about 0.40 to about 0.78; from about 0.40 to about 0.79; from about 0.40 to about 0.80; from about 0.40 to about 0.81; from about 0.40 to about 0.82; from about 0.40 to about 0.83; from about 0.40 to about 0.84; from about 0.40 to about 0.85; from about 0.40 to about 0.86; from about 0.40 to about 0.87; from about 0.40 to about 0.88; from about 0.40 to about 0.89; from about 0.40 to about 0.90; from about 0.40 to about 0.91; from about 0.40 to about 0.92; from about 0.40 to about 0.93; from about 0.40 to about 0.94; from about 0.40 to about 0.95; from about 0.40 to about 0.96; from about 0.40 to about 0.97; from about 0.40 to about 0.98; from about 0.40 to about 0.99; from about 0.40 to about 1.00; from about 0.50 to about 0.51; from about 0.50 to about 0.52; from about 0.50 to about 0.53; from about 0.50 to about 0.54; from about 0.50 to about 0.55; from about 0.50 to about 0.56; from about 0.50 to about 0.57; from about 0.50 to about 0.58; from about 0.50 to about 0.59; from about 0.50 to about 0.60; from about 0.50 to about 0.61; from about 0.50 to about 0.62; from about 0.50 to about 0.63; from about 0.50 to about 0.64; from about 0.50 to about 0.65; from about 0.50 to about 0.66; from about 0.50 to about 0.67; from about 0.50 to about 0.68; from about 0.50 to about 0.69; from about 0.50 to about 0.70; from about 0.50 to about 0.71; from about 0.50 to about 0.72; from about 0.50 to about 0.73; from about 0.50 to about 0.74; from about 0.50 to about 0.75; from about 0.50 to about 0.76; from about 0.50 to about 0.77; from about 0.50 to about 0.78; from about 0.50 to about 0.79; from about 0.50 to about 0.80; from about 0.50 to about 0.81; from about 0.50 to about 0.82; from about 0.50 to about 0.83; from about 0.50 to about 0.84; from about 0.50 to about 0.85; from about 0.50 to about 0.86; from about 0.50 to about 0.87; from about 0.50 to about 0.88; from about 0.50 to about 0.89; from about 0.50 to about 0.90; from about 0.50 to about 0.91; from about 0.50 to about 0.92; from about 0.50 to about 0.93; from about 0.50 to about 0.94; from about 0.50 to about 0.95; from about 0.50 to about 0.96; from about 0.50 to about 0.97; from about 0.50 to about 0.98; from about 0.50 to about 0.99; from about 0.50 to about 1.00; from about 0.60 to about 0.61; from about 0.60 to about 0.62; from about 0.60 to about 0.63; from about 0.60 to about 0.64; from about 0.60 to about 0.65; from about 0.60 to about 0.66; from about 0.60 to about 0.67; from about 0.60 to about 0.68; from about 0.60 to about 0.69; from about 0.60 to about 0.70; from about 0.60 to about 0.71; from about 0.60 to about 0.72; from about 0.60 to about 0.73; from about 0.60 to about 0.74; from about 0.60 to about 0.75; from about 0.60 to about 0.76; from about 0.60 to about 0.77; from about 0.60 to about 0.78; from about 0.60 to about 0.79; from about 0.60 to about 0.80; from about 0.60 to about 0.81; from about 0.60 to about 0.82; from about 0.60 to about 0.83; from about 0.60 to about 0.84; from about 0.60 to about 0.85; from about 0.60 to about 0.86; from about 0.60 to about 0.87; from about 0.60 to about 0.88; from about 0.60 to about 0.89; from about 0.60 to about 0.90; from about 0.60 to about 0.91; from about 0.60 to about 0.92; from about 0.60 to about 0.93; from about 0.60 to about 0.94; from about 0.60 to about 0.95; from about 0.60 to about 0.96; from about 0.60 to about 0.97; from about 0.60 to about 0.98; from about 0.60 to about 0.99; from about 0.60 to about 1.00; from about 0.70 to about 0.71; from about 0.70 to about 0.72; from about 0.70 to about 0.73; from about 0.70 to about 0.74; from about 0.70 to about 0.75; from about 0.70 to about 0.76; from about 0.70 to about 0.77; from about 0.70 to about 0.78; from about 0.70 to about 0.79; from about 0.70 to about 0.80; from about 0.70 to about 0.81; from about 0.70 to about 0.82; from about 0.70 to about 0.83; from about 0.70 to about 0.84; from about 0.70 to about 0.85; from about 0.70 to about 0.86; from about 0.70 to about 0.87; from about 0.70 to about 0.88; from about 0.70 to about 0.89; from about 0.70 to about 0.90; from about 0.70 to about 0.91; from about 0.70 to about 0.92; from about 0.70 to about 0.93; from about 0.70 to about 0.94; from about 0.70 to about 0.95; from about 0.70 to about 0.96; from about 0.70 to about 0.97; from about 0.70 to about 0.98; from about 0.70 to about 0.99; from about 0.70 to about 1.00; from about 0.80 to about 0.80; from about 0.80 to about 0.81; from about 0.80 to about 0.82; from about 0.80 to about 0.83; from about 0.80 to about 0.84; from about 0.80 to about 0.85; from about 0.80 to about 0.86; from about 0.80 to about 0.87; from about 0.80 to about 0.88; from about 0.80 to about 0.89; from about 0.80 to about 0.90; from about 0.80 to about 0.91; from about 0.80 to about 0.92; from about 0.80 to about 0.93; from about 0.80 to about 0.94; from about 0.80 to about 0.95; from about 0.80 to about 0.96; from about 0.80 to about 0.97; from about 0.80 to about 0.98; from about 0.80 to about 0.99; from about 0.80 to about 1.00; from about 0.90 to about 0.91; from about 0.90 to about 0.92; from about 0.90 to about 0.93; from about 0.90 to about 0.94; from about 0.90 to about 0.95; from about 0.90 to about 0.96; from about 0.90 to about 0.97; from about 0.90 to about 0.98; from about 0.90 to about 0.99; from about 0.90 to about 1.00, at room temperature.

In some embodiments, M may be iron and the active material particles may form a stable solid solution when x ranges from about 0 to about 0.8. In some embodiments, M may be iron and the active material particles may form a stable solid solution when x ranges from about 0 to about 0.9. In some embodiments, M may be iron and the active material particles may form a stable solid solution when x ranges from about 0 to about 0.95.

In some embodiments, the electrode may further comprise a current collector having a surface. In some embodiments, the electrode may comprise two or more layers, each layer having a first surface and a second surface, wherein the first surface of the first layer is in electrical communication with the current collector at the current collector surface, and, wherein the first surface of the second layer is in electrical and ionic communication with the second surface of the first layer. In some embodiments, the first layer may comprise smaller active material particles, on average, than the second layer. In some embodiments, the first layer comprises fewer conductive particles, on average, than the second layer. In some embodiments, the layers may be imaginary boundaries delineating two regions of an electrode having different functional properties.

In some embodiments, the electrode may comprise x, y, and z dimensions, and at least one layer runs in one or a combination of the x, y, and z dimensions. In some embodiments, the different layers or regions run parallel to a plane defined by the x and y dimensions. In some embodiments, the different layers or regions traverse the z dimension. In some embodiments, at least one of the layers may have a boundary running substantially parallel to one of the surface of the current collector, or the layers may have a boundary running substantially perpendicular to the surface of the current collector, or both. In some instances, the boundary is imaginary.

In some embodiments, at least two adjacent layers can be tape delaminated when a delaminating force is applied. In some embodiments, at least two adjacent layers cannot be delaminated when a tape delaminating force is applied.

In some embodiments, the electrode may be a monolithic structure, or the electrode may not be monolithic. In some embodiments, monolithic is defined as having no discernable boundaries. In some embodiments, monolithic is defined as a structure previously having discernable boundaries, layers, and/or regions, however, the discernable boundaries, layers, and/or regions have merged, fused, solvent welded, bonded, adhered, and/or become integral to the structure as a whole.

In some embodiments, there may be at least one conductive layer between two adjacent layers, and the conductive layer may comprise a plurality of conductive particles, the conductive particles may comprise one or a combination of: buckyballs; buckminsterfullerenes; carbon; carbon black; ketjan black; carbon nanostructures; carbon nanotubes; carbon nanoballs; carbon fiber; graphite; graphene; graphitic sheets; graphite nanoparticles; and, potato graphite. In some embodiments, the conductive layer may comprise a thickness of about 0.01 μm; or about 0.02 μm; or about 0.03 μm; or about 0.04 μm; or about 0.05 μm; or about 0.06 μm; or about 0.07 μm; or about 0.08 μm; or about 0.09; 0.1 μm; or about 0.2 μm; or about 0.3 μm; or about 0.4 μm; or about 0.5 μm; or about 0.6 μm; or about 0.7 μm; or about 0.8 μm; or about 0.9 μm; or about 1 μm; or about 2 μm; or about 3 μm; or about 4 μm; or about 5 μm; or about 6 μm; about or 7 μm; or about 8 μm; or about 9 μm; or about 10 μm; or about 11 μm; or about 12 μm; or about 13 μm; or about 14 μm; or about 15 μm; or about 16 μm; or about 17 μm; or about 18 μm; or about 19 μm; or, about 20 μm.

In some embodiments, the invention provides for an electrode comprising an electrode matrix comprising at least one functional gradient therein, the electrode matrix comprising active material particles capable of reversibly storing ions; and, conductive particles. In some embodiments the functional gradient is a gradient selected from the group consisting of: a particle size gradient; a particle composition gradient; a particle concentration gradient; an electron conductivity gradient; an ion permeability gradient; ion storage capacity gradient; a porosity gradient; and, a density gradient.

In some embodiments, the functional gradient may be a plurality of functional gradients, wherein each of the plurality of functional gradients may comprise one or a combination of a particle size gradient; a particle composition gradient; a particle concentration gradient; an electron conductivity gradient; an ion permeability gradient; ion storage capacity gradient; a porosity gradient; and, a density gradient. In some embodiments, at least one of the plurality of functional gradients may be different from at least one other plurality of functional gradients. In some embodiments, the functional gradient may be spatially organized, and the spatial organization may be with respect to one or a combination of dimensions selected from x, y, or z dimensions, the spatial organization may be with respect to a combination of two or more dimensions.

In some embodiments, the functional gradient may be mathematically represented by a polynomial function or combination of polynomial functions which may include, and may not be limited to, first; second; third; fourth; fifth; sixth; seventh; eighth; ninth; or tenth degree polynomial functions.

In some embodiments, the functional gradient may be a concentration gradient represented by the mathematical formula:

$$∇ f = ( \frac{\partial f}{\partial {x}_{1}} , … \frac{\partial f}{\partial {x}_{n}} ) .$$

In some embodiments, the functional gradient may have one or a combination of a linear profile, a common logarithmic profile, a natural logarithmic profile, a bell-shaped profile, a mono-modal profile, a bi-modal profile, a continuous profile, a discontinuous profile, the discontinuous profile may be interrupted by one or more gaps, the gaps may correspond to one or more regions in the gradient where only the conductive particles are present. In some embodiments, the gaps may correspond to one or more regions in the gradient where both active material particles and conductive particles are present or where neither active material particles nor conductive particles are present. In some embodiments, the gaps correspond to voids in the electrode matrix resulting from removal of void forming particles. In some embodiments, the gaps correspond to voids introduced into the electrode matrix by first saturating the coating suspension by placing under a gas pressure above ambient and coating the electrode support at a gas pressure less than the gas pressure above ambient and/or coating the electrode support under a vacuum.

The invention provides, in another aspect, a method for making an electrode comprising providing an electrode support having a surface; and, forming an electrode matrix upon the electrode support surface, the electrode matrix comprising active material particles capable of reversibly storing an ion; and conductive particles, wherein the electrode matrix has a functional gradient formed therein. In some embodiments, the functional gradient may be a gradient, or combination of gradients, including, but not limited to, a compositional gradient; a structural gradient; and, an organizational gradient, or, in some instances, any combination thereof.

In some embodiments, the functional gradient is arranged within the electrode matrix normal to the surface of the electrode support, or the functional gradient is arranged within the electrode matrix about normal to the surface of the electrode support, the functional gradient is arranged within the electrode matrix not normal to the surface of the electrode support, or the functional gradient is arranged within the electrode matrix parallel to the surface of the electrode support. In some embodiments, the compositional gradient is a gradient where the active material particles are distributed along the compositional gradient with varying concentrations per unit volume of the electrode matrix, preferably where the active material particles concentration decreases proportionally with respect to the compositional gradient, or preferably the compositional gradient is a gradient where the conductive particles are distributed along the compositional gradient with varying concentrations per unit volume of the electrode matrix.

In some preferred embodiments, the electrode matrix may further comprises a polymer binder, and wherein the compositional gradient is a gradient where the binder polymers are distributed along the compositional gradient with varying concentrations per unit volume of the electrode matrix.

In some embodiments, the functional gradient is a structural gradient and the active material particles have a cross-sectional dimension ranging in size from about 1 nm to about 30 μm, and the active material particles are distributed along the functional gradient according to the cross-sectional dimension.

The invention provides, in another aspect, a method for making a battery electrode comprising the steps of providing an electrode support having a surface; applying a first layer upon the support surface, the first electrode layer having a first surface and a second surface, wherein the first layer first surface and the electrode support surface form an electrically conductive interface between each other; applying a second layer having first and second surfaces, the second layer first surface and the first layer second surface forming an electrically and ionically conductive interface between each other, wherein the first layer and the second layer are functionally different than each other.

The invention provides, in another aspect, a method for making a battery electrode comprising the steps of: providing an electrode support having a surface; forming an electrode matrix upon the surface of the electrode support, the electrode matrix comprising: active material particles, the active material particles being able to reversibly store ions; and, conductive particles, wherein the electrode matrix has a gradient therein.

In some embodiments, the gradient may be a functional gradient and the gradient may run substantially perpendicular to the surface of the electrode support. In some embodiments, the electrode matrix may be seamlessly formed. In some embodiments, the gradient may be continuous or the gradient is discontinuous, or the gradient may have portions that are continuous and other portions that are discontinuous.

In some embodiments, the electrode matrix may be formed by spraying, electro-spraying, powder coating, or the electrode matrix may be formed by casting, or electroplating; or electrophoretic deposition, or the electrode matrix may be formed by a combination of the aforementioned modalities. In some embodiments, the combination of modalities includes electrophoretic deposition and spraying. In some embodiments, the electrode matrix may be formed by extrusion, of co-extrusion, of multilayered extrusion, of dip coating, or formed using a doctor blade, or formed using a slot die, and/or a combination thereof.

In some embodiments, the first layer and the second layer may differ by the average size of the active material particles or where the first and second layers each comprise a different amount of the conductive particles, or a combination of both.

In some embodiments, the electrode matrix may further comprise a polymer binder. In some embodiments, the polymer binder may be selected from a group including: polymer binder comprises a polymer selected from the group consisting of: acacia gum; acrylic; polyvinyl acetate acrylate; acrylate; acrylonitrile/butadiene/styrene carboxymethyl cellulose; acrylonitrile/butadiene rubber (NBR); agarose; aldehyde polymer; alginate; butyl rubber; carboxymethylcellulose; carrageenan; casein; ethylene/prolylene/diene terpolymer (EPDM) ethylene vinyl alcohol; polyvinyl alcohol (EVA); polyvinyl acetate (PVA); gelatin; guar gum; hydroxymethylcellulose; hydroxyethylcellulose; hydroxyl ethyl methyl cellulose; hydroxypropylcellulose (HPC); isobutylene-maleic anyhydride copolymer; ethylene-maleic anyhydride copolymer; pectin; polyvinyl dichloride; polyvinyl difluoride; ethylene vinyl acetate; ethylene vinyl chloride; bismaleimide; butadiene/acrylonitrile; ethylene acrylic acid; epoxy; melamine/formaldehyde; phenolic; polycarbonate; polyethylene; polyester; polyimide; polyvinyl chloride; polyester; styrene; styrene polyphenylene; oxide; polyethylene glycol; polyacrylnitrile; polyacrylic acid; poly(ε-caprolactone) (PLL); polyimide; polyethylene (PE); polyethyleneoxide (PEO); polyglycolide (PGA); poly(lactide); polypropylene oxide (PPO); polypropylene (PP); polyurethane; polyvinyl alcohol; neoprene; polyiosobutylene (PIB); starch; styrene/acrylonitrile/styrene (SIS) block copolymers; styrene/butadiene rubber (SBR); styrene/butadiene/styrene (SBS) block copolymers; styrene-maleic anyhydride copolymer; tragacanth; urea/formaldehyde; and/or, urethane; and, xanthum gum.

In some embodiments, the first and the second layers each comprise a different amount of the polymer binder.

In some embodiments, the first layer may have an average thickness, or range of two or more average thicknesses, the thicknesses being about 1 μm; or, about 2 μm; or, about 3 μm; or, about 4 μm; or, about 5 μm; or, about 6 μm; or, about 7 μm; or, about 8 μm; or, about 9 μm; or, about 10 μm; or, about 11 μm; or, about 12 μm; or, about 13 μm; or, about 14 μm; or, about 15 μm; or, about 16 μm; or, about 17 μm; or, about 18 μm; or, about 19 μm; or, about 20 μm; or, about 21 μm; or, about 22 μm; or, about 23 μm; or, about 24 μm; or, about 25 μm; or, about 26 μm; or, about 27 μm; or, about 28 μm; or, about 39 μm; or, about 30 μm; or, about 31 μm; or, about 32 μm; or, about 33 μm; or, about 34 μm; or, about 35 μm; or, about 36 μm; or, about 37 μm; or, about 38 μm; or, about 39 μm; or, about 40 μm; or, about 41 μm; or, about 42 μm; or, about 43 μm; or, about 44 μm; or, about 45 μm; or, about 46 μm; or, about 47 μm; or, about 48 μm; or, about 49 μm; or, about 50 μm; or, about 51 μm; or, about 52 μm; or, about 53 μm; or, about 54 μm; or, about 55 μm; or, about 56 μm; or, about 57 μm; or, about 58 μm; or, about 59 μm; or, about 60 μm; or, about 61 μm; or, about 62 μm; or, about 63 μm; or, about 64 μm; or, about 65 μm; or, about 66 μm; or, about 67 μm; or, about 68 μm; or, about 69 μm; or, about 70 μm; or, about 71 μm; or, about 72 μm; or, about 73 μm; or, about 74 μm; or, about 75 μm; or, about 76 μm; or, about 77 μm; or, about 78 μm; or, about 79 μm; or, about 80 μm; or, about 81 μm; or, about 82 μm; or, about 83 μm; or, about 84 μm; or, about 85 μm; or, about 86 μm; or, about 87 μm; or, about 88 μm; or, about 89 μm; or, about 90 μm; or, about 91 μm; or, about 92 μm; or, about 93 μm; or, about 94 μm; or, about 95 μm; or, about 96 μm; or, about 97 μm; or, about 98 μm; or, about 99 μm; or, about 100 μm; or, about 101 μm; or, about 102 μm; or, about 103 μm; or, about 104 μm; or, about 105 μm; or, about 106 μm; or, about 107 μm; or, about 108 μm; or, about 109 μm; or, about 110 μm; or, about 112 μm; or, about 113 μm; or, about 114 μm; or, about 115 μm; or, about 116 μm; or, about 117 μm; or, about 118 μm; or, about 119 μm; or, about 120 μm; or, about 121 μm; or, about 122 μm; or, about 123 μm; or, about 124 μm; or, about 125 μm; or, about 126 μm; or, about 127 μm; or, about 128 μm; or, about 139 μm; or, about 130 μm; or, about 131 μm; or, about 132 μm; or, about 133 μm; or, about 134 μm; or, about 135 μm; or, about 136 μm; or, about 137 μm; or, about 138 μm; or, about 139 μm; or, about 140 μm; or, about 141 μm; or, about 142 μm; or, about 143 μm; or, about 144 μm; or, about 145 μm; or, about 146 μm; or, about 147 μm; or, about 148 μm; or, about 149 μm; or, about 150 μm; or, about 151 μm; or, about 152 μm; or, about 153 μm; or, about 154 μm; or, about 155 μm; or, about 156 μm; or, about 157 μm; or, about 158 μm; or, about 159 μm; or, about 160 μm; or, about 161 μm; or, about 162 μm; or, about 163 μm; or, about 164 μm; or, about 165 μm; or, about 166 μm; or, about 167 μm; or, about 168 μm; or, about 169 μm; or, about 170 μm; or, about 171 μm; or, about 172 μm; or, about 173 μm; or, about 174 μm; or, about 175 μm; or, about 176 μm; or, about 177 μm; or, about 178 μm; or, about 179 μm; or, about 180 μm; or, about 181 μm; or, about 182 μm; or, about 183 μm; or, about 184 μm; or, about 185 μm; or, about 186 μm; or, about 187 μm; or, about 188 μm; or, about 189 μm; or, about 190 μm; or, about 191 μm; or, about 192 μm; or, about 193 μm; or, about 194 μm; or, about 195 μm; or, about 196 μm; or, about 197 μm; or, about 198 μm; or, about 199 μm; or, about 200 μm; or, about 201 μm; or, about 202 μm; or, about 203 μm; or, about 204 μm; or, about 205 μm; or, about 206 μm; or, about 207 μm; or, about 208 μm; or, about 209 μm; or, about 210 μm; or, about 211 μm; or, about 212 μm; or, about 213 μm; or, about 214 μm; or, about 215 μm; or, about 216 μm; or, about 217 μm; or, about 218 μm; or, about 219 μm; or, about 220 μm; or, about 221 μm; or, about 222 μm; or, about 223 μm; or, about 224 μm; or, about 225 μm; or, about 226 μm; or, about 227 μm; or, about 228 μm; or, about 239 μm; or, about 230 μm; or, about 231 μm; or, about 232 μm; or, about 233 m; or, about 234 μm; or, about 235 μm; or, about 236 μm; or, about 237 μm; or, about 238 μm; or, about 239 μm; or, about 240 μm; or, about 241 μm; or, about 242 μm; or, about 243 μm; or, about 244 μm; or, about 245 μm; or, about 246 μm; or, about 247 μm; or, about 248 μm; or, about 249 μm; or, about 250 μm; or, about 251 μm; or, about 252 μm; or, about 253 μm; or, about 254 μm; or, about 255 μm; or, about 256 μm; or, about 257 μm; or, about 258 μm; or, about 259 μm; or, about 260 μm; or, about 261 μm; or, about 262 μm; or, about 263 μm; or, about 264 μm; or, about 265 μm; or, about 266 μm; or, about 267 μm; or, about 268 μm; or, about 269 μm; or, about 270 μm; or, about 271 μm; or, about 272 μm; or, about 273 μm; or, about 274 μm; or, about 275 μm; or, about 276 μm; or, about 277 μm; or, about 278 μm; or, about 279 μm; or, about 280 μm; or, about 281 μm; or, about 282 μm; or, about 283 μm; or, about 284 μm; or, about 285 μm; or, about 286 μm; or, about 287 μm; or, about 288 μm; or, about 289 μm; or, about 290 μm; or, about 291 μm; or, about 292 μm; or, about 293 μm; or, about 294 μm; or, about 295 μm; or, about 296 μm; or, about 297 μm; or, about 298 μm; or, about 299 μm; or, about 300 μm.

In some embodiments, the first layer may have an average thickness, or a combination of thicknesses ranging: from about 1 μm to about 10 μm; or, from about 10 μm to about 20 μm; or, from about 20 μm to about 30 μm; or, from about 30 μm to about 40 μm; or, from about 40 μm to about 50 μm; or, from about 50 μm to about 60 μm; or, from about 60 μm to about 70 μm; or, from about 70 μm to about 80 μm; or, from about 80 μm to about 90 μm; or, from about 90 μm to about 100 μm; or, from about 100 μm to about 110 μm; or, from about 110 μm to about 120 μm; or, from about 120 μm to about 130 μm; or, from about 130 μm to about 140 μm; or, from about 140 μm to about 150 μm; or, from about 150 μm to about 160 μm; or, from about 160 μm to about 170 μm; or, from about 170 μm to about 180 μm; or, from about 180 μm to about 190 μm; or, from about 190 μm to about 200 μm; or, from about 5 μm to about 10 μm; or, from about 10 μm to about 15 μm; or, from about 15 μam to about 20 μm; or, from about 20 μm to about 25 μm; or, from about 25 μm to about 30 μm; or, from about 30 μm to about 35 μm; or, from about 35 μm to about 40 μm; or, from about 40 μm to about 45 μm; or, from about 45 μm to about 50 μm; or, from about 50 μm to about 55 μm; or, from about 55 μm to about 60 μm; or, from about 60 μm to about 65 μm; or, from about 65 μm to about 70 μm; or, from about 70 μm to about 75 μm; or, from about 75 μm to about 80 μm; or, from about 80 μm to about 85 μm; or, from about 85 μm to about 90 μm; or, from about 90 μm to about 95 μm; or, from about 95 μm to about 100 μm; or, from about 100 μm to about 105 μm; or, from about 105 μm to about 110 μm; or, from about 110 μm to about 115 μm; or, from about 115 μm to about 120 μm; or, from about 120 μm to about 125 μm; or, from about 125 μm to about 130 μm; or, from about 130 μm to about 135 μm; or, from about 135 μm to about 140 μm; or, from about 140 μm to about 145 μm; or, from about 145 μm to about 150 μm; or, from about 150 μm to about 155 μm; or, from about 155 μm to about 160 μm; or, from about 160 μm to about 165 μm; or, from about 165 μm to about 170 μm; or, from about 170 μm to about 175 μm; or, from about 175 μm to about 180 μm; or, from about 185 μm to about 190 μm; or, from about 190 μm to about 195 μm; or, from about 195 μm to about 200 μm; or, from about 0 μm to about 50 μm; or, from about 10 μam to about 60 μm; or, from about 20 μm to about 70 μm; or, from about 30 μm to about 80 μm; or, from about 40 μm to about 90 μm; or, from about 50 μm to about 100 μm; or, from about 60 μm to about 110 μm; or, from about 70 μm to about 120 μm; or, from about 80 μm to about 130 μm; or, from about 90 μm to about 140 μm; or, from about 100 μm to about 150 μm; or, from about 110 μm to about 160 μm; or, from about 120 μm to about 170 μm; or, from about 130 μm to about 180 μm; or, from about 140 μm to about 190 μm; or, from about 150 μm to about 200 μm; or, from about 160 μm to about 210 μm; or, from about 170 μm to about 220 μm; or, from about 180 μm to about 230 μm; or, and, from about 190 μm to about 240 μm.

In some embodiments, the ions may be lithium ions. In some embodiments, the active material particles may comprise a chalcogen compound that is one or a combination of the following: FeS₂; TiS₂; MoS₂; V₂O₃, V₂O₅, V₆O₁₃, MnO₂. In some embodiments, the active material particles may comprise a composite lithium oxide wherein the composite lithium oxide may comprise one or a combination of: LiCoO₂; LiFePO₄; LiNiO₂; LiMnO₂; and, LiMn₂O₄.

In some embodiments, the active material particles may comprises LixNyM_{1-y}O₂, wherein M comprises a metal, for example, but not limited to, a transitional metal; titanium; vanadium; chromium; manganese; iron; cobalt; nickel; copper; zinc; and aluminum, and that x and y may have the following values: 0.05≦x≦1.10, 0.5≦y≦1.0).

In some embodiments, the active material comprises a material having the formula Li₁₋ₓMₓFePO₄, wherein M is a dopant selected from the group consisting of: titanium; vanadium; chromium; manganese; iron; cobalt; nickel; copper; zinc; zirconium; niobium; molybdenum; silver; and, tungsten, and, wherein x is a number selected from the group of: about 0.00; about 0.01; about 0.02; about 0.03; about 0.04; about 0.05; about 0.06; about 0.07; about 0.08; about 0.09; about 0.10; about 0.11; about 0.12; about 0.13; about 0.14; about 0.15; about 0.16; about 0.17; about 0.18; about 0.19; about 0.20; about 0.21; about 0.22; about 0.23; about 0.24; about 0.25; about 0.26; about 0.27; about 0.28; about 0.29; about 0.30; about 0.31; about 0.32; about 0.33; about 0.34; about 0.35; about 0.36; about 0.37; about 0.38; about 0.39; about 0.40; about 0.41; about 0.42; about 0.43; about 0.44; about 0.45; about 0.46; about 0.47; about 0.48; about 0.49; about 0.50; about 0.51; about 0.52; about 0.53; about 0.54; about 0.55; about 0.56; about 0.57; about 0.58; about 0.59; about 0.60; about 0.61; about 0.62; about 0.63; about 0.64; about 0.65; about 0.66; about 0.67; about 0.68; about 0.69; about 0.70; about 0.71; about 0.72; about 0.73; about 0.74; about 0.75; about 0.76; about 0.77; about 0.78; about 0.79; about 0.80; about 0.81; about 0.82; about 0.83; about 0.84; about 0.85; about 0.86; about 0.87; about 0.88; about 0.89; about 0.90; about 0.91; about 0.92; about 0.93; about 0.94; about 0.95; about 0.96; about 0.97; about 0.98; about 0.99; and, about 1.00.

In some embodiments, the active material may comprise a material having the formula Li₁₋ₓMₓFePO₄, where M is a metal, or combination of metals, selected from the group of: titanium; vanadium; chromium; manganese; iron; cobalt; nickel; copper; zinc; zirconium; niobium; molybdenum; silver; and, tungsten, and, wherein x is a number range selected from the group consisting of: from about 0.00 to about 0.01; from about 0.00 to about 0.02; from about 0.00 to about 0.03; from about 0.00 to about 0.04; from about 0.00 to about 0.05; from about 0.00 to about 0.06; from about 0.00 to about 0.07; from about 0.00 to about 0.08; from about 0.00 to about 0.09; from about 0.00 to about 0.10; from about 0.00 to about 0.11; from about 0.00 to about 0.12; from about 0.00 to about 0.13; from about 0.00 to about 0.14; from about 0.00 to about 0.15; from about 0.00 to about 0.16; from about 0.00 to about 0.17; from about 0.00 to about 0.18; from about 0.00 to about 0.19; from about 0.00 to about 0.20; from about 0.00 to about 0.21; from about 0.00 to about 0.22; from about 0.00 to about 0.23; from about 0.00 to about 0.24; from about 0.00 to about 0.25; from about 0.00 to about 0.26; from about 0.00 to about 0.27; from about 0.00 to about 0.28; from about 0.00 to about 0.29; from about 0.00 to about 0.30; from about 0.00 to about 0.31; from about 0.00 to about 0.32; from about 0.00 to about 0.33; from about 0.00 to about 0.34; from about 0.00 to about 0.35; from about 0.00 to about 0.36; from about 0.00 to about 0.37; from about 0.00 to about 0.38; from about 0.00 to about 0.39; from about 0.00 to about 0.40; from about 0.00 to about 0.41; from about 0.00 to about 0.42; from about 0.00 to about 0.43; from about 0.00 to about 0.44; from about 0.00 to about 0.45; from about 0.00 to about 0.46; from about 0.00 to about 0.47; from about 0.00 to about 0.48; from about 0.00 to about 0.49; from about 0.00 to about 0.50; from about 0.00 to about 0.51; from about 0.00 to about 0.52; from about 0.00 to about 0.53; from about 0.00 to about 0.54; from about 0.00 to about 0.55; from about 0.00 to about 0.56; from about 0.00 to about 0.57; from about 0.00 to about 0.58; from about 0.00 to about 0.59; from about 0.00 to about 0.60; from about 0.00 to about 0.61; from about 0.00 to about 0.62; from about 0.00 to about 0.63; from about 0.00 to about 0.64; from about 0.00 to about 0.65; from about 0.00 to about 0.66; from about 0.00 to about 0.67; from about 0.00 to about 0.68; from about 0.00 to about 0.69; from about 0.00 to about 0.70; from about 0.00 to about 0.71; from about 0.00 to about 0.72; from about 0.00 to about 0.73; from about 0.00 to about 0.74; from about 0.00 to about 0.75; from about 0.00 to about 0.76; from about 0.00 to about 0.77; from about 0.00 to about 0.78; from about 0.00 to about 0.79; from about 0.00 to about 0.80; from about 0.00 to about 0.81; from about 0.00 to about 0.82; from about 0.00 to about 0.83; from about 0.00 to about 0.84; from about 0.00 to about 0.85; from about 0.00 to about 0.86; from about 0.00 to about 0.87; from about 0.00 to about 0.88; from about 0.00 to about 0.89; from about 0.00 to about 0.90; from about 0.00 to about 0.91; from about 0.00 to about 0.92; from about 0.00 to about 0.93; from about 0.00 to about 0.94; from about 0.00 to about 0.95; from about 0.00 to about 0.96; from about 0.00 to about 0.97; from about 0.00 to about 0.98; from about 0.00 to about 0.99; from about 0.00 to about 0.10; from about 0.10 to about 0.11; from about 0.10 to about 0.12; from about 0.10 to about 0.13; from about 0.10 to about 0.14; from about 0.10 to about 0.15; from about 0.10 to about 0.16; from about 0.10 to about 0.17; from about 0.10 to about 0.18; from about 0.10 to about 0.19; from about 0.10 to about 0.20; from about 0.10 to about 0.21; from about 0.10 to about 0.22; from about 0.10 to about 0.23; from about 0.10 to about 0.24; from about 0.10 to about 0.25; from about 0.10 to about 0.26; from about 0.10 to about 0.27; from about 0.10 to about 0.28; from about 0.10 to about 0.29; from about 0.10 to about 0.30; from about 0.10 to about 0.31; from about 0.10 to about 0.32; from about 0.10 to about 0.33; from about 0.10 to about 0.34; from about 0.10 to about 0.35; from about 0.10 to about 0.36; from about 0.10 to about 0.37; from about 0.10 to about 0.38; from about 0.10 to about 0.39; from about 0.10 to about 0.40; from about 0.10 to about 0.41; from about 0.10 to about 0.42; from about 0.10 to about 0.43; from about 0.10 to about 0.44; from about 0.10 to about 0.45; from about 0.10 to about 0.46; from about 0.10 to about 0.47; from about 0.10 to about 0.48; from about 0.10 to about 0.49; from about 0.10 to about 0.50; from about 0.10 to about 0.51; from about 0.10 to about 0.52; from about 0.10 to about 0.53; from about 0.10 to about 0.54; from about 0.10 to about 0.55; from about 0.10 to about 0.56; from about 0.10 to about 0.57; from about 0.10 to about 0.58; from about 0.10 to about 0.59; from about 0.10 to about 0.60; from about 0.10 to about 0.61; from about 0.10 to about 0.62; from about 0.10 to about 0.63; from about 0.10 to about 0.64; from about 0.10 to about 0.65; from about 0.10 to about 0.66; from about 0.10 to about 0.67; from about 0.10 to about 0.68; from about 0.10 to about 0.69; from about 0.10 to about 0.70; from about 0.10 to about 0.71; from about 0.10 to about 0.72; from about 0.10 to about 0.73; from about 0.10 to about 0.74; from about 0.10 to about 0.75; from about 0.10 to about 0.76; from about 0.10 to about 0.77; from about 0.10 to about 0.78; from about 0.10 to about 0.79; from about 0.10 to about 0.80; from about 0.10 to about 0.81; from about 0.10 to about 0.82; from about 0.10 to about 0.83; from about 0.10 to about 0.84; from about 0.10 to about 0.85; from about 0.10 to about 0.86; from about 0.10 to about 0.87; from about 0.10 to about 0.88; from about 0.10 to about 0.89; from about 0.10 to about 0.90; from about 0.10 to about 0.91; from about 0.10 to about 0.92; from about 0.10 to about 0.93; from about 0.10 to about 0.94; from about 0.10 to about 0.95; from about 0.10 to about 0.96; from about 0.10 to about 0.97; from about 0.10 to about 0.98; from about 0.10 to about 0.99; from about 0.10 to about 1.00; from about 0.20 to about 0.21; from about 0.20 to about 0.22; from about 0.20 to about 0.23; from about 0.20 to about 0.24; from about 0.20 to about 0.25; from about 0.20 to about 0.26; from about 0.20 to about 0.27; from about 0.20 to about 0.28; from about 0.20 to about 0.29; from about 0.20 to about 0.30; from about 0.20 to about 0.31; from about 0.20 to about 0.32; from about 0.20 to about 0.33; from about 0.20 to about 0.34; from about 0.20 to about 0.35; from about 0.20 to about 0.36; from about 0.20 to about 0.37; from about 0.20 to about 0.38; from about 0.20 to about 0.39; from about 0.20 to about 0.40; from about 0.20 to about 0.41; from about 0.20 to about 0.42; from about 0.20 to about 0.43; from about 0.20 to about 0.44; from about 0.20 to about 0.45; from about 0.20 to about 0.46; from about 0.20 to about 0.47; from about 0.20 to about 0.48; from about 0.20 to about 0.49; from about 0.20 to about 0.50; from about 0.20 to about 0.51; from about 0.20 to about 0.52; from about 0.20 to about 0.53; from about 0.20 to about 0.54; from about 0.20 to about 0.55; from about 0.20 to about 0.56; from about 0.20 to about 0.57; from about 0.20 to about 0.58; from about 0.20 to about 0.59; from about 0.20 to about 0.60; from about 0.20 to about 0.61; from about 0.20 to about 0.62; from about 0.20 to about 0.63; from about 0.20 to about 0.64; from about 0.20 to about 0.65; from about 0.20 to about 0.66; from about 0.20 to about 0.67; from about 0.20 to about 0.68; from about 0.20 to about 0.69; from about 0.20 to about 0.70; from about 0.20 to about 0.71; from about 0.20 to about 0.72; from about 0.20 to about 0.73; from about 0.20 to about 0.74; from about 0.20 to about 0.75; from about 0.20 to about 0.76; from about 0.20 to about 0.77; from about 0.20 to about 0.78; from about 0.20 to about 0.79; from about 0.20 to about 0.80; from about 0.20 to about 0.81; from about 0.20 to about 0.82; from about 0.20 to about 0.83; from about 0.20 to about 0.84; from about 0.20 to about 0.85; from about 0.20 to about 0.86; from about 0.20 to about 0.87; from about 0.20 to about 0.88; from about 0.20 to about 0.89; from about 0.20 to about 0.90; from about 0.20 to about 0.91; from about 0.20 to about 0.92; from about 0.20 to about 0.93; from about 0.20 to about 0.94; from about 0.20 to about 0.95; from about 0.20 to about 0.96; from about 0.20 to about 0.97; from about 0.20 to about 0.98; from about 0.20 to about 0.99; from about 0.20 to about 1.00; from about 0.30 to about 0.31; from about 0.30 to about 0.32; from about 0.30 to about 0.33; from about 0.30 to about 0.34; from about 0.30 to about 0.35; from about 0.30 to about 0.36; from about 0.30 to about 0.37; from about 0.30 to about 0.38; from about 0.30 to about 0.39; from about 0.30 to about 0.40; from about 0.30 to about 0.41; from about 0.30 to about 0.42; from about 0.30 to about 0.43; from about 0.30 to about 0.44; from about 0.30 to about 0.45; from about 0.30 to about 0.46; from about 0.30 to about 0.47; from about 0.30 to about 0.48; from about 0.30 to about 0.49; from about 0.30 to about 0.50; from about 0.30 to about 0.51; from about 0.30 to about 0.52; from about 0.30 to about 0.53; from about 0.30 to about 0.54; from about 0.30 to about 0.55; from about 0.30 to about 0.56; from about 0.30 to about 0.57; from about 0.30 to about 0.58; from about 0.30 to about 0.59; from about 0.30 to about 0.60; from about 0.30 to about 0.61; from about 0.30 to about 0.62; from about 0.30 to about 0.63; from about 0.30 to about 0.64; from about 0.30 to about 0.65; from about 0.30 to about 0.66; from about 0.30 to about 0.67; from about 0.30 to about 0.68; from about 0.30 to about 0.69; from about 0.30 to about 0.70; from about 0.30 to about 0.71; from about 0.30 to about 0.72; from about 0.30 to about 0.73; from about 0.30 to about 0.74; from about 0.30 to about 0.75; from about 0.30 to about 0.76; from about 0.30 to about 0.77; from about 0.30 to about 0.78; from about 0.30 to about 0.79; from about 0.30 to about 0.80; from about 0.30 to about 0.81; from about 0.30 to about 0.82; from about 0.30 to about 0.83; from about 0.30 to about 0.84; from about 0.30 to about 0.85; from about 0.30 to about 0.86; from about 0.30 to about 0.87; from about 0.30 to about 0.88; from about 0.30 to about 0.89; from about 0.30 to about 0.90; from about 0.30 to about 0.91; from about 0.30 to about 0.92; from about 0.30 to about 0.93; from about 0.30 to about 0.94; from about 0.30 to about 0.95; from about 0.30 to about 0.96; from about 0.30 to about 0.97; from about 0.30 to about 0.98; from about 0.30 to about 0.99; from about 0.30 to about 1.00; from about 0.40 to about 0.40; from about 0.40 to about 0.41; from about 0.40 to about 0.42; from about 0.40 to about 0.43; from about 0.40 to about 0.44; from about 0.40 to about 0.45; from about 0.40 to about 0.46; from about 0.40 to about 0.47; from about 0.40 to about 0.48; from about 0.40 to about 0.49; from about 0.40 to about 0.50; from about 0.40 to about 0.51; from about 0.40 to about 0.52; from about 0.40 to about 0.53; from about 0.40 to about 0.54; from about 0.40 to about 0.55; from about 0.40 to about 0.56; from about 0.40 to about 0.57; from about 0.40 to about 0.58; from about 0.40 to about 0.59; from about 0.40 to about 0.60; from about 0.40 to about 0.61; from about 0.40 to about 0.62; from about 0.40 to about 0.63; from about 0.40 to about 0.64; from about 0.40 to about 0.65; from about 0.40 to about 0.66; from about 0.40 to about 0.67; from about 0.40 to about 0.68; from about 0.40 to about 0.69; from about 0.40 to about 0.70; from about 0.40 to about 0.71; from about 0.40 to about 0.72; from about 0.40 to about 0.73; from about 0.40 to about 0.74; from about 0.40 to about 0.75; from about 0.40 to about 0.76; from about 0.40 to about 0.77; from about 0.40 to about 0.78; from about 0.40 to about 0.79; from about 0.40 to about 0.80; from about 0.40 to about 0.81; from about 0.40 to about 0.82; from about 0.40 to about 0.83; from about 0.40 to about 0.84; from about 0.40 to about 0.85; from about 0.40 to about 0.86; from about 0.40 to about 0.87; from about 0.40 to about 0.88; from about 0.40 to about 0.89; from about 0.40 to about 0.90; from about 0.40 to about 0.91; from about 0.40 to about 0.92; from about 0.40 to about 0.93; from about 0.40 to about 0.94; from about 0.40 to about 0.95; from about 0.40 to about 0.96; from about 0.40 to about 0.97; from about 0.40 to about 0.98; from about 0.40 to about 0.99; from about 0.40 to about 1.00; from about 0.50 to about 0.51; from about 0.50 to about 0.52; from about 0.50 to about 0.53; from about 0.50 to about 0.54; from about 0.50 to about 0.55; from about 0.50 to about 0.56; from about 0.50 to about 0.57; from about 0.50 to about 0.58; from about 0.50 to about 0.59; from about 0.50 to about 0.60; from about 0.50 to about 0.61; from about 0.50 to about 0.62; from about 0.50 to about 0.63; from about 0.50 to about 0.64; from about 0.50 to about 0.65; from about 0.50 to about 0.66; from about 0.50 to about 0.67; from about 0.50 to about 0.68; from about 0.50 to about 0.69; from about 0.50 to about 0.70; from about 0.50 to about 0.71; from about 0.50 to about 0.72; from about 0.50 to about 0.73; from about 0.50 to about 0.74; from about 0.50 to about 0.75; from about 0.50 to about 0.76; from about 0.50 to about 0.77; from about 0.50 to about 0.78; from about 0.50 to about 0.79; from about 0.50 to about 0.80; from about 0.50 to about 0.81; from about 0.50 to about 0.82; from about 0.50 to about 0.83; from about 0.50 to about 0.84; from about 0.50 to about 0.85; from about 0.50 to about 0.86; from about 0.50 to about 0.87; from about 0.50 to about 0.88; from about 0.50 to about 0.89; from about 0.50 to about 0.90; from about 0.50 to about 0.91; from about 0.50 to about 0.92; from about 0.50 to about 0.93; from about 0.50 to about 0.94; from about 0.50 to about 0.95; from about 0.50 to about 0.96; from about 0.50 to about 0.97; from about 0.50 to about 0.98; from about 0.50 to about 0.99; from about 0.50 to about 1.00; from about 0.60 to about 0.61; from about 0.60 to about 0.62; from about 0.60 to about 0.63; from about 0.60 to about 0.64; from about 0.60 to about 0.65; from about 0.60 to about 0.66; from about 0.60 to about 0.67; from about 0.60 to about 0.68; from about 0.60 to about 0.69; from about 0.60 to about 0.70; from about 0.60 to about 0.71; from about 0.60 to about 0.72; from about 0.60 to about 0.73; from about 0.60 to about 0.74; from about 0.60 to about 0.75; from about 0.60 to about 0.76; from about 0.60 to about 0.77; from about 0.60 to about 0.78; from about 0.60 to about 0.79; from about 0.60 to about 0.80; from about 0.60 to about 0.81; from about 0.60 to about 0.82; from about 0.60 to about 0.83; from about 0.60 to about 0.84; from about 0.60 to about 0.85; from about 0.60 to about 0.86; from about 0.60 to about 0.87; from about 0.60 to about 0.88; from about 0.60 to about 0.89; from about 0.60 to about 0.90; from about 0.60 to about 0.91; from about 0.60 to about 0.92; from about 0.60 to about 0.93; from about 0.60 to about 0.94; from about 0.60 to about 0.95; from about 0.60 to about 0.96; from about 0.60 to about 0.97; from about 0.60 to about 0.98; from about 0.60 to about 0.99; from about 0.60 to about 1.00; from about 0.70 to about 0.71; from about 0.70 to about 0.72; from about 0.70 to about 0.73; from about 0.70 to about 0.74; from about 0.70 to about 0.75; from about 0.70 to about 0.76; from about 0.70 to about 0.77; from about 0.70 to about 0.78; from about 0.70 to about 0.79; from about 0.70 to about 0.80; from about 0.70 to about 0.81; from about 0.70 to about 0.82; from about 0.70 to about 0.83; from about 0.70 to about 0.84; from about 0.70 to about 0.85; from about 0.70 to about 0.86; from about 0.70 to about 0.87; from about 0.70 to about 0.88; from about 0.70 to about 0.89; from about 0.70 to about 0.90; from about 0.70 to about 0.91; from about 0.70 to about 0.92; from about 0.70 to about 0.93; from about 0.70 to about 0.94; from about 0.70 to about 0.95; from about 0.70 to about 0.96; from about 0.70 to about 0.97; from about 0.70 to about 0.98; from about 0.70 to about 0.99; from about 0.70 to about 1.00; from about 0.80 to about 0.80; from about 0.80 to about 0.81; from about 0.80 to about 0.82; from about 0.80 to about 0.83; from about 0.80 to about 0.84; from about 0.80 to about 0.85; from about 0.80 to about 0.86; from about 0.80 to about 0.87; from about 0.80 to about 0.88; from about 0.80 to about 0.89; from about 0.80 to about 0.90; from about 0.80 to about 0.91; from about 0.80 to about 0.92; from about 0.80 to about 0.93; from about 0.80 to about 0.94; from about 0.80 to about 0.95; from about 0.80 to about 0.96; from about 0.80 to about 0.97; from about 0.80 to about 0.98; from about 0.80 to about 0.99; from about 0.80 to about 1.00; from about 0.90 to about 0.91; from about 0.90 to about 0.92; from about 0.90 to about 0.93; from about 0.90 to about 0.94; from about 0.90 to about 0.95; from about 0.90 to about 0.96; from about 0.90 to about 0.97; from about 0.90 to about 0.98; from about 0.90 to about 0.99; and, from about 0.90 to about 1.00.

In some embodiments, the active material particles may comprise a material, or combination of materials, selected from the group of: Li₂MnF₂; Li₂MnO; Li₂MnS; Li₂FeF₂; Li₂FeO; Li₂FeS; Li₂CoF₂; Li₂CoO; Li₂NiF₂; Li₂NiO; Li₂CuF₂: Li₂CuO; Li₂CuS; Li₃VF₃; Li₃V₂O₃; Li₃CrF₃; Li₃Cr₂O₃; Li₃MnF₃; Li₃Mn₂O₃; Li₃FeF₃; Li₃Fe₂O₃; Li₃BiF₃; and, Li₃Bi₂O₃.

In some embodiments, the layers may be seamlessly adjoined and where the layers may or may not have discernable boundaries therebetween.

In some embodiments, the electrode matrix may comprise a plurality of layers numbering in any amount or an amount selected from the group of: 1; 2; 3; 4; 5; 6; 7; 8; 9; 10; 11; 12; 13; 14; 15; 16; 17; 18; 19; 20; 21; 22; 23; 24; 25; 26; 27; 28; 29; 30; 31; 32; 33; 34; 35; 36; 37; 38; 39; 40; 41; 42; 43; 44; 45; 46; 47; 48; 49; 50; 51; 52; 53; 54; 55; 56; 57; 58; 59; 60; 61; 62; 63; 64; 65; 66; 67; 68; 69; 70; 71; 72; 73; 74; 75; 76; 77; 78; 79; 80; 81; 82; 83; 84; 85; 86; 87; 88; 89; 90; 91; 92; 93; 94; 95; 96; 97; 98; 99; and, 100.

In some embodiments, the plurality of layers may alternate between layers comprising conductive particles and layers comprising conductive particles and active material particles.

In some embodiments, the conductive particles may comprise one or more materials selected from the group of: carbon, carbon black, ketjan black; pyrolytic carbon; pitch coke; needle coke; petroleum coke; graphite; glass carbon; organic macromolecular compound fired products; carbon fibers; carbon nanotubes; carbon nanoballs; carbon nanobells; multi-walled carbon nanotubes; single-walled carbon nanotubes; and active carbon.

In another aspect, the invention provides for cells and batteries comprising the electrodes of the invention. In a preferred embodiment, a cell comprises a cathode current collector, a cathode, the cathode being in electrical communication with the cathode current collector, a separator sheet or layer, the separator layer being ion permeable and electrically non-conductive within the operating voltage range of the cell, an anode, an anode current collector in electrical communication with the anode, a housing to hold the before mentioned components, a solvent, and electrolyte salts, wherein either the cathode or anode, or both, contain at least one functional gradient therein.

In some embodiments, the separator is selected from a material that includes, but is not limited to: a microporous membrane made, for example, but not limited to, a dry process or by a wet process. Both processes comprise an extrusion step that produces a thin film and employ one or more orientation steps to generate pores. In some embodiments, the process used to make the separator comprise the use of molten or soluble polymers and may further comprise the steps of: extruding molten polymer to form a film, annealing the film, and stretching the film to generate pores. In other embodiments of the invention, the process comprises mixing extractable additives to form a hot polymer mixture or solution, extruding the hot solution to form a gel-like film, and, extracting soluble additives out of the film to form porous structure to yield, in certain embodiments, slit-pore microstructures. In yet other embodiments, the method may yield electrode supports having interconnected spherical or elliptical pores.

In certain embodiments, the polymer sheet may be made using, for example, but not limited to, a dry-laid process, wet-laid process, spun-bond process or melt-blown process. Each of the aforementioned processes comprises at least three steps: forming fabric webs, bonding the formed webs, and, post-treatment. In preferred embodiments, the web forming and bonding are done in one step. In other embodiments, it can be done in two or more steps.

In some embodiments, the separator is a polymer gel.

In some embodiments, the separator is a polymer gel electrolyte.

In some embodiments, the separator has a thickness having a thickness range selected from the group of thickness ranges of: from about 1 μm to about 10 μm; or, from about 10 μm to about 20 μm; or, from about 20 μm to about 30 μm; or, from about 30 μm to about 40 μm; or, from about 40 μm to about 50 μm; or, from about 50 μm to about 60 μm; or, from about 60 μm to about 70 μm; or, from about 70 μm to about 80 μm; or, from about 80 μm to about 90 μm; or, from about 90 μm to about 100 μm; or, from about 100 μm to about 110 μm; or, from about 110 μm to about 120 μm; or, from about 120 μm to about 130 μm; or, from about 130 μm to about 140 μm; or, from about 140 μm to about 150 μm; or, from about 150 μm to about 160 μm; or, from about 160 μm to about 170 μm; or, from about 170 μm to about 180 μm; or, from about 180 μm to about 190 μm; or, from about 190 μm to about 200 μm; or, from about 5 μm to about 10 μm; or, from about 10 μm to about 15 μm; or, from about 15 μm to about 20 μm; or, from about 20 μm to about 25 μm; or, from about 25 μm to about 30 μm; or, from about 30 μm to about 35 μm; or, from about 35 μm to about 40 μm; or, from about 40 μm to about 45 μm; or, from about 45 μm to about 50 μm; or, from about 50 μm to about 55 μm; or, from about 55 μm to about 60 μm; or, from about 60 μm to about 65 μm; or, from about 65 μm to about 70 μm; or, from about 70 μm to about 75 μm; or, from about 75 μm to about 80 μm; or, from about 80 μm to about 85 μm; or, from about 85 μm to about 90 μm; or, from about 90 μm to about 95 μm; or, from about 95 μm to about 100 μm; or, from about 100 μm to about 105 μm; or, from about 105 μm to about 110 μm; or, from about 110 μm to about 115 μm; or, from about 115 μm to about 120 μm; or, from about 120 μm to about 125 μm; or, from about 125 μm to about 130 μm; or, from about 130 μm to about 135 μm; or, from about 135 μm to about 140 μm; or, from about 140 μm to about 145 μm; or, from about 145 μm to about 150 μm; or, from about 150 μm to about 155 μm; or, from about 155 μm to about 160 μm; or, from about 160 μm to about 165 μm; or, from about 165 μm to about 170 μm; or, from about 170 μm to about 175 μm; or, from about 175 μm to about 180 μm; or, from about 185 μm to about 190 μm; or, from about 190 μm to about 195 μm; or, from about 195 μm to about 200 μm; or, from about 0 μm to about 50 μm; or, from about 10 μm to about 60 μm; or, from about 20 μm to about 70 μm; or, from about 30 μm to about 80 μm; or, from about 40 μm to about 90 μm; or, from about 50 μm to about 100 μm; or, from about 60 μm to about 110 μm; or, from about 70 μm to about 120 μm; or, from about 80 μm to about 130 μm; or, from about 90 μm to about 140 μm; or, from about 100 μm to about 150 μm; or, from about 110 μm to about 160 μm; or, from about 120 μm to about 170 μm; or, from about 130 μm to about 180 μm; or, from about 140 μm to about 190 μm; or, from about 150 μm to about 200 μm; or, from about 160 μm to about 210 μm; or, from about 170 μm to about 220 μm; or, from about 180 μm to about 230 μm; or, and, from about 190 μm to about 240 μm.

In some embodiments, the separator may comprise a plurality of layers or may comprise a single layer. In the multi-layer embodiments, each layer may comprise the same material or one or more layers may comprise a material different from the other layer.

The invention provides, in another aspect, for an apparatus for testing battery electrodes comprising: a first sheet array having first and second sides and comprising a non-electrically conductive support having a plurality of apertures arrayed within the sheet array, each aperture traversing from the first side to the second side; and, a plurality of electrodes arrayed upon the first side of the first sheet array, the electrodes each comprising an electrode support comprising an electrically conductive material, the electrode support having first and second sides; and, an electrodes deposited upon the electrode support first side, each of the electrodes comprising active material particles capable of reversibly storing ions; and, conductive particles, wherein each electrode is electrically and ionically isolated from other electrodes of the sheet array.

In some embodiments, the apparatus may include a second sheet array having first and second sides and comprising: a non-electrically conductive support having a plurality of apertures arrayed within the sheet array, each aperture traversing from the first side to the second side; and, a plurality of electrodes positionally arrayed upon the first side of the second sheet array, the electrodes each comprising: an electrode support comprising an electrically conductive material, the electrode support having first and second sides; and, an electrode deposited upon the electrode support first side, each of the electrodes comprising: active material particles capable of reversibly storing ions; and, conductive particles, wherein each electrode is electrically and ionically isolated from other electrodes of the sheet array.

In some embodiments, the apparatus may further include a separator array arranged between the first and second sheet arrays, the separator array comprising a separator array support; a plurality of separators, the separators being ionically permeable and electrically impermeable, wherein each of the plurality of separators is ionically and electrically isolated from each other, and, wherein each of the first and second sheet arrays is arranged so that the electrodes deposited on each sheet array face each other with an individual separator from the separator array being interposed between each opposing electrode, wherein each opposing electrode support, electrode, and corresponding separator form an electrochemical cell, each electrochemical cell having a volume of electrolyte solution therein, wherein a voltage potential can be applied to each of the electrode supports by contacting each electrode second surface through a corresponding electrode support aperture.

In some embodiments, the apparatus may further comprise first and second electrode contact arrays, each contact array comprising a contact array substrate having first and second surfaces and, associated therewith, a plurality of electrically conductive traces, each trace leading to at least one position within the electrode contact array.

In some embodiments, the apparatus may further comprise a plurality of electrical contacts, each electrical contact in electrical communication with a corresponding electrically conductive trace, each of the plurality of electrical contacts protruding from the first surface of the electrode contact array such that when the sheet arrays second side is associated with the electrode contact array first side, the electrical contact protrudes through one of the apertures of the sheet array to electrically communicate with the second side of the electrode support positionally corresponding to the position in the sheet array.

In some embodiments, the separator has a thickness ranging form about 10 μm to about 300 μm. In some embodiments, the separator has a thickness ranging from the group of thicknesses comprising:

In some embodiments, the apparatus may further comprise first and second support plates, the support plates flanking an assembly in order of the first electrode contact array, the first sheet array, the separator array, sheet array, and, the second electrode contact array.

In some embodiments, the apparatus may further comprise an automated battery cell tester in electrical communication with the plurality of the electrically conductive traces of the electrode contact array.

In some embodiments, the apparatus may further comprise a computerized database in communication with the automated battery cell tester, the computerized database being configured to obtain, store, and manipulate data acquired from the automated battery tester.

The invention provides, in another aspect, for a method for testing battery electrodes comprising the steps of providing an array of electrodes, each electrode in electrical and ionic isolation from other electrodes, providing an array of counter electrodes, each counter electrode in electrical and ionic isolation from other counter electrodes, providing an array of separators, each separator in electrical and ionic isolation from other separators of the array of separators; bonding the array of electrodes to the array of counter electrodes with the array of separators therebetween to form an array of battery cells, each in electrical and ion isolation from other battery cells of the array of battery cells; providing an automated battery cell tester in discrete electrical communication with each electrode and counter electrode of the array of battery cells; and, testing each battery cell, either sequentially or in parallel, and collecting data with a computerized database.

The invention provides, in another aspect, for a method for making a separator array comprising the steps of providing a separator sheet, the separator sheet having first and second surfaces, wherein the separator sheet is electrically non-conductive between the first and second surfaces, and wherein the separator sheet is ionically conductive between the first and second surfaces, providing a patterned die having an array pattern of raised shapes, the raised shapes having at least one wall, pressing the patterned die again the first surface of the separator sheet to imprint the raised shapes into the separator sheet, withdrawing the patterned die away from the first surface of the separator sheet, wherein an image of the array pattern of raised shapes is imprinted onto the separator sheet.

In some embodiments, the patterned die may be a hot melt pattern die and the image of the array pattern results by melting the image of the array pattern into the separator sheet thereby forming an array of independent separators, each independent separator being in electrical and ionic isolation from other independent separators.

In some embodiments, the method may further comprise providing a second patterned die having a array pattern of raised shapes mirroring the first patterned die array pattern of raised shapes, wherein when the first patterned die and the second patterned die are mated with the separator sheet therebetween, the pattern of raised shapes from the first and second patterned dies mates without cutting through the separator sheet.

In some embodiments, the method may provide for the first and second patterned dies being hot melt pattern dies and the image and the mirror image of the first and second patterned dies is imprinted into the separator sheet to form an array of independent separators, each separator in electrical and ionic isolation from other independent separators.

The invention provides, in another aspect, a method for forming a plurality of electrodes, the method comprising the steps of providing a sheet array having first and second sides and comprising a non-electrically conductive support having a plurality of apertures arrayed within the sheet array, each aperture traversing from the first side to the second side; and, a plurality of electrode supports positionally arrayed upon the first side of the sheet array, the electrodes each comprising an electrode support comprising an electrically conductive material, the electrode support having first and second sides; depositing a first electrode material upon the first side of a first of the plurality of the electrode supports; depositing a second electrode material upon the first side of a second of the plurality of the electrode supports; wherein the first electrode material is different from the second electrode material.

In some embodiments, the first of the plurality of the electrode supports may comprise a plurality of layers deposited thereupon, wherein at least two of the plurality of layers may differ from each other. In some embodiments, the first of the plurality of electrodes may comprise an electrode having at least one functional gradient therein, and the functional gradient may run in a direction perpendicular to the first surface of the electrode support, or the functional gradient may run in a direction not perpendicular to the first surface of the electrode support.

In some embodiments, the electrode matrix may have a pore volume fraction having a range selected from the group consisting of percentages ranging: from about 1% to about 10%; from about 1% to about 5%; from about 5% to about 10%; from about 10% to about 15%; from about 10% to about 20%; from about 15% to about 20%; from about 20% to about 25%; from about 20% to about 30%; from about 25% to about 30%; from about 30% to about 35%; from about 30% to about 40%; from about 35% to about 40%; from about 40% to about 45%; from about 40% to about 50%; from about 45% to about 50%; from about 50% to about 55%; from about 50% to about 60%; from about 55% to about 60%; from about 60% to about 65%; from about 60% to about 70%; from about 65% to about 70%; from about 70% to about 75%; from about 70% to about 80%; from about 75% to about 80%; from about 80% to about 85%; from about 80% to about 90%; from about 85% to about 90%; from about 90% to about 95%; from about 90% to about 100%; from about 95% to about 100%.

The invention provides, in another aspect, for a method for making a plurality of electrodes, the method comprising the steps of providing a plurality of electrode material suspensions, wherein at least two of the plurality of electrode material suspensions are different from each other in at least one functional attribute providing an array of electrode supports, depositing each of the plurality of electrode suspensions onto a corresponding electrode support of the array of electrode supports.

In some embodiments, the method may have the deposition step comprise automated deposition. In some embodiments, the method may comprise spray depositing, preferably where the spray depositing is conducted by a spray robot having x,y plane articulation ability. In some embodiments, the spray robot may automatically select individual electrode material suspensions from the plurality of electrode material suspensions. In some embodiments, the spray robot may automatically self-clean between depositing different electrode material suspensions. In some embodiments, a computer controller and database may be used to control the automated deposition and to track locations of electrode material suspensions deposited upon the electrode supports. In some embodiments, the spray robot may further include the capability of, or have, a mixing robot capable of mixing electrode material suspension in accordance with a pre-selected formulation table to form an array of different electrode material suspensions. In some embodiments, the depositing may be spray depositing that is conducted by a spray robot having x,y plane articulation ability. In some embodiments, the spray robot may automatically select individual electrode material suspensions from the plurality of electrode material suspensions. In some embodiments, the spray robot may automatically self-clean between depositing different electrode material suspensions. In some embodiments, the method may further provide a computer controller and database to control the automated deposition and to track locations and composition of electrode material suspensions deposited upon the electrode supports.

In another aspect, the invention provides for a spray robot for making a plurality of electrode, the method comprising the steps of: providing a plurality of electrode material suspensions, wherein at least two of the plurality of electrode material suspensions are different from each other in at least one functional attribute; providing an array of electrode supports; depositing each of the plurality of electrode suspensions onto a corresponding electrode support of the array of electrode supports. In some embodiments, the depositing comprises automated deposition, preferably, the depositing comprises spray depositing, even more preferably, the spray depositing is conducted by a spray robot having x,y plane articulation ability.

In some embodiments, the spray robot may automatically select individual electrode material suspensions from the plurality of electrode material suspensions, the spray robot may automatically self-clean between depositing different electrode material suspensions. In highly preferred embodiments, the spray robot comprises a computer controller and database to control the automated deposition and to track locations of electrode material suspensions deposited upon the electrode supports. In some embodiments, the spray robot is paired or has the function of being a mixing robot capable of mixing electrode material suspension in accordance with a pre-selected formulation table to form an array of different electrode material suspensions. In some embodiments, the depositing is spray depositing that is conducted by a spray robot having x,y plane articulation ability, wherein the spray robot may automatically select individual electrode material suspensions from the plurality of electrode material suspensions.

In another aspect, the invention provides for a battery electrode comprising: electrode composite having x, y, and z dimensions, the electrode composite comprising: active material particles; conductive particles, wherein the electrode composite further comprises: first regions having a first density; and, second regions having a second density, wherein the first and second regions are arranged in the x and y dimensions. In some embodiments, the battery electrode may further comprise: a second layer comprising: a top surface; a bottom surface; the second layer further comprising: active material particles; conductive material particles; the second layer further comprising: a first region having a first density; a second region having a second density, wherein first and second density of the second layer are different.

In another aspect, the invention provides for a method for forming an electrode comprising the steps of: forming the electrode using a coating method selected from the group consisting of: roll coating; forward roll coating; reverse roll coating; direct gravure coating; reverse gravure coating; knife over gravure coating; air knife coating; doctor blade coating; slot die coating; slurry coating; extrusion coating; multiple extrusion coating; spraying; electrokinetic deposition; electrophoretic deposition; electro-spray deposition; inkjet deposition; bubble jet deposition; powder coating; and, printing, wherein the electrode comprises therein a functional gradient formed by the coating method. In some embodiments, the electrode may comprise two or more layers therein, wherein at least one of the layers is functionally different than the other layer(s), each layer comprising active material particles and conductive material particles. In some embodiments, the electrode may comprise x,y, and x dimensions, and the electrode is divided spatially into a plurality of x,y regions in the x,y plane of the electrode. In some embodiments, the electrode may comprise two or more layers therein, wherein at least one of the layers is functionally different than the other layer(s), each layer comprising active material particles and conductive material particles, each of the x,y regions in the x,y plane comprising the two or more layers therein.

### BRIEF DESCRIPTION OF THE SEVERAL VIEWS OF THE DRAWING

FIG. 1 depicts an exemplary PRIOR ART battery cell in cross-sectional view.

FIG. 2 depicts an exemplary PRIOR ART electrode matrix in cross-sectional view.

FIG. 3 depicts an exemplary PRIOR ART battery cell in cross-sectional view where each electrode matrix is homogenous with respect to functionality, composition, structure, and, organization and interposed by a separator.

FIG. 4 depicts an exemplary electrode matrix provided for by the invention wherein such matrix is has a functional gradient formed therein.

FIG. 5 depicts an exemplary electrode matrix provided for by the invention wherein the matrix comprises alternating layers of large and small active material composite.

FIG. 6 depicts an exemplary battery cell the invention provides wherein the cathode and anode are electrode matrices each having a functional gradient therein.

FIG. 7 depicts an exemplary battery cell the invention provides wherein the cathode and anode are electrode matrices each having a functional gradient therein, the gradient running in a direction opposite of the cell depicted in FIG. 6.

FIG. 8 depicts an exemplary electrode matrix the invention provides wherein the active material particles/conductive particles layers have interposed therebetween layers having a relatively high concentration of conductive particles.

FIG. 9 depicts the subject matter of FIG. 8 in cut-away view to highlight each layer of the electrode matrix.

FIGS. 10A through 10D depict an exemplary electrode matrix forming device the invention provides wherein electrode matrices having at least one functional gradient therein are cast in-place along a moving roll-stock of electrode support.

FIG. 11 depicts an exemplary electrode matrix forming device wherein ten layers are deposited upon a moving roll-stock electrode support.

FIG. 12 depicts an exemplary gradient forming system operating under computer control.

FIGS. 13 through 25 graphically depict different scenarios of changes made in composition of an electrode matrix wherein the electrode matrix composition changes as a function of distance from the electrode support.

FIG. 26A depicts an electrode matrix having therein a plurality of polymer particles where, in FIG. 26B, voids are formed in place of the polymer particles by dissolving the polymer particles in-situ to form well defined pores within the electrode matrix.

FIG. 27A depicts a slot-die coater used to form battery electrodes.

FIG. 27B depicts a close-up view of the slot-die coater in FIG. 27A where deliberate bubble formation is used to control the porosity of the electrode matrix.

FIG. 28 depicts a resulting electrode made using the slot-die method and apparatus depicted in FIG. 27B.

FIG. 29A depicts an array spotter used to form electrode layers having at least one functional gradient in the x and y dimensions, wherein the drops are spaced apart upon the substrate during deposition.

FIG. 29B depicts an electrode matrix formed using the spotter of FIG. 29A, wherein an electrode matrix having functional gradients in the x and y dimensions, as well as in the z dimension with multiple layers of different active material compositions.

FIG. 30 depicts a side view of an electrode matrix perforator.

FIG. 31 depicts a perspective view of an electrode matrix perforator.

FIGS. 32A and 32B show a resulting perforated electrode matrix or layer in both plan and side views, respectively.

FIG. 33 depicts an electrode dimpler roller that differentially calendars the surface of the electrode or layer as dictated by the pattern of dimples upon the surface of the roller.

FIG. 34 depicts the electrode dimpler roller of FIG. 33 in use forming dimples in a portion of a moving roll stock current collector coated with electrode material.

FIG. 35 depicts a calendaring roller system found in the PRIOR ART.

FIG. 36 depicts a spray coat system embodiment of the invention where after each drying step post spraying, the layer is calendared, wherein the different calendaring steps may cause different levels of densification for each layer and the electrode matrix as a whole.

FIGS. 37A through 37D depict one embodiment of an embosser used to differentially calendar a layer or electrode matrix.

FIGS. 38A through 38G depict a system using a wire mesh as an embossing pattern to differentially calendar an electrode matrix or a layer.

FIGS. 39A and 39B depict another embodiment provided for by the invention to differentially calendar an electrode matrix or layer using a perforated die press to cause the active material composite to extrude into the perforations of the die press.

FIGS. 40A through 40G depict a micromolding process used to form compartments in the x,y dimensions of the layer or electrode matrix using a micromachined negative mold to form compartments for later filling with active material composite or other materials.

FIG. 41 depicts a perspective view of an exemplary electrode array former used for high-throughput screening of candidate electrode configurations.

FIG. 42 depicts two microtiter-type plates containing arrays of electrode coating suspensions for use with an array former such as the one depicted in FIG. 26.

FIG. 43A through FIG. 43E depict the steps used for making a sheet array of supported electrodes for use with an array former such as the one depicted in FIG. 42.

FIG. 44 depicts a conductive support block for use with the sheet array of supported electrodes of FIGS. 43A through 43E.

FIGS. 45A and 45B depict one embodiment of a separator array in exploded perspective and assembled perspective views, respectively.

FIGS. 46A and 46B depict a jig and process used for making an embodiment of a separator array.

FIG. 47 depicts a formed separator array.

FIGS. 48A and 48B depict a jig and process for making another embodiment of a separator array.

FIG. 49 depicts an embodiment of an assembled separator array.

FIG. 50 depicts, in exploded perspective view, an electrode array testing apparatus useful with the electrode arrays, separator array, and other components depicted in FIGS. 43 through FIGS. 49.

FIG. 51 depicts a cross-sectional view of an assembled electrode array testing apparatus.

### DETAILED DESCRIPTION OF THE INVENTION

An object of the invention is the formation of superior electrodes and battery cells using the apparatuses and methods of the invention to produce the devices arising therefrom.

The invention provides for methods and apparatuses that produce electrodes having improved performance attributed to optimization electrode composition, structure, organization, among different regions within an electrode in any one or combination of x, y, and z dimensions within the electrode. The invention further provides for high-throughput screening methods and apparatuses for rapidly screening electrodes having therein differences in electrode composition, structure, organization, as well as others parameters disclosed herein, among different regions within an electrode in any one or combination of x, y, and z dimensions within the electrode.

The prior art provides simple batteries using homogeneous electrodes. Most popular are electrodes formed by either a doctor blade or slot-die method of coating. The result is cells having electrodes that are uniform in function, composition, structure, and organization, that is, for the most part, the electrodes are homogenous monolithic structures comprising generally: 1) active material particles; 2) conductive particles; and, 3) binder formed together into a dry layer-less cake.

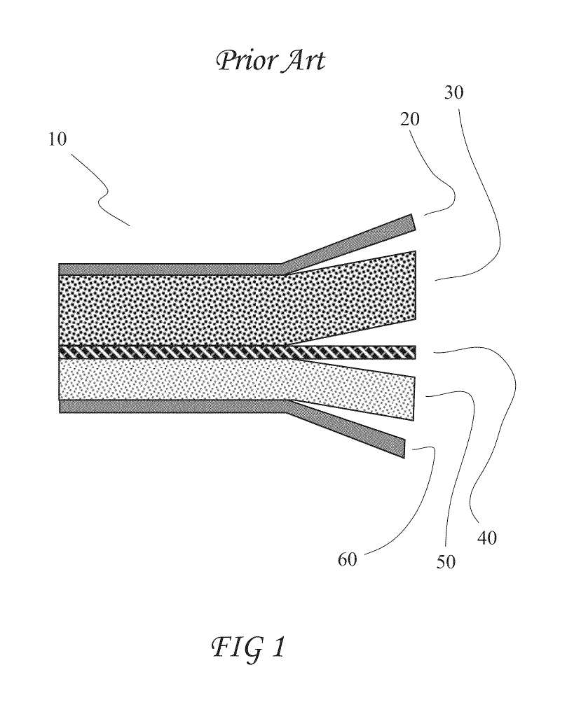

Shown in FIG. 1 is an exemplary PRIOR ART battery cell in cross-sectional view. Battery Cell 10 comprises Cathode Current Collector 20 having associated therewith Cathode 30 which comprises a material capable of reversibly storing ions, typically lithium ions. On the other side of Cell 10, Anode Current Collector 60 has associated therewith Anode 50 which comprises a material also capable of reversibly storing ions, typically lithium ions. Separating Anode 50 from Cathode 30 is Separator 40 which is permeable to the reversibly stored ions but electronically isolates Anode 50 from Cathode 30. Not shown is an electrolyte that allows migration of ions between Cathode 30 and Anode 50. To charge Cell 10, a voltage potential is applied to Cathode Current Collector 20 and Anode Current Collector 60 to cause ions to migrate between Cathode 30 and Anode 50. If lithium ions are used, charging typically causes Cathode 30 to delithiate or release ions and Anode 50 to lithiate or store ions. To discharge Cell 10, an electrical load is applied to Cathode Current Collector 20 and Anode Current Collector 60 and, in the case of lithium ions, Anode 50 delithiates and Cathode 30 lithiates. The ions traverse the ion permeable, electrically non-conductive separator during charge and discharge cycles. Not wishing to be bound by theory, it is believed that Cell 10, when charged, is in a higher potential energy state than when discharged or “drained.” The ion migration between Cathode 30 and Anode 50 is sometimes referred to as a shuttlecock system because the ions act like a shuttlecock in the game badminton.

In the case of the cell depicted in FIG. 1, the notable feature is that electrodes, Cathode 30 and Anode 50 are homogenous coatings meaning that throughout the electrode, the composition, structure, organization, and function are substantially the same or homogeneous.

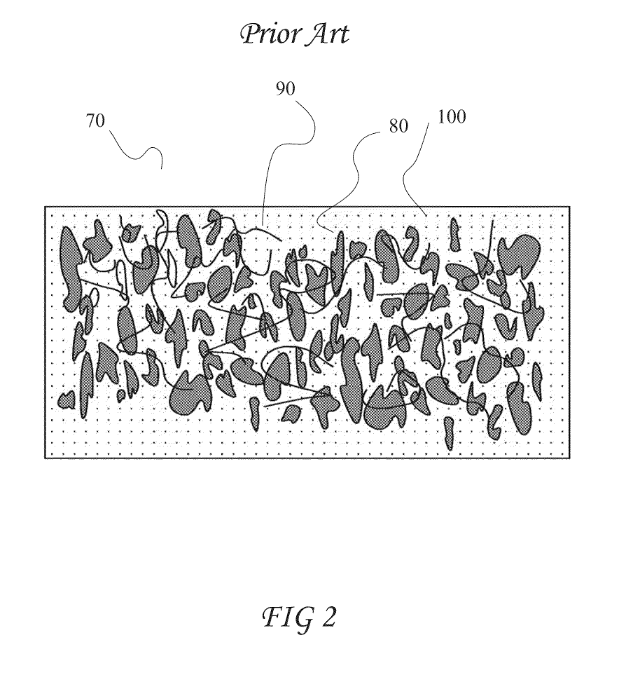

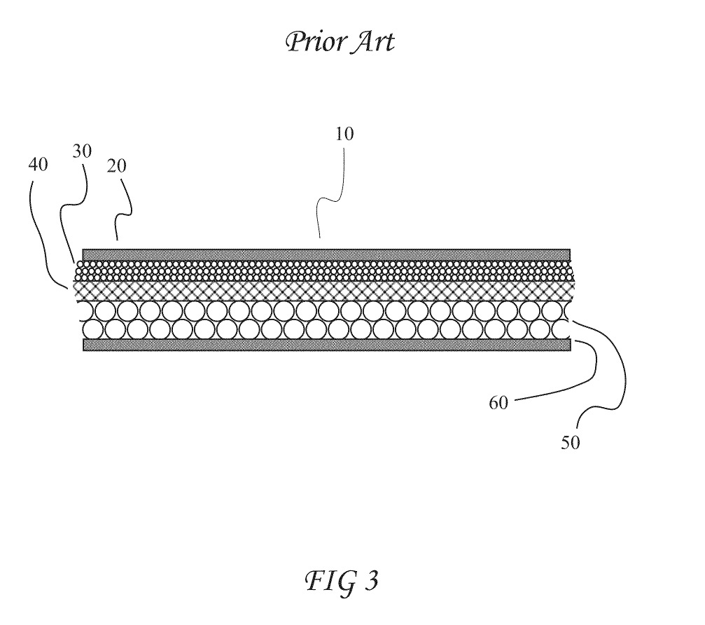

Looking closer at a typical electrode in the prior art, FIG. 2 depicts an exemplary PRIOR ART electrode matrix in cross-sectional view. Here, Electrode Matrix 70 comprises Active Material Particles 80 distributed randomly throughout the entirety of Electrode Matrix 70. Conductive Particles 90 and Binder Polymers 100 are likewise randomly distributed throughout the entirety of Electrode Matrix 70. Shown differently, FIG. 3 depicts an exemplary PRIOR ART battery cell in cross-sectional view where each electrode matrix is homogenous with respect to functionality, composition, structure, and, organization. Here, Cell 10 is shown assembled and the active material particles of Cathode 30 and Anode 50 are represented by circles to suggest dimensional differences. Not wishing to be bound by theory, it is believed that active material particle size plays a significant part in how a particular cell may perform. Likewise, it is believed that density, percentages of conductive particles and binder polymers play a significant role in determining the performance of a cell.

To overcome the limitation of the Prior Art, the invention provides, in one aspect, for an electrode comprising a plurality of layers, each layer comprising active material particles capable of reversibly storing ions; and, conductive particles, wherein the plurality of layers has at least one layer being functionally different from at least one other layer.

Functional differences between layers may be a difference in composition, structure, and, organization of the constituents of each layer.

In some embodiments, the active material particles may have a pore volume fraction ranging from about 20% to about 30% by volume, however, active material particles having a pore volume fraction range selected from one or a combination of the following ranges: from about 1% to about 10%; from about 1% to about 5%; from about 5% to about 10%; from about 10% to about 15%; from about 10% to about 20%; from about 15% to about 20%; from about 20% to about 25%; from about 20% to about 30%; from about 25% to about 30%; from about 30% to about 35%; from about 30% to about 40%; from about 35% to about 40%; from about 40% to about 45%; from about 40% to about 50%; from about 45% to about 50%; from about 50% to about 55%; from about 50% to about 60%; from about 55% to about 60%; from about 60% to about 65%; from about 60% to about 70%; from about 65% to about 70%; from about 70% to about 75%; from about 70% to about 80%; from about 75% to about 80%; from about 80% to about 85%; from about 80% to about 90%; from about 85% to about 90%; from about 90% to about 95%; from about 90% to about 100%; and, from about 95% to about 100% are contemplated by the invention.

Active material particles may comprise lithium, or the active material particles may comprise a non-lithium metal, or the active material particles may comprise both lithium and non-lithium metals. the electrode may further comprise a current collector having first and second sides; and, a first electrode comprising a plurality of layers, each layer comprising active material particles capable of reversibly storing ions; and, conductive particles, wherein the plurality of layers has at least one layer being functionally different from at least one other layer, wherein the first electrode is attached to, and/or in electrical communication with, the first side of the current collector.

The non-lithium metal may be one or a combination of: aluminum; chromium; cobalt; iron; nickel; magnesium; manganese; molybdenum; titanium; and, vanadium. Active material particles may comprise an oxide of a metal selected from the group consisting of: aluminum; chromium; cobalt; iron; nickel; magnesium; manganese; molybdenum; titanium; and, vanadium. Active material may further comprise iron phosphate or lithium iron phosphate. In some embodiments, the active material particles may comprise a conventional cathode active material used in lithium ion secondary batteries.

Active material particles may comprise a lithium-transition metal-phosphate compound, or the active material particles may comprise LiCoO₂, or where the active material particles may comprise LiNiO₂, or the active material particles may comprise LiMn₂O₄, or a combination thereof. Active material particles may comprise a lithium-transition metal-phosphate compound doped with a material selected from the group consisting of: metals, metalloids, and, halogens. Active material particles may comprise an olivine structure LiMPO₄ compound, where M is selected from the group of metals consisting of: vanadium, chromium, manganese, iron, cobalt, and nickel. Olivine structure LiMPO₄ compounds may have lithium sites with deficiencies, the deficiencies being compensated by the addition of a metal or metalloid and may be doped at the metal sites, and the oxygen sites deficiencies at the oxygen sites may be compensated for by the addition of a halogen.

Preferably, active material particles have a nitrogen adsorption Brunauer-Emmett-Teller (BET) method surface area that is greater than 10 m²/g, or a nitrogen adsorption BET method surface area that is greater than BET 20 m²/g, or where the active material particles have a nitrogen adsorption BET method surface area greater than 10 m²/g, or where the active material particles have a nitrogen adsorption BET method surface area greater than 15 m²/g, or where the active material particles have a nitrogen adsorption BET method surface area greater than 20 m²/g, or where the active material particles have a nitrogen adsorption BET method surface area greater than 30 m²/g.

Active material particles may have a pore volume fraction ranging from about 20% to about 30% by volume, however, active material particles having a pore volume fraction range selected from one or a combination of the following ranges: from about 1% to about 10%; from about 1% to about 5%; from about 5% to about 10%; from about 10% to about 15%; from about 10% to about 20%; from about 15% to about 20%; from about 20% to about 25%; from about 20% to about 30%; from about 25% to about 30%; from about 30% to about 35%; from about 30% to about 40%; from about 35% to about 40%; from about 40% to about 45%; from about 40% to about 50%; from about 45% to about 50%; from about 50% to about 55%; from about 50% to about 60%; from about 55% to about 60%; from about 60% to about 65%; from about 60% to about 70%; from about 65% to about 70%; from about 70% to about 75%; from about 70% to about 80%; from about 75% to about 80%; from about 80% to about 85%; from about 80% to about 90%; from about 85% to about 90%; from about 90% to about 95%; from about 90% to about 100%; and, from about 95% to about 100% are contemplated by the invention.

Active material particles may have a cross-sectional dimension ranging from about 20 nm to about 20 μm. Contemplated by the invention are active material particles having a cross-sectional dimension ranging from the following ranges from about 1 nm to about 10 nm; from about 10 nm to about 20 nm; from about 20 nm to about 30 nm; from about 30 nm to about 40 nm; from about 40 nm to about 50 nm; from about 50 nm to about 60 nm; from about 60 nm to about 70 nm; from about 70 nm to about 80 nm; from about 80 nm to about 90 nm; from about 90 nm to about 100 nm; from about 100 nm to about 110 nm; from about 110 nm to about 120 nm; from about 120 nm to about 130 nm; from about 130 nm to about 140 nm; from about 140 nm to about 150 nm; from about 150 nm to about 160 nm; from about 160 nm to about 170 nm; from about 170 nm to about 180 nm; from about 180 nm to about 190 nm; from about 190 nm to about 200 nm; from about 5 nm to about 10 nm; from about 10 nm to about 15 nm; from about 15 nm to about 20 nm; from about 20 nm to about 25 nm; from about 25 nm to about 30 nm; from about 30 nm to about 35 nm; from about 35 nm to about 40 nm; from about 40 nm to about 45 nm; from about 45 nm to about 50 nm; from about 50 nm to about 55 nm; from about 55 nm to about 60 nm; from about 60 nm to about 65 nm; from about 65 nm to about 70 nm; from about 70 nm to about 75 nm; from about 75 nm to about 80 nm; from about 80 nm to about 85 nm; from about 85 nm to about 90 nm; from about 90 nm to about 95 nm; from about 95 nm to about 100 nm; from about 100 nm to about 105 nm; from about 105 nm to about 110 nm; from about 110 nm to about 115 nm; from about 115 nm to about 120 nm; from about 120 nm to about 125 nm; from about 125 nm to about 130 nm; from about 130 nm to about 135 nm; from about 135 nm to about 140 nm; from about 140 nm to about 145 nm; from about 145 nm to about 150 nm; from about 150 nm to about 155 nm; from about 155 nm to about 160 nm; from about 160 nm to about 165 nm; from about 165 nm to about 170 nm; from about 170 nm to about 175 nm; from about 175 nm to about 180 nm; from about 185 nm to about 190 nm; from about 190 nm to about 195 nm; from about 195 nm to about 200 nm; from about 0 nm to about 50 nm; from about 10 nm to about 60 nm; from about 20 nm to about 70 nm; from about 30 nm to about 80 nm; from about 40 nm to about 90 nm; from about 50 nm to about 100 nm; from about 60 nm to about 110 nm; from about 70 nm to about 120 nm; from about 80 nm to about 130 nm; from about 90 nm to about 140 nm; from about 100 nm to about 150 nm; from about 110 nm to about 160 nm; from about 120 nm to about 170 nm; from about 130 nm to about 180 nm; from about 140 nm to about 190 nm; from about 150 nm to about 200 nm; from about 160 nm to about 210 nm; from about 170 nm to about 220 nm; from about 180 nm to about 230 nm; from about 190 nm to about 240 nm; from about 240 nm to about 1.0 μm; from 1.0 μm to about 10 μm; from about 10 μm to about 100 μm; and, from about 100 μm to about 250 μm.

Contemplated by the invention are active material particles comprising an olivine lithium metal phosphate material having the formula LixM′yM″zPO4, wherein M′ comprises a metal selected from the group consisting of: manganese and iron, wherein M′ comprises a metal selected from the group consisting of: manganese; cobalt; and, nickel, wherein M′ is not the same as M″, and, wherein x is greater than or equal to 0, and x is less than or equal to 1.2; y is greater than or equal to 0.7, and y is less than or equal to 0.95; z is greater than or equal to 0.02, and z is greater than or equal to 0.3; and, the sum of y and z is greater than or equal to 0.8, and the sum of y and z is less than or equal to 1.2. Preferably, z may be greater than or equal to 0.02, and z may be less than or equal to 0.1, or the sum of y and z may equal 1. In some embodiments, M′ may be iron, and z may be greater than or equal to 0.02, and z may be less than or equal to 0.1, or the sum of y and z may equal 1. The sum of y and z may be greater than or equal to 0.8, and the sum of y and z may be less than or equal to 1.

Active material particles may comprise a lithium transition metal phosphate material having an overall composition of Li_{1-X} MPO₄, wherein M comprises at least one first row transition metal selected from the group consisting of titanium, vanadium, chromium, manganese, iron, cobalt and nickel, and wherein in use x ranges from 0 to 1. M may be iron and the active material particles may form a stable solid solution at room temperature when x ranges from about 0.1 to about 0.3. M may be iron and the active material particles may form a stable solid solution at room temperature when x has a range selected from one or a combination of the following ranges: from: about 0 to about 0.15; from about 0.00 to about 0.01; from about 0.00 to about 0.02; from about 0.00 to about 0.03; from about 0.00 to about 0.04; from about 0.00 to about 0.05; from about 0.00 to about 0.06; from about 0.00 to about 0.07; from about 0.00 to about 0.08; from about 0.00 to about 0.09; from about 0.00 to about 0.10; from about 0.00 to about 0.11; from about 0.00 to about 0.12; from about 0.00 to about 0.13; from about 0.00 to about 0.14; from about 0.00 to about 0.15; from about 0.00 to about 0.16; from about 0.00 to about 0.17; from about 0.00 to about 0.18; from about 0.00 to about 0.19; from about 0.00 to about 0.20; from about 0.00 to about 0.21; from about 0.00 to about 0.22; from about 0.00 to about 0.23; from about 0.00 to about 0.24; from about 0.00 to about 0.25; from about 0.00 to about 0.26; from about 0.00 to about 0.27; from about 0.00 to about 0.28; from about 0.00 to about 0.29; from about 0.00 to about 0.30; from about 0.00 to about 0.31; from about 0.00 to about 0.32; from about 0.00 to about 0.33; from about 0.00 to about 0.34; from about 0.00 to about 0.35; from about 0.00 to about 0.36; from about 0.00 to about 0.37; from about 0.00 to about 0.38; from about 0.00 to about 0.39; from about 0.00 to about 0.40; from about 0.00 to about 0.41; from about 0.00 to about 0.42; from about 0.00 to about 0.43; from about 0.00 to about 0.44; from about 0.00 to about 0.45; from about 0.00 to about 0.46; from about 0.00 to about 0.47; from about 0.00 to about 0.48; from about 0.00 to about 0.49; from about 0.00 to about 0.50; from about 0.00 to about 0.51; from about 0.00 to about 0.52; from about 0.00 to about 0.53; from about 0.00 to about 0.54; from about 0.00 to about 0.55; from about 0.00 to about 0.56; from about 0.00 to about 0.57; from about 0.00 to about 0.58; from about 0.00 to about 0.59; from about 0.00 to about 0.60; from about 0.00 to about 0.61; from about 0.00 to about 0.62; from about 0.00 to about 0.63; from about 0.00 to about 0.64; from about 0.00 to about 0.65; from about 0.00 to about 0.66; from about 0.00 to about 0.67; from about 0.00 to about 0.68; from about 0.00 to about 0.69; from about 0.00 to about 0.70; from about 0.00 to about 0.71; from about 0.00 to about 0.72; from about 0.00 to about 0.73; from about 0.00 to about 0.74; from about 0.00 to about 0.75; from about 0.00 to about 0.76; from about 0.00 to about 0.77; from about 0.00 to about 0.78; from about 0.00 to about 0.79; from about 0.00 to about 0.80; from about 0.00 to about 0.81; from about 0.00 to about 0.82; from about 0.00 to about 0.83; from about 0.00 to about 0.84; from about 0.00 to about 0.85; from about 0.00 to about 0.86; from about 0.00 to about 0.87; from about 0.00 to about 0.88; from about 0.00 to about 0.89; from about 0.00 to about 0.90; from about 0.00 to about 0.91; from about 0.00 to about 0.92; from about 0.00 to about 0.93; from about 0.00 to about 0.94; from about 0.00 to about 0.95; from about 0.00 to about 0.96; from about 0.00 to about 0.97; from about 0.00 to about 0.98; from about 0.00 to about 0.99; from about 0.00 to about 0.10; from about 0.10 to about 0.11; from about 0.10 to about 0.12; from about 0.10 to about 0.13; from about 0.10 to about 0.14; from about 0.10 to about 0.15; from about 0.10 to about 0.16; from about 0.10 to about 0.17; from about 0.10 to about 0.18; from about 0.10 to about 0.19; from about 0.10 to about 0.20; from about 0.10 to about 0.21; from about 0.10 to about 0.22; from about 0.10 to about 0.23; from about 0.10 to about 0.24; from about 0.10 to about 0.25; from about 0.10 to about 0.26; from about 0.10 to about 0.27; from about 0.10 to about 0.28; from about 0.10 to about 0.29; from about 0.10 to about 0.30; from about 0.10 to about 0.31; from about 0.10 to about 0.32; from about 0.10 to about 0.33; from about 0.10 to about 0.34; from about 0.10 to about 0.35; from about 0.10 to about 0.36; from about 0.10 to about 0.37; from about 0.10 to about 0.38; from about 0.10 to about 0.39; from about 0.10 to about 0.40; from about 0.10 to about 0.41; from about 0.10 to about 0.42; from about 0.10 to about 0.43; from about 0.10 to about 0.44; from about 0.10 to about 0.45; from about 0.10 to about 0.46; from about 0.10 to about 0.47; from about 0.10 to about 0.48; from about 0.10 to about 0.49; from about 0.10 to about 0.50; from about 0.10 to about 0.51; from about 0.10 to about 0.52; from about 0.10 to about 0.53; from about 0.10 to about 0.54; from about 0.10 to about 0.55; from about 0.10 to about 0.56; from about 0.10 to about 0.57; from about 0.10 to about 0.58; from about 0.10 to about 0.59; from about 0.10 to about 0.60; from about 0.10 to about 0.61; from about 0.10 to about 0.62; from about 0.10 to about 0.63; from about 0.10 to about 0.64; from about 0.10 to about 0.65; from about 0.10 to about 0.66; from about 0.10 to about 0.67; from about 0.10 to about 0.68; from about 0.10 to about 0.69; from about 0.10 to about 0.70; from about 0.10 to about 0.71; from about 0.10 to about 0.72; from about 0.10 to about 0.73; from about 0.10 to about 0.74; from about 0.10 to about 0.75; from about 0.10 to about 0.76; from about 0.10 to about 0.77; from about 0.10 to about 0.78; from about 0.10 to about 0.79; from about 0.10 to about 0.80; from about 0.10 to about 0.81; from about 0.10 to about 0.82; from about 0.10 to about 0.83; from about 0.10 to about 0.84; from about 0.10 to about 0.85; from about 0.10 to about 0.86; from about 0.10 to about 0.87; from about 0.10 to about 0.88; from about 0.10 to about 0.89; from about 0.10 to about 0.90; from about 0.10 to about 0.91; from about 0.10 to about 0.92; from about 0.10 to about 0.93; from about 0.10 to about 0.94; from about 0.10 to about 0.95; from about 0.10 to about 0.96; from about 0.10 to about 0.97; from about 0.10 to about 0.98; from about 0.10 to about 0.99; from about 0.10 to about 1.00; from about 0.20 to about 0.21; from about 0.20 to about 0.22; from about 0.20 to about 0.23; from about 0.20 to about 0.24; from about 0.20 to about 0.25; from about 0.20 to about 0.26; from about 0.20 to about 0.27; from about 0.20 to about 0.28; from about 0.20 to about 0.29; from about 0.20 to about 0.30; from about 0.20 to about 0.31; from about 0.20 to about 0.32; from about 0.20 to about 0.33; from about 0.20 to about 0.34; from about 0.20 to about 0.35; from about 0.20 to about 0.36; from about 0.20 to about 0.37; from about 0.20 to about 0.38; from about 0.20 to about 0.39; from about 0.20 to about 0.40; from about 0.20 to about 0.41; from about 0.20 to about 0.42; from about 0.20 to about 0.43; from about 0.20 to about 0.44; from about 0.20 to about 0.45; from about 0.20 to about 0.46; from about 0.20 to about 0.47; from about 0.20 to about 0.48; from about 0.20 to about 0.49; from about 0.20 to about 0.50; from about 0.20 to about 0.51; from about 0.20 to about 0.52; from about 0.20 to about 0.53; from about 0.20 to about 0.54; from about 0.20 to about 0.55; from about 0.20 to about 0.56; from about 0.20 to about 0.57; from about 0.20 to about 0.58; from about 0.20 to about 0.59; from about 0.20 to about 0.60; from about 0.20 to about 0.61; from about 0.20 to about 0.62; from about 0.20 to about 0.63; from about 0.20 to about 0.64; from about 0.20 to about 0.65; from about 0.20 to about 0.66; from about 0.20 to about 0.67; from about 0.20 to about 0.68; from about 0.20 to about 0.69; from about 0.20 to about 0.70; from about 0.20 to about 0.71; from about 0.20 to about 0.72; from about 0.20 to about 0.73; from about 0.20 to about 0.74; from about 0.20 to about 0.75; from about 0.20 to about 0.76; from about 0.20 to about 0.77; from about 0.20 to about 0.78; from about 0.20 to about 0.79; from about 0.20 to about 0.80; from about 0.20 to about 0.81; from about 0.20 to about 0.82; from about 0.20 to about 0.83; from about 0.20 to about 0.84; from about 0.20 to about 0.85; from about 0.20 to about 0.86; from about 0.20 to about 0.87; from about 0.20 to about 0.88; from about 0.20 to about 0.89; from about 0.20 to about 0.90; from about 0.20 to about 0.91; from about 0.20 to about 0.92; from about 0.20 to about 0.93; from about 0.20 to about 0.94; from about 0.20 to about 0.95; from about 0.20 to about 0.96; from about 0.20 to about 0.97; from about 0.20 to about 0.98; from about 0.20 to about 0.99; from about 0.20 to about 1.00; from about 0.30 to about 0.31; from about 0.30 to about 0.32; from about 0.30 to about 0.33; from about 0.30 to about 0.34; from about 0.30 to about 0.35; from about 0.30 to about 0.36; from about 0.30 to about 0.37; from about 0.30 to about 0.38; from about 0.30 to about 0.39; from about 0.30 to about 0.40; from about 0.30 to about 0.41; from about 0.30 to about 0.42; from about 0.30 to about 0.43; from about 0.30 to about 0.44; from about 0.30 to about 0.45; from about 0.30 to about 0.46; from about 0.30 to about 0.47; from about 0.30 to about 0.48; from about 0.30 to about 0.49; from about 0.30 to about 0.50; from about 0.30 to about 0.51; from about 0.30 to about 0.52; from about 0.30 to about 0.53; from about 0.30 to about 0.54; from about 0.30 to about 0.55; from about 0.30 to about 0.56; from about 0.30 to about 0.57; from about 0.30 to about 0.58; from about 0.30 to about 0.59; from about 0.30 to about 0.60; from about 0.30 to about 0.61; from about 0.30 to about 0.62; from about 0.30 to about 0.63; from about 0.30 to about 0.64; from about 0.30 to about 0.65; from about 0.30 to about 0.66; from about 0.30 to about 0.67; from about 0.30 to about 0.68; from about 0.30 to about 0.69; from about 0.30 to about 0.70; from about 0.30 to about 0.71; from about 0.30 to about 0.72; from about 0.30 to about 0.73; from about 0.30 to about 0.74; from about 0.30 to about 0.75; from about 0.30 to about 0.76; from about 0.30 to about 0.77; from about 0.30 to about 0.78; from about 0.30 to about 0.79; from about 0.30 to about 0.80; from about 0.30 to about 0.81; from about 0.30 to about 0.82; from about 0.30 to about 0.83; from about 0.30 to about 0.84; from about 0.30 to about 0.85; from about 0.30 to about 0.86; from about 0.30 to about 0.87; from about 0.30 to about 0.88; from about 0.30 to about 0.89; from about 0.30 to about 0.90; from about 0.30 to about 0.91; from about 0.30 to about 0.92; from about 0.30 to about 0.93; from about 0.30 to about 0.94; from about 0.30 to about 0.95; from about 0.30 to about 0.96; from about 0.30 to about 0.97; from about 0.30 to about 0.98; from about 0.30 to about 0.99; from about 0.30 to about 1.00; from about 0.40 to about 0.40; from about 0.40 to about 0.41; from about 0.40 to about 0.42; from about 0.40 to about 0.43; from about 0.40 to about 0.44; from about 0.40 to about 0.45; from about 0.40 to about 0.46; from about 0.40 to about 0.47; from about 0.40 to about 0.48; from about 0.40 to about 0.49; from about 0.40 to about 0.50; from about 0.40 to about 0.51; from about 0.40 to about 0.52; from about 0.40 to about 0.53; from about 0.40 to about 0.54; from about 0.40 to about 0.55; from about 0.40 to about 0.56; from about 0.40 to about 0.57; from about 0.40 to about 0.58; from about 0.40 to about 0.59; from about 0.40 to about 0.60; from about 0.40 to about 0.61; from about 0.40 to about 0.62; from about 0.40 to about 0.63; from about 0.40 to about 0.64; from about 0.40 to about 0.65; from about 0.40 to about 0.66; from about 0.40 to about 0.67; from about 0.40 to about 0.68; from about 0.40 to about 0.69; from about 0.40 to about 0.70; from about 0.40 to about 0.71; from about 0.40 to about 0.72; from about 0.40 to about 0.73; from about 0.40 to about 0.74; from about 0.40 to about 0.75; from about 0.40 to about 0.76; from about 0.40 to about 0.77; from about 0.40 to about 0.78; from about 0.40 to about 0.79; from about 0.40 to about 0.80; from about 0.40 to about 0.81; from about 0.40 to about 0.82; from about 0.40 to about 0.83; from about 0.40 to about 0.84; from about 0.40 to about 0.85; from about 0.40 to about 0.86; from about 0.40 to about 0.87; from about 0.40 to about 0.88; from about 0.40 to about 0.89; from about 0.40 to about 0.90; from about 0.40 to about 0.91; from about 0.40 to about 0.92; from about 0.40 to about 0.93; from about 0.40 to about 0.94; from about 0.40 to about 0.95; from about 0.40 to about 0.96; from about 0.40 to about 0.97; from about 0.40 to about 0.98; from about 0.40 to about 0.99; from about 0.40 to about 1.00; from about 0.50 to about 0.51; from about 0.50 to about 0.52; from about 0.50 to about 0.53; from about 0.50 to about 0.54; from about 0.50 to about 0.55; from about 0.50 to about 0.56; from about 0.50 to about 0.57; from about 0.50 to about 0.58; from about 0.50 to about 0.59; from about 0.50 to about 0.60; from about 0.50 to about 0.61; from about 0.50 to about 0.62; from about 0.50 to about 0.63; from about 0.50 to about 0.64; from about 0.50 to about 0.65; from about 0.50 to about 0.66; from about 0.50 to about 0.67; from about 0.50 to about 0.68; from about 0.50 to about 0.69; from about 0.50 to about 0.70; from about 0.50 to about 0.71; from about 0.50 to about 0.72; from about 0.50 to about 0.73; from about 0.50 to about 0.74; from about 0.50 to about 0.75; from about 0.50 to about 0.76; from about 0.50 to about 0.77; from about 0.50 to about 0.78; from about 0.50 to about 0.79; from about 0.50 to about 0.80; from about 0.50 to about 0.81; from about 0.50 to about 0.82; from about 0.50 to about 0.83; from about 0.50 to about 0.84; from about 0.50 to about 0.85; from about 0.50 to about 0.86; from about 0.50 to about 0.87; from about 0.50 to about 0.88; from about 0.50 to about 0.89; from about 0.50 to about 0.90; from about 0.50 to about 0.91; from about 0.50 to about 0.92; from about 0.50 to about 0.93; from about 0.50 to about 0.94; from about 0.50 to about 0.95; from about 0.50 to about 0.96; from about 0.50 to about 0.97; from about 0.50 to about 0.98; from about 0.50 to about 0.99; from about 0.50 to about 1.00; from about 0.60 to about 0.61; from about 0.60 to about 0.62; from about 0.60 to about 0.63; from about 0.60 to about 0.64; from about 0.60 to about 0.65; from about 0.60 to about 0.66; from about 0.60 to about 0.67; from about 0.60 to about 0.68; from about 0.60 to about 0.69; from about 0.60 to about 0.70; from about 0.60 to about 0.71; from about 0.60 to about 0.72; from about 0.60 to about 0.73; from about 0.60 to about 0.74; from about 0.60 to about 0.75; from about 0.60 to about 0.76; from about 0.60 to about 0.77; from about 0.60 to about 0.78; from about 0.60 to about 0.79; from about 0.60 to about 0.80; from about 0.60 to about 0.81; from about 0.60 to about 0.82; from about 0.60 to about 0.83; from about 0.60 to about 0.84; from about 0.60 to about 0.85; from about 0.60 to about 0.86; from about 0.60 to about 0.87; from about 0.60 to about 0.88; from about 0.60 to about 0.89; from about 0.60 to about 0.90; from about 0.60 to about 0.91; from about 0.60 to about 0.92; from about 0.60 to about 0.93; from about 0.60 to about 0.94; from about 0.60 to about 0.95; from about 0.60 to about 0.96; from about 0.60 to about 0.97; from about 0.60 to about 0.98; from about 0.60 to about 0.99; from about 0.60 to about 1.00; from about 0.70 to about 0.71; from about 0.70 to about 0.72; from about 0.70 to about 0.73; from about 0.70 to about 0.74; from about 0.70 to about 0.75; from about 0.70 to about 0.76; from about 0.70 to about 0.77; from about 0.70 to about 0.78; from about 0.70 to about 0.79; from about 0.70 to about 0.80; from about 0.70 to about 0.81; from about 0.70 to about 0.82; from about 0.70 to about 0.83; from about 0.70 to about 0.84; from about 0.70 to about 0.85; from about 0.70 to about 0.86; from about 0.70 to about 0.87; from about 0.70 to about 0.88; from about 0.70 to about 0.89; from about 0.70 to about 0.90; from about 0.70 to about 0.91; from about 0.70 to about 0.92; from about 0.70 to about 0.93; from about 0.70 to about 0.94; from about 0.70 to about 0.95; from about 0.70 to about 0.96; from about 0.70 to about 0.97; from about 0.70 to about 0.98; from about 0.70 to about 0.99; from about 0.70 to about 1.00; from about 0.80 to about 0.80; from about 0.80 to about 0.81; from about 0.80 to about 0.82; from about 0.80 to about 0.83; from about 0.80 to about 0.84; from about 0.80 to about 0.85; from about 0.80 to about 0.86; from about 0.80 to about 0.87; from about 0.80 to about 0.88; from about 0.80 to about 0.89; from about 0.80 to about 0.90; from about 0.80 to about 0.91; from about 0.80 to about 0.92; from about 0.80 to about 0.93; from about 0.80 to about 0.94; from about 0.80 to about 0.95; from about 0.80 to about 0.96; from about 0.80 to about 0.97; from about 0.80 to about 0.98; from about 0.80 to about 0.99; from about 0.80 to about 1.00; from about 0.90 to about 0.91; from about 0.90 to about 0.92; from about 0.90 to about 0.93; from about 0.90 to about 0.94; from about 0.90 to about 0.95; from about 0.90 to about 0.96; from about 0.90 to about 0.97; from about 0.90 to about 0.98; from about 0.90 to about 0.99; and, from about 0.90 to about 1.00.

M may be iron where the active material particles form a stable solid solution when x ranges from about 0 to at least about 0.07 at room temperature. M also may be iron and the active material particles may form a stable solid solution at room temperature when x has ranges from one or a combination of the following ranges: from about 0 to about 0.05; from about 0.00 to about 0.01; from about 0.00 to about 0.02; from about 0.00 to about 0.03; from about 0.00 to about 0.04; from about 0.00 to about 0.05; from about 0.00 to about 0.06; from about 0.00 to about 0.07; from about 0.00 to about 0.08; from about 0.00 to about 0.09; from about 0.00 to about 0.10; from about 0.00 to about 0.11; from about 0.00 to about 0.12; from about 0.00 to about 0.13; from about 0.00 to about 0.14; from about 0.00 to about 0.15; from about 0.00 to about 0.16; from about 0.00 to about 0.17; from about 0.00 to about 0.18; from about 0.00 to about 0.19; from about 0.00 to about 0.20; from about 0.00 to about 0.21; from about 0.00 to about 0.22; from about 0.00 to about 0.23; from about 0.00 to about 0.24; from about 0.00 to about 0.25; from about 0.00 to about 0.26; from about 0.00 to about 0.27; from about 0.00 to about 0.28; from about 0.00 to about 0.29; from about 0.00 to about 0.30; from about 0.00 to about 0.31; from about 0.00 to about 0.32; from about 0.00 to about 0.33; from about 0.00 to about 0.34; from about 0.00 to about 0.35; from about 0.00 to about 0.36; from about 0.00 to about 0.37; from about 0.00 to about 0.38; from about 0.00 to about 0.39; from about 0.00 to about 0.40; from about 0.00 to about 0.41; from about 0.00 to about 0.42; from about 0.00 to about 0.43; from about 0.00 to about 0.44; from about 0.00 to about 0.45; from about 0.00 to about 0.46; from about 0.00 to about 0.47; from about 0.00 to about 0.48; from about 0.00 to about 0.49; from about 0.00 to about 0.50; from about 0.00 to about 0.51; from about 0.00 to about 0.52; from about 0.00 to about 0.53; from about 0.00 to about 0.54; from about 0.00 to about 0.55; from about 0.00 to about 0.56; from about 0.00 to about 0.57; from about 0.00 to about 0.58; from about 0.00 to about 0.59; from about 0.00 to about 0.60; from about 0.00 to about 0.61; from about 0.00 to about 0.62; from about 0.00 to about 0.63; from about 0.00 to about 0.64; from about 0.00 to about 0.65; from about 0.00 to about 0.66; from about 0.00 to about 0.67; from about 0.00 to about 0.68; from about 0.00 to about 0.69; from about 0.00 to about 0.70; from about 0.00 to about 0.71; from about 0.00 to about 0.72; from about 0.00 to about 0.73; from about 0.00 to about 0.74; from about 0.00 to about 0.75; from about 0.00 to about 0.76; from about 0.00 to about 0.77; from about 0.00 to about 0.78; from about 0.00 to about 0.79; from about 0.00 to about 0.80; from about 0.00 to about 0.81; from about 0.00 to about 0.82; from about 0.00 to about 0.83; from about 0.00 to about 0.84; from about 0.00 to about 0.85; from about 0.00 to about 0.86; from about 0.00 to about 0.87; from about 0.00 to about 0.88; from about 0.00 to about 0.89; from about 0.00 to about 0.90; from about 0.00 to about 0.91; from about 0.00 to about 0.92; from about 0.00 to about 0.93; from about 0.00 to about 0.94; from about 0.00 to about 0.95; from about 0.00 to about 0.96; from about 0.00 to about 0.97; from about 0.00 to about 0.98; from about 0.00 to about 0.99; from about 0.00 to about 0.10; from about 0.10 to about 0.11; from about 0.10 to about 0.12; from about 0.10 to about 0.13; from about 0.10 to about 0.14; from about 0.10 to about 0.15; from about 0.10 to about 0.16; from about 0.10 to about 0.17; from about 0.10 to about 0.18; from about 0.10 to about 0.19; from about 0.10 to about 0.20; from about 0.10 to about 0.21; from about 0.10 to about 0.22; from about 0.10 to about 0.23; from about 0.10 to about 0.24; from about 0.10 to about 0.25; from about 0.10 to about 0.26; from about 0.10 to about 0.27; from about 0.10 to about 0.28; from about 0.10 to about 0.29; from about 0.10 to about 0.30; from about 0.10 to about 0.31; from about 0.10 to about 0.32; from about 0.10 to about 0.33; from about 0.10 to about 0.34; from about 0.10 to about 0.35; from about 0.10 to about 0.36; from about 0.10 to about 0.37; from about 0.10 to about 0.38; from about 0.10 to about 0.39; from about 0.10 to about 0.40; from about 0.10 to about 0.41; from about 0.10 to about 0.42; from about 0.10 to about 0.43; from about 0.10 to about 0.44; from about 0.10 to about 0.45; from about 0.10 to about 0.46; from about 0.10 to about 0.47; from about 0.10 to about 0.48; from about 0.10 to about 0.49; from about 0.10 to about 0.50; from about 0.10 to about 0.51; from about 0.10 to about 0.52; from about 0.10 to about 0.53; from about 0.10 to about 0.54; from about 0.10 to about 0.55; from about 0.10 to about 0.56; from about 0.10 to about 0.57; from about 0.10 to about 0.58; from about 0.10 to about 0.59; from about 0.10 to about 0.60; from about 0.10 to about 0.61; from about 0.10 to about 0.62; from about 0.10 to about 0.63; from about 0.10 to about 0.64; from about 0.10 to about 0.65; from about 0.10 to about 0.66; from about 0.10 to about 0.67; from about 0.10 to about 0.68; from about 0.10 to about 0.69; from about 0.10 to about 0.70; from about 0.10 to about 0.71; from about 0.10 to about 0.72; from about 0.10 to about 0.73; from about 0.10 to about 0.74; from about 0.10 to about 0.75; from about 0.10 to about 0.76; from about 0.10 to about 0.77; from about 0.10 to about 0.78; from about 0.10 to about 0.79; from about 0.10 to about 0.80; from about 0.10 to about 0.81; from about 0.10 to about 0.82; from about 0.10 to about 0.83; from about 0.10 to about 0.84; from about 0.10 to about 0.85; from about 0.10 to about 0.86; from about 0.10 to about 0.87; from about 0.10 to about 0.88; from about 0.10 to about 0.89; from about 0.10 to about 0.90; from about 0.10 to about 0.91; from about 0.10 to about 0.92; from about 0.10 to about 0.93; from about 0.10 to about 0.94; from about 0.10 to about 0.95; from about 0.10 to about 0.96; from about 0.10 to about 0.97; from about 0.10 to about 0.98; from about 0.10 to about 0.99; from about 0.10 to about 1.00; from about 0.20 to about 0.21; from about 0.20 to about 0.22; from about 0.20 to about 0.23; from about 0.20 to about 0.24; from about 0.20 to about 0.25; from about 0.20 to about 0.26; from about 0.20 to about 0.27; from about 0.20 to about 0.28; from about 0.20 to about 0.29; from about 0.20 to about 0.30; from about 0.20 to about 0.31; from about 0.20 to about 0.32; from about 0.20 to about 0.33; from about 0.20 to about 0.34; from about 0.20 to about 0.35; from about 0.20 to about 0.36; from about 0.20 to about 0.37; from about 0.20 to about 0.38; from about 0.20 to about 0.39; from about 0.20 to about 0.40; from about 0.20 to about 0.41; from about 0.20 to about 0.42; from about 0.20 to about 0.43; from about 0.20 to about 0.44; from about 0.20 to about 0.45; from about 0.20 to about 0.46; from about 0.20 to about 0.47; from about 0.20 to about 0.48; from about 0.20 to about 0.49; from about 0.20 to about 0.50; from about 0.20 to about 0.51; from about 0.20 to about 0.52; from about 0.20 to about 0.53; from about 0.20 to about 0.54; from about 0.20 to about 0.55; from about 0.20 to about 0.56; from about 0.20 to about 0.57; from about 0.20 to about 0.58; from about 0.20 to about 0.59; from about 0.20 to about 0.60; from about 0.20 to about 0.61; from about 0.20 to about 0.62; from about 0.20 to about 0.63; from about 0.20 to about 0.64; from about 0.20 to about 0.65; from about 0.20 to about 0.66; from about 0.20 to about 0.67; from about 0.20 to about 0.68; from about 0.20 to about 0.69; from about 0.20 to about 0.70; from about 0.20 to about 0.71; from about 0.20 to about 0.72; from about 0.20 to about 0.73; from about 0.20 to about 0.74; from about 0.20 to about 0.75; from about 0.20 to about 0.76; from about 0.20 to about 0.77; from about 0.20 to about 0.78; from about 0.20 to about 0.79; from about 0.20 to about 0.80; from about 0.20 to about 0.81; from about 0.20 to about 0.82; from about 0.20 to about 0.83; from about 0.20 to about 0.84; from about 0.20 to about 0.85; from about 0.20 to about 0.86; from about 0.20 to about 0.87; from about 0.20 to about 0.88; from about 0.20 to about 0.89; from about 0.20 to about 0.90; from about 0.20 to about 0.91; from about 0.20 to about 0.92; from about 0.20 to about 0.93; from about 0.20 to about 0.94; from about 0.20 to about 0.95; from about 0.20 to about 0.96; from about 0.20 to about 0.97; from about 0.20 to about 0.98; from about 0.20 to about 0.99; from about 0.20 to about 1.00; from about 0.30 to about 0.31; from about 0.30 to about 0.32; from about 0.30 to about 0.33; from about 0.30 to about 0.34; from about 0.30 to about 0.35; from about 0.30 to about 0.36; from about 0.30 to about 0.37; from about 0.30 to about 0.38; from about 0.30 to about 0.39; from about 0.30 to about 0.40; from about 0.30 to about 0.41; from about 0.30 to about 0.42; from about 0.30 to about 0.43; from about 0.30 to about 0.44; from about 0.30 to about 0.45; from about 0.30 to about 0.46; from about 0.30 to about 0.47; from about 0.30 to about 0.48; from about 0.30 to about 0.49; from about 0.30 to about 0.50; from about 0.30 to about 0.51; from about 0.30 to about 0.52; from about 0.30 to about 0.53; from about 0.30 to about 0.54; from about 0.30 to about 0.55; from about 0.30 to about 0.56; from about 0.30 to about 0.57; from about 0.30 to about 0.58; from about 0.30 to about 0.59; from about 0.30 to about 0.60; from about 0.30 to about 0.61; from about 0.30 to about 0.62; from about 0.30 to about 0.63; from about 0.30 to about 0.64; from about 0.30 to about 0.65; from about 0.30 to about 0.66; from about 0.30 to about 0.67; from about 0.30 to about 0.68; from about 0.30 to about 0.69; from about 0.30 to about 0.70; from about 0.30 to about 0.71; from about 0.30 to about 0.72; from about 0.30 to about 0.73; from about 0.30 to about 0.74; from about 0.30 to about 0.75; from about 0.30 to about 0.76; from about 0.30 to about 0.77; from about 0.30 to about 0.78; from about 0.30 to about 0.79; from about 0.30 to about 0.80; from about 0.30 to about 0.81; from about 0.30 to about 0.82; from about 0.30 to about 0.83; from about 0.30 to about 0.84; from about 0.30 to about 0.85; from about 0.30 to about 0.86; from about 0.30 to about 0.87; from about 0.30 to about 0.88; from about 0.30 to about 0.89; from about 0.30 to about 0.90; from about 0.30 to about 0.91; from about 0.30 to about 0.92; from about 0.30 to about 0.93; from about 0.30 to about 0.94; from about 0.30 to about 0.95; from about 0.30 to about 0.96; from about 0.30 to about 0.97; from about 0.30 to about 0.98; from about 0.30 to about 0.99; from about 0.30 to about 1.00; from about 0.40 to about 0.40; from about 0.40 to about 0.41; from about 0.40 to about 0.42; from about 0.40 to about 0.43; from about 0.40 to about 0.44; from about 0.40 to about 0.45; from about 0.40 to about 0.46; from about 0.40 to about 0.47; from about 0.40 to about 0.48; from about 0.40 to about 0.49; from about 0.40 to about 0.50; from about 0.40 to about 0.51; from about 0.40 to about 0.52; from about 0.40 to about 0.53; from about 0.40 to about 0.54; from about 0.40 to about 0.55; from about 0.40 to about 0.56; from about 0.40 to about 0.57; from about 0.40 to about 0.58; from about 0.40 to about 0.59; from about 0.40 to about 0.60; from about 0.40 to about 0.61; from about 0.40 to about 0.62; from about 0.40 to about 0.63; from about 0.40 to about 0.64; from about 0.40 to about 0.65; from about 0.40 to about 0.66; from about 0.40 to about 0.67; from about 0.40 to about 0.68; from about 0.40 to about 0.69; from about 0.40 to about 0.70; from about 0.40 to about 0.71; from about 0.40 to about 0.72; from about 0.40 to about 0.73; from about 0.40 to about 0.74; from about 0.40 to about 0.75; from about 0.40 to about 0.76; from about 0.40 to about 0.77; from about 0.40 to about 0.78; from about 0.40 to about 0.79; from about 0.40 to about 0.80; from about 0.40 to about 0.81; from about 0.40 to about 0.82; from about 0.40 to about 0.83; from about 0.40 to about 0.84; from about 0.40 to about 0.85; from about 0.40 to about 0.86; from about 0.40 to about 0.87; from about 0.40 to about 0.88; from about 0.40 to about 0.89; from about 0.40 to about 0.90; from about 0.40 to about 0.91; from about 0.40 to about 0.92; from about 0.40 to about 0.93; from about 0.40 to about 0.94; from about 0.40 to about 0.95; from about 0.40 to about 0.96; from about 0.40 to about 0.97; from about 0.40 to about 0.98; from about 0.40 to about 0.99; from about 0.40 to about 1.00; from about 0.50 to about 0.51; from about 0.50 to about 0.52; from about 0.50 to about 0.53; from about 0.50 to about 0.54; from about 0.50 to about 0.55; from about 0.50 to about 0.56; from about 0.50 to about 0.57; from about 0.50 to about 0.58; from about 0.50 to about 0.59; from about 0.50 to about 0.60; from about 0.50 to about 0.61; from about 0.50 to about 0.62; from about 0.50 to about 0.63; from about 0.50 to about 0.64; from about 0.50 to about 0.65; from about 0.50 to about 0.66; from about 0.50 to about 0.67; from about 0.50 to about 0.68; from about 0.50 to about 0.69; from about 0.50 to about 0.70; from about 0.50 to about 0.71; from about 0.50 to about 0.72; from about 0.50 to about 0.73; from about 0.50 to about 0.74; from about 0.50 to about 0.75; from about 0.50 to about 0.76; from about 0.50 to about 0.77; from about 0.50 to about 0.78; from about 0.50 to about 0.79; from about 0.50 to about 0.80; from about 0.50 to about 0.81; from about 0.50 to about 0.82; from about 0.50 to about 0.83; from about 0.50 to about 0.84; from about 0.50 to about 0.85; from about 0.50 to about 0.86; from about 0.50 to about 0.87; from about 0.50 to about 0.88; from about 0.50 to about 0.89; from about 0.50 to about 0.90; from about 0.50 to about 0.91; from about 0.50 to about 0.92; from about 0.50 to about 0.93; from about 0.50 to about 0.94; from about 0.50 to about 0.95; from about 0.50 to about 0.96; from about 0.50 to about 0.97; from about 0.50 to about 0.98; from about 0.50 to about 0.99; from about 0.50 to about 1.00; from about 0.60 to about 0.61; from about 0.60 to about 0.62; from about 0.60 to about 0.63; from about 0.60 to about 0.64; from about 0.60 to about 0.65; from about 0.60 to about 0.66; from about 0.60 to about 0.67; from about 0.60 to about 0.68; from about 0.60 to about 0.69; from about 0.60 to about 0.70; from about 0.60 to about 0.71; from about 0.60 to about 0.72; from about 0.60 to about 0.73; from about 0.60 to about 0.74; from about 0.60 to about 0.75; from about 0.60 to about 0.76; from about 0.60 to about 0.77; from about 0.60 to about 0.78; from about 0.60 to about 0.79; from about 0.60 to about 0.80; from about 0.60 to about 0.81; from about 0.60 to about 0.82; from about 0.60 to about 0.83; from about 0.60 to about 0.84; from about 0.60 to about 0.85; from about 0.60 to about 0.86; from about 0.60 to about 0.87; from about 0.60 to about 0.88; from about 0.60 to about 0.89; from about 0.60 to about 0.90; from about 0.60 to about 0.91; from about 0.60 to about 0.92; from about 0.60 to about 0.93; from about 0.60 to about 0.94; from about 0.60 to about 0.95; from about 0.60 to about 0.96; from about 0.60 to about 0.97; from about 0.60 to about 0.98; from about 0.60 to about 0.99; from about 0.60 to about 1.00; from about 0.70 to about 0.71; from about 0.70 to about 0.72; from about 0.70 to about 0.73; from about 0.70 to about 0.74; from about 0.70 to about 0.75; from about 0.70 to about 0.76; from about 0.70 to about 0.77; from about 0.70 to about 0.78; from about 0.70 to about 0.79; from about 0.70 to about 0.80; from about 0.70 to about 0.81; from about 0.70 to about 0.82; from about 0.70 to about 0.83; from about 0.70 to about 0.84; from about 0.70 to about 0.85; from about 0.70 to about 0.86; from about 0.70 to about 0.87; from about 0.70 to about 0.88; from about 0.70 to about 0.89; from about 0.70 to about 0.90; from about 0.70 to about 0.91; from about 0.70 to about 0.92; from about 0.70 to about 0.93; from about 0.70 to about 0.94; from about 0.70 to about 0.95; from about 0.70 to about 0.96; from about 0.70 to about 0.97; from about 0.70 to about 0.98; from about 0.70 to about 0.99; from about 0.70 to about 1.00; from about 0.80 to about 0.80; from about 0.80 to about 0.81; from about 0.80 to about 0.82; from about 0.80 to about 0.83; from about 0.80 to about 0.84; from about 0.80 to about 0.85; from about 0.80 to about 0.86; from about 0.80 to about 0.87; from about 0.80 to about 0.88; from about 0.80 to about 0.89; from about 0.80 to about 0.90; from about 0.80 to about 0.91; from about 0.80 to about 0.92; from about 0.80 to about 0.93; from about 0.80 to about 0.94; from about 0.80 to about 0.95; from about 0.80 to about 0.96; from about 0.80 to about 0.97; from about 0.80 to about 0.98; from about 0.80 to about 0.99; from about 0.80 to about 1.00; from about 0.90 to about 0.91; from about 0.90 to about 0.92; from about 0.90 to about 0.93; from about 0.90 to about 0.94; from about 0.90 to about 0.95; from about 0.90 to about 0.96; from about 0.90 to about 0.97; from about 0.90 to about 0.98; from about 0.90 to about 0.99; and, from about 0.90 to about 1.00.

M may be iron and the active material particles may form a stable solid solution when x ranges from about 0 to about 0.8. In some embodiments, M may be iron and the active material particles may form a stable solid solution when x ranges from about 0 to about 0.9. In some embodiments, M may be iron and the active material particles may form a stable solid solution when x ranges from about 0 to about 0.95.

Conductive particles may comprise one or a combination of: buckyballs; buckminsterfullerenes; carbon; carbon black; ketjan black; carbon nanostructures; carbon nanotubes; carbon nanoballs; carbon fiber; graphite; graphene; graphitic sheets; graphite nanoparticles; and, potato graphite. Functional differences may comprise one or a combination of a compositional difference, an organizational difference; a structural difference, a compositional difference and a structural difference, a compositional difference and an organizational difference, a structural difference and an organizational difference, a compositional difference, a structural difference, and an organizational difference. At least one layer may have electrical impedance greater than at least one other layer or an electrical resistance greater than at least one other layer, or both, and, optionally, at least one layer may be more ionically permeable than at least one other layer.

In some embodiments, the active material particles may comprise a material selected from the list consisting of: Li₃BiF₃; Li₃Bi₂O₃; LiCoO₂; Li₂CoF₂; Li₃CrF₃; Li₃Cr₂O₃; Li₂CuF₂: Li₂CuO; Li₂CuS; Li₃FeF₃; Li₃Fe₂O₃; Li₂FeF₂; Li₂FeO; Li₂FeS; Li₂MnF₂; Li₂MnO; LiMn₂O₄; Li₃MnF₃; Li₃Mn₂O₃; Li₂MnS; Li₂NiF₂; LiNiO₂; Li₂NiO; Li₃VF₃; and, Li₃V₂O₃

In some embodiments, the active material comprises an anode active material selected from the group comprising: carbon; graphite; graphite coated graphite; graphene; mesocarbon micobeads; carbon nanotubes; silicon; porous silicon; nanostructured silicon; nanometer scale silicon; micrometer scale silicon; alloys containing silicon; carbon coated silicon; carbon nanotube coated silicon; manganese vanadate; manganese molybdate; sulfer oxide; highly oriented pyrolytic graphite; tin; tin oxide; alloys containing tin; antimony, tin antimony; lithium metal; and Li₄Ti₅O₁₂.

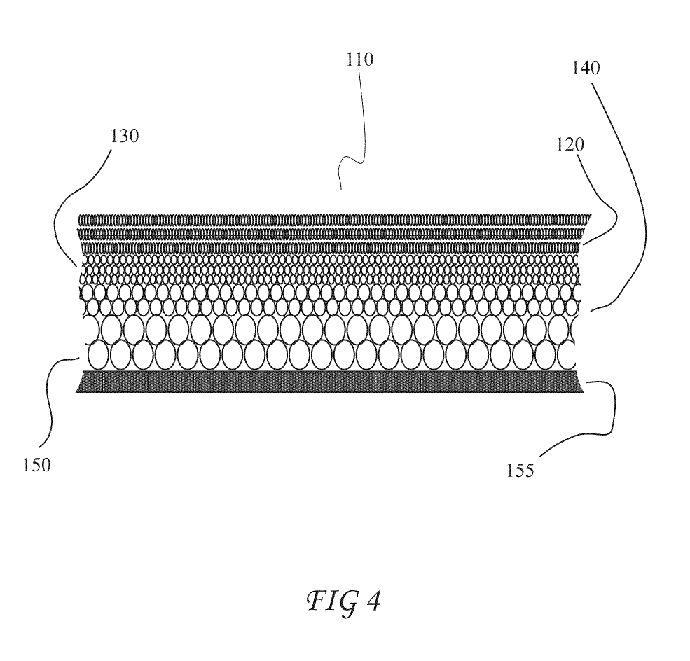

The invention provides for cells that exploit the above mentioned beliefs by varying parameters such as particle size, size distribution with the electrode, conductive particle concentrations, and binder concentrations within an electrode. FIG. 4 depicts an exemplary electrode matrix provided for by the invention wherein such matrix has a functional gradient formed therein. Here, Electrode 110 comprises a plurality of layers wherein each layer differs from at least one other layer in Electrode 110. By way of non-limiting example, FIG. 4 depict a multilayer electrode, Electrode 110, having four layers each comprising active material particles which differ in size from layer to layer. Current Collector 155 has thereupon Layer 150 having the largest active material particle sizes within the electrode. Layers 140, 130, and 120 are each progressively smaller in active material particle size in comparison to Layer 150. Examples of how layers may differ is that at least one layer may have more ion storage capacity than at least one other layer. The electrode may further comprise at least two of the plurality of layers, wherein at least one layer may comprise more binder polymer than at least one other layer. Preferably, at least one layer may comprise more conductive particles than at least one other layer, or, at least one layer may comprise more active material particles than at least one other layer, or both.

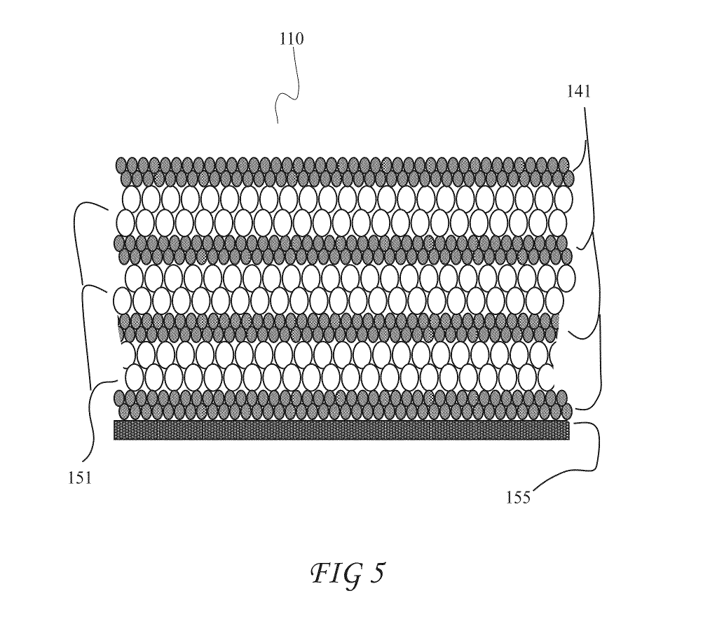

In a preferred embodiment, an electrode may comprise a plurality of layers having a repeating order of arrangement. FIG. 5 depicts an electrode having a repeating order of arrangement wherein Electrode 110 comprises Current Collector 155 having thereupon alternating layers Larger Active Material Particle Layers 151 with interposed Smaller Active Material Particle Layers 141. Layer thicknesses generally are between 10 μm and 50 μm, however thickness of about 1 μm; about 2 μm; about 3 μm; about 4 μm; about 5 μm; about 6 μm; about 7 μm; about 8 μm; about 9 μm; about 10 μm; about 11 μm; about 12 μm; about 13 μm; about 14 μm; about 15 μm; about 16 μm; about 17 μm; about 18 μm; about 19 μm; about 20 μm; about 21 μm; about 22 μm; about 23 μm; about 24 μm; about 25 μm; about 26 μm; about 27 μm; about 28 μm; about 39 μm; about 30 μm; about 31 μm; about 32 μm; about 33 μm; about 34 μm; about 35 μm; about 36 μm; about 37 μm; about 38 μm; about 39 μm; about 40 μm; about 41 μm; about 42 μm; about 43 μm; about 44 μm; about 45 μm; about 46 μm; about 47 μm; about 48 μm; about 49 μm; about 50 μm; about 51 μm; about 52 μm; about 53 μm; about 54 μm; about 55 μm; about 56 μm; about 57 μm; about 58 μm; about 59 μm; about 60 μm; about 61 μm; about 62 μm; about 63 μm; about 64 μm; about 65 μm; about 66 μm; about 67 μm; about 68 μm; about 69 μm; about 70 μm; about 71 μm; about 72 μm; about 73 μm; about 74 μm; about 75 μm; about 76 μm; about 77 μm; about 78 μm; about 79 μm; about 80 μm; about 81 μm; about 82 μm; about 83 μm; about 84 μm; about 85 μm; about 86 μm; about 87 μm; about 88 μm; about 89 μm; about 90 μm; about 91 μm; about 92 μm; about 93 μm; about 94 μm; about 95 μm; about 96 μm; about 97 μm; about 98 μm; about 99 μm; about 100 μm; about 101 μm; about 102 μm; about 103 μm; about 104 μm; about 105 μm; about 106 μm; about 107 μm; about 108 μm; about 109 μm; about 110 μm; about 111 μm; about 112 μm; about 113 μm; about 114 μm; about 115 μm; about 116 μm; about 117 μm; about 118 μm; about 119 μm; about 120 μm; about 121 μm; about 122 μm; about 123 μm; about 124 μm; about 125 μm; about 126 μm; about 127 μm; about 128 μm; about 129 μm; about 130 μm; about 131 μm; about 132 μm; about 133 μm; about 134 μm; about 135 μm; about 136 μm; about 137 μm; about 138 μm; about 139 μm; about 140 μm; about 141 μm; about 142 μm; about 143 μm; about 144 μm; about 145 μm; about 146 μm; about 147 μm; about 148 μm; about 149 μm; about 150 μm; about 151 μm; about 152 μm; about 153 μm; about 154 μm; about 155 μm; about 156 μm; about 157 μm; about 158 μm; about 159 μm; about 160 μm; about 161 μm; about 162 μm; about 163 μm; about 164 μm; about 165 μm; about 166 μm; about 167 μm; about 168 μm; about 169 μm; about 170 μm; about 171 μm; about 172 μm; about 173 μm; about 174 μm; about 175 μm; about 176 μm; about 177 μm; about 178 μm; about 179 μm; about 180 μm; about 181 μm; about 182 μm; about 183 μm; about 184 μm; about 185 μm; about 186 μm; about 187 μm; about 188 μm; about 189 μm; about 190 μm; about 191 μm; about 192 μm; about 193 μm; about 194 μm; about 195 μm; about 196 μm; about 197 μm; about 198 μm; about 199 μm; about 200 μm; about 201 μm; about 202 μm; about 203 μm; about 204 μm; about 205 μm; about 206 μm; about 207 μm; about 208 μm; about 209 μm; about 210 μm; about 211 μm; about 212 μm; about 213 μm; about 214 μm; about 215 μm; about 216 μm; about 217 μm; about 218 μm; about 219 μm; about 220 μm; about 221 μm; about 222 μm; about 223 μm; about 224 μm; about 225 μm; about 226 μm; about 227 μm; about 228 μm; about 239 μm; about 230 μm; about 231 μm; about 232 μm; about 233 m; about 234 μm; about 235 μm; about 236 μm; about 237 μm; about 238 μm; about 239 μm; about 240 μm; about 241 μm; about 242 μm; about 243 μm; about 244 μm; about 245 μm; about 246 μm; about 247 μm; about 248 μm; about 249 μm; about 250 μm; about 251 μm; about 252 μm; about 253 μm; about 254 μm; about 255 μm; about 256 μm; about 257 μm; about 258 μm; about 259 μm; about 260 μm; about 261 μm; about 262 μm; about 263 μm; about 264 μm; about 265 μm; about 266 μm; about 267 μm; about 268 μm; about 269 μm; about 270 μm; about 271 μm; about 272 μm; about 273 μm; about 274 μm; about 275 μm; about 276 μm; about 277 μm; about 278 μm; about 279 μm; about 280 μm; about 281 μm; about 282 μm; about 283 μm; about 284 μm; about 285 μm; about 286 μm; about 287 μm; about 288 μm; about 289 μm; about 290 μm; about 291 μm; about 292 μm; about 293 μm; about 294 μm; about 295 μm; about 296 μm; about 297 μm; about 298 μm; about 299 μm; and, about 300 μm are contemplated by the invention.

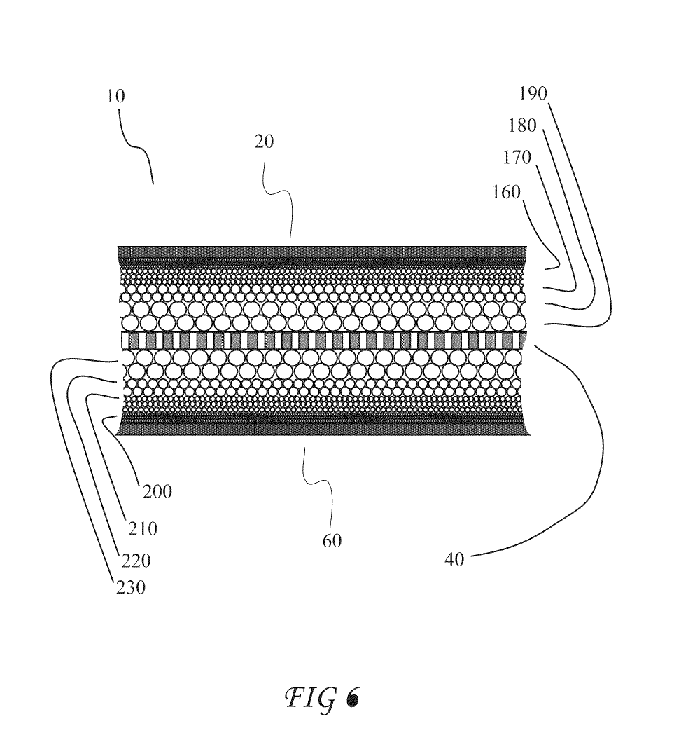

When used in a cell, the preferred electrodes of the invention may resemble schematically the electrode depicted in FIG. 6. Here, an exemplary battery cell of invention is shown where the cathode and anode are electrode matrices each having at least one functional gradient within each. In FIG. 6, Cell 10 comprises, reading from bottom up, Anode Current Collector 60 having associated therewith First through Fourth Anode Layers 200, 210, 220, and 230, respectively, wherein First Anode Layer 200 has the smallest active material particles, and each subsequent layer having ever increasing active material particle sizes therein. Cathode Current Collector 20 has associated therewith, First through Fourth Cathode Layers 160, 170, 180, and 190, respectively, wherein First Cathode Layer 160 has the smallest active material particles within Cathode 30, and each subsequent layer having ever increasing active material particle sizes therein. Between Cathode 30 and Anode 50 is Separator 40 which electrically isolates Cathode 30 and Anode 50 from each other while permitting ion transfer through Separator 40, typically through pores, channels, or gaps in Separator 40.

In some embodiments, the electrode may comprise two or more layers, each layer having a first surface and a second surface, wherein the first surface of the first layer is in electrical communication with the current collector at the current collector surface, and, wherein the first surface of the second layer is in electrical and ionic communication with the second surface of the first layer. The first layer may comprise smaller active material particles, on average, than the second layer. The first layer comprises fewer conductive particles, on average, than the second layer. The layers may be imaginary boundaries delineating two regions of an electrode having different functional properties.

The invention provides, in some embodiments, for cells comprising one or both electrodes formed in accordance with the methods of the invention and such electrodes having a gradient therein, preferably, a functional gradient. FIG. 7 depicts an exemplary battery cell the invention provides wherein the cathode and anode are electrode matrices each having a functional gradient therein, each gradient running in a direction normal to Cathode Current Collector 20 and Anode Current Collector 60. The organization of the layers in each electrode is such that larger active materials are adjacent a current collector. Here, Anode Current Collector 60 has adjacent thereto Layer 230 comprising Cathode 30's largest active material particles, then Layers 220 through 200 in order of decreasing active material particle size, the layer being sequentially layered upon Layer 230. Likewise, Cathode Current Collector 20 has adjacent thereto Layer 190 having Cathode 30's largest active material particles, then Layers 180 through 160 in order of decreasing active material particle size, the layers being sequentially layered upon Layer 190.

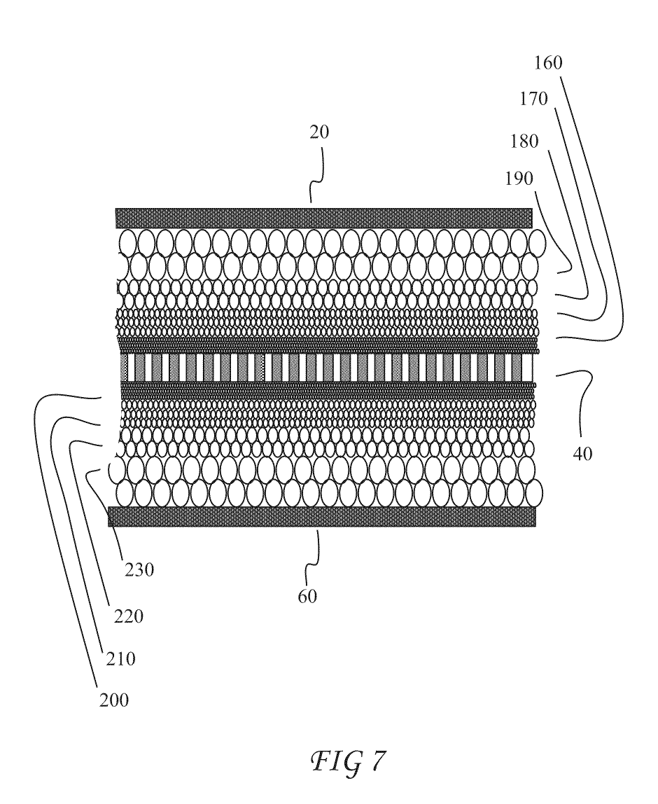

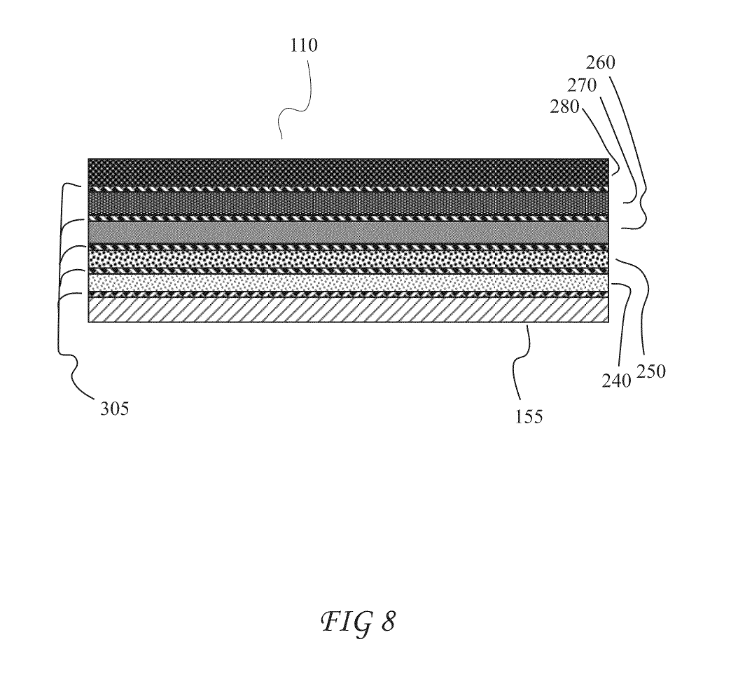

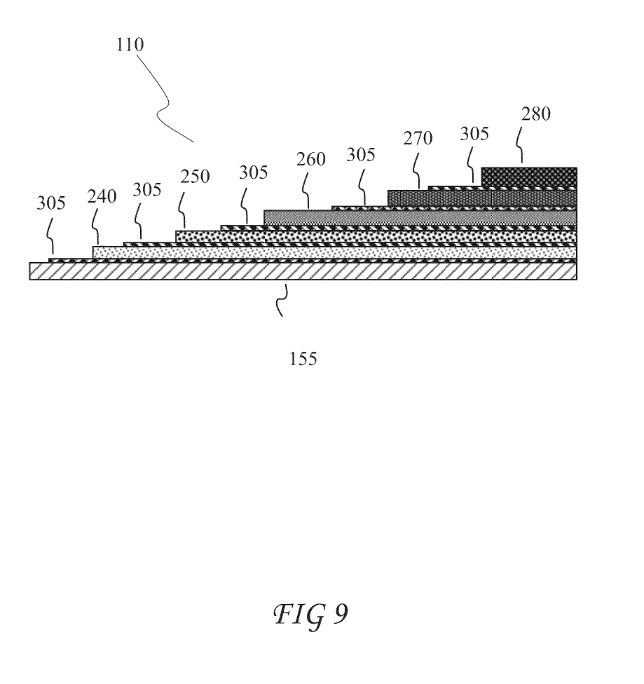

In some embodiments, it may be desired to have an electrode comprising a plurality of layers wherein at least one of the layers comprises mostly conductive particles. Not wishing to be bound by theory, it has been discovered that having intervening conductive layers between layers of active material and conductive particles improves electrode performance, in part, by reducing the internal resistance of the electrode. Because the intervening conductive layers are relatively thin when compared to layers comprising active material and conductive material, it is believed that addition of the conductive layer does not sacrifice significant electrode ion storage capacity. An example of an electrode comprising intervening conductive layers is show in FIG. 8 which depicts an exemplary electrode matrix the invention provides where the active material particles/conductive particles layers have interposed therebetween layers with at least 50% of solids being conductive particles. Electrode 110 comprises a plurality of layers, Layers 240 through 280, each layer comprising active material particles and conductive particles. Layers 305 comprise higher amounts of conductive material when compared to Layers 240 through 280. It has been discovered that applying Layer 305 first to Current Collector 155 improves electrode adhesion and lowers the electrode's internal resistance. Each layer up from Current Collector 155 alternates between a Layer 305 having higher conductive particle amounts, and layers 240 through 280. The resulting Electrode 110 has lower internal resistance when compared to an electrode of similar storage capacity yet lacking intervening conductive Layers 305. FIG. 9 depicts the subject matter of FIG. 8 with cut-away viewing to highlight each layer of the electrode matrix.

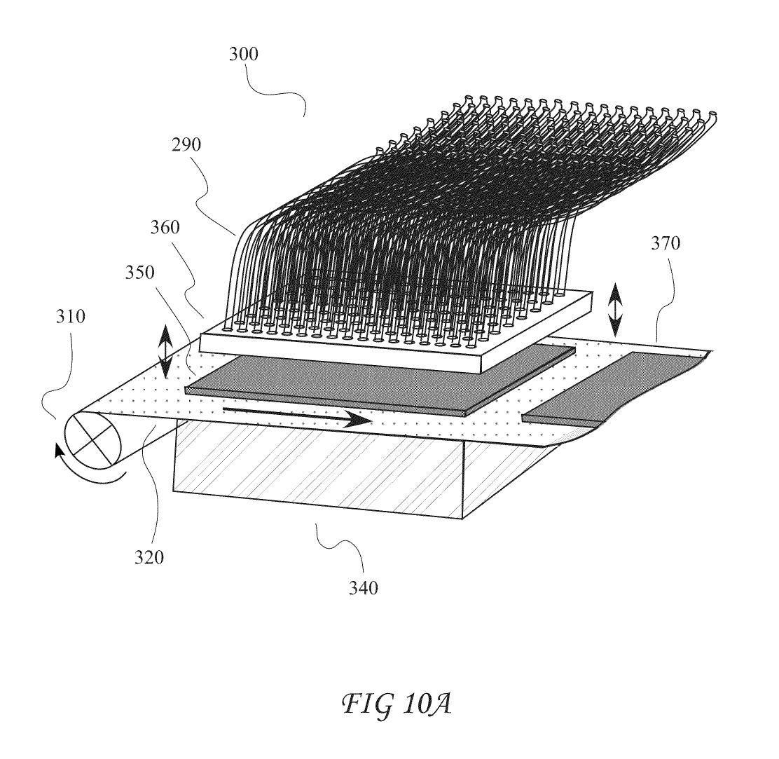

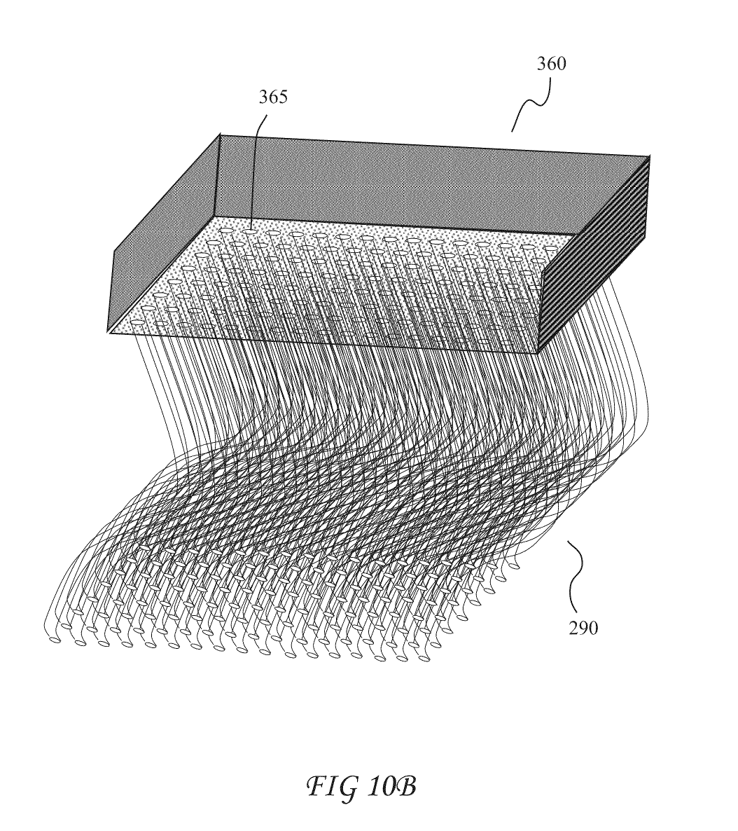

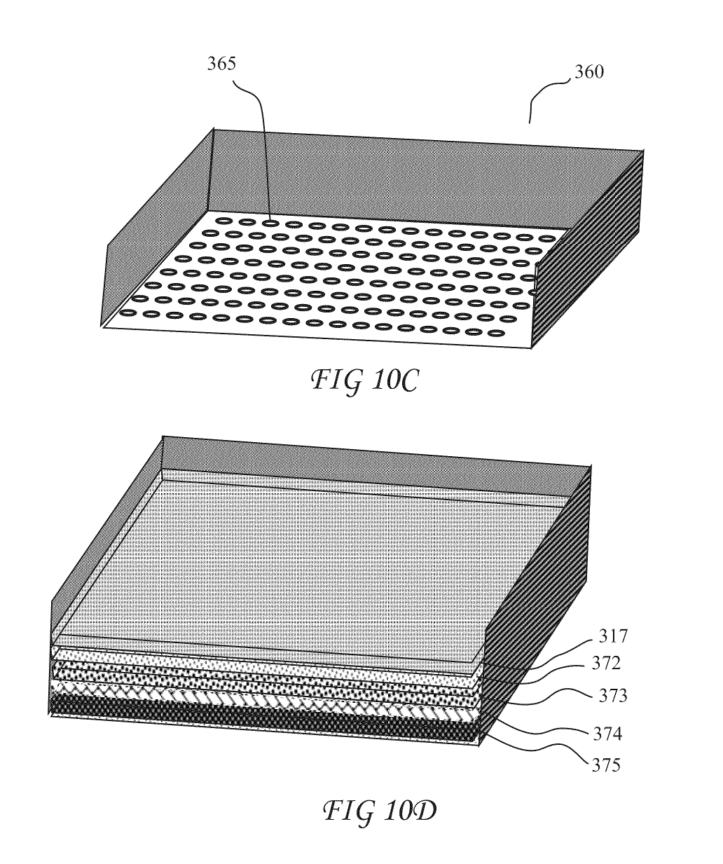

FIG. 10A through 10D depict an exemplary electrode matrix forming device the invention provides wherein electrode matrices having at least one functional gradient therein are cast in-place along a moving roll-stock of electrode support. To make the preferred electrodes of the invention, the invention provides for methods and apparatuses for making electrodes having therein at least one gradient, preferably a gradient running normal to the surface of the current collector (electrode support). FIGS. 10A through 10D depict an exemplary electrode matrix forming device wherein layers seamlessly deposited upon a moving roll-stock electrode support. FIG. 10A shows Coating System 300 comprises Casting Manifold 290 having a plurality of feed tubes containing coating suspension arriving from a mixer in fluid communication with a plurality of coating suspensions, at least two coating suspensions being different from each other, the mixer dynamically combining and mixing a coating suspension having a selected composition for its intended spatial location within the cast electrode. Accordingly, along any feed line of Manifold 290 may be a gradient of compositions arranged as the gradient is to be arranged within the to-be cast electrode. By monitoring flow rates and volumes, an automated system can fill each feed tube with a plurality of gradients in sequence for ultimate deposition into discrete electrodes, each electrode receiving one or more gradients as desired. The reason for the plurality of feed tubes is to ensure that at any given point in the x,y dimension of the electrode, the composition of the electrode at distance z corresponds with the desired profile of the gradient sought within the electrode. FIG. 10B presents a cut-away perspective view of Casting Manifold Head 360 with Casting Manifold 290 leading thereto. Casting Manifold Head 360 is presented up-side-down to show the distribution of Outlets 361 of Casting Manifold 290 within Casting Manifold Head 360. FIG. 10C shows Casting Manifold Head 360, again inverted and in cut-away perspective view, wherein Casting Manifold Head 360 is empty as evidenced by the appearance of Outlets 361. FIG. 10D shows Casting Manifold Head filled with 5 gradations of a continuous gradient formed by the upstream mixing and pumping system, not show. Gradations 317 through 375 represent changes in one or a combination of composition, organization, structure, and/or function of the gradation within the functional gradient of the electrode.

Electrodes may have a loading density ranging from about 0.5 mg/cm² to about 1.0 mg/cm²; from about 1.0 mg/cm² to about 2.0 mg/cm²; or from about 1.5 mg/cm² to about 2.5 mg/cm²; or from about 2.0 mg/cm² to about 2.5 mg/cm²; or from about 2.0 mg/cm² to about 3.0 mg/cm²; or from about 1.0 mg/cm² to about 3.0 mg/cm²; or from about 2.0 mg/cm² to about 4.0 mg/cm²; or from about 1.0 mg/cm² to about 5.0 mg/cm²; or from about 3.0 mg/cm² to about 5.0 mg/cm²; or from about 4.5 mg/cm² to about 5.0 mg/cm²; or from about 5.0 mg/cm² to about 10 mg/cm²; or from about 6.0 mg/cm² to about 7.0 mg/cm²; or from about 7.0 mg/cm² to about 8.0 mg/cm²; or from about 8.0 mg/cm² to about 9.0 mg/cm²; or from about 9.0 mg/cm² to about 10 mg/cm²; or from about 10 mg/cm² to about 11 mg/cm²; or from about 11 mg/cm² to about 12 mg/cm²; or from about 12 mg/cm² to about 13 mg/cm²; or from about 13 mg/cm² to about 14 mg/cm²; or from about 14 mg/cm² to about 15 mg/cm²; or from about 15 mg/cm² to about 20 mg/cm²; or from about 20 mg/cm² to about 30 mg/cm²; or from about 30 mg/cm² to about 40 mg/cm²; or from about 40 mg/cm² to about 50 mg/cm²; or from about 1.5 mg/cm² to about 3.5 mg/cm²; or from about 2.0 mg/cm² to about 4.5 mg/cm²; or from about 1.0 mg/cm² to about 8.0 mg/cm²; from about 5.0 mg/cm² to about 8.0 mg/cm². or from about 1.0 mg/cm² to about 5.0 mg/cm²; or from about 3.0 mg/cm² to about 5.0 mg/cm²; or from about 1.5 mg/cm² to about 3.5 mg/cm²; or from about 2.0 mg/cm² to about 4.5 mg/cm²; or from about 1.0 mg/cm² to about 8.0 mg/cm²; from about 5.0 mg/cm² to about 8.0 mg/cm². or from about 1.0 mg/cm² to about 20 mg/cm²; or from about 1.5 mg/cm² to about 25 mg/cm²; or from about 2.0 mg/cm² to about 25 mg/cm²; or from about 1.0 mg/cm² to about 25 mg/cm²; or from about 1.0 mg/cm² to about 30 mg/cm²; or from about 1.0 mg/cm² to about 35 mg/cm²; or from about 1.0 mg/cm² to about 40 mg/cm²; or from about 1.0 mg/cm² to about 50 mg/cm²; or from about 15 mg/cm² to about 35 mg/cm²; or from about 20 mg/cm² to about 45 mg/cm²; or from about 10 mg/cm² to about 80 mg/cm²; and, from about 50 mg/cm² to about 80 mg/cm² are contemplated by the invention. Electrodes having a loading density ranging from about 11 mg/cm² to about 15 mg/cm² or a loading density of about 12.5 mg/cm² to about 15 mg/cm² are likewise contemplated by the invention.

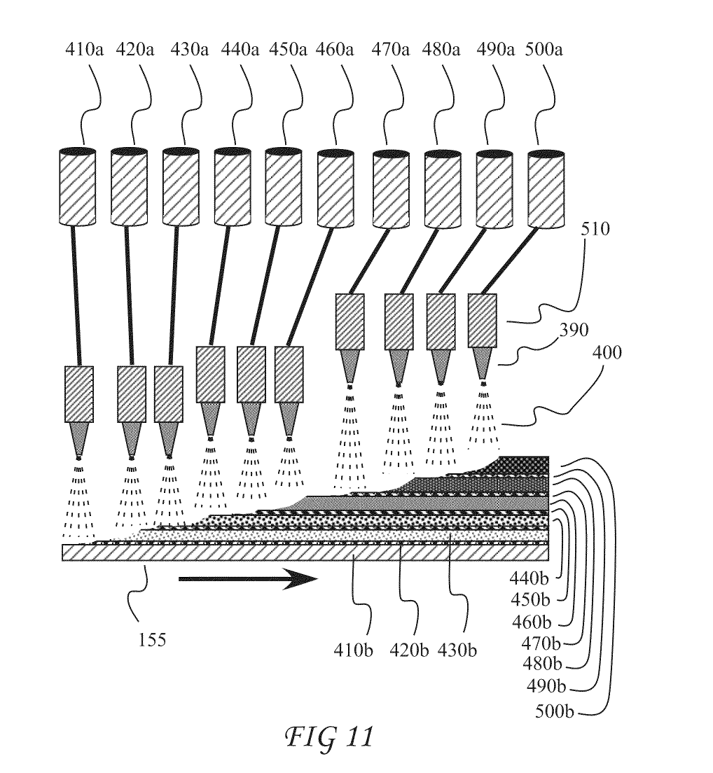

An alternative to casting electrodes having at least one functional gradient therein, the invention provides apparatuses and methods for making such electrodes using wholly, or partly, spray application of electrode coating suspensions. FIG. 11 shows an exemplary embodiment of the invention wherein Roll Stock Current Collector 155 is sequentially spray coated with a plurality of electrode coating suspensions wherein at least one electrode coating suspension is different from another electrode coating suspension used in the coating line. Each electrode coating suspension is contained in Reservoirs 410a through 500a ready for distribution to Spray Heads 510 having each attached thereto Spray Nozzle 390 from which each electrode coating suspension is ejected to form Spray Patterns 400. Spray Heads 510 are sequentially arranged so that when in continuous operation, Layers 410b through 500b are applied to Current Collector 155 in a sequential manner to produce a multilayered electrode. In some embodiments, there may be a heating, cooling, or both, step performed prior to, during, after, or a combination thereof with respect to each or some of the spray steps.

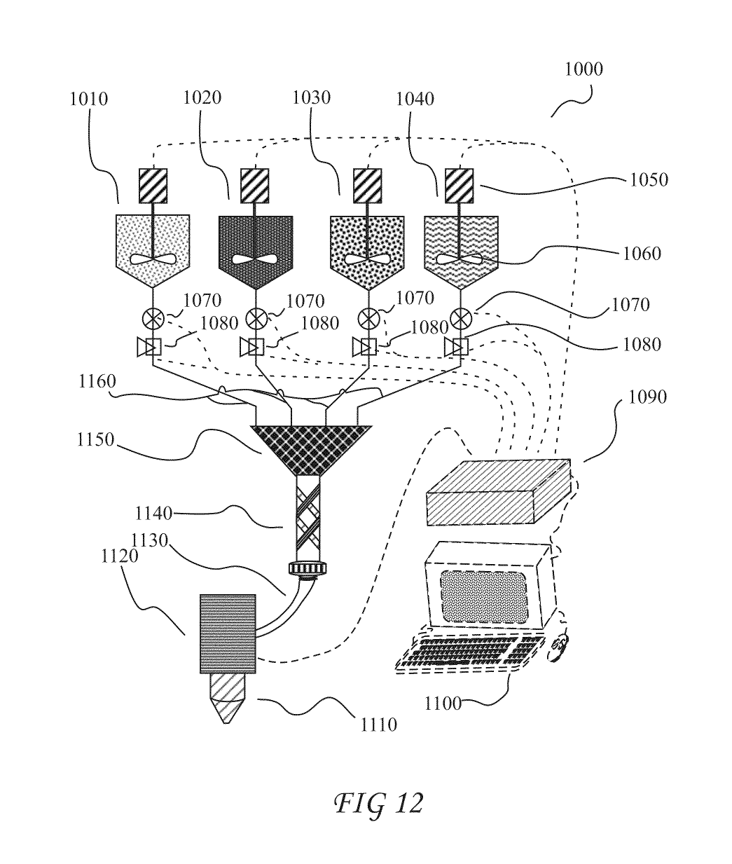

Electrode coating suspensions of the invention can be prepared using traditional techniques known to one of ordinary skill in the art. The invention also provides, in one embodiment, for a dynamic electrode coating suspension formation that combines and mixes the constituents for delivery to a depositing device, for example, but not limited to, a sprayer. An exemplary system is shown in FIG. 12 where Coating Suspension Former 1000 comprises two or more reservoirs, here, Reservoirs 1010 through 1040, each having Motor 1050 driving Impeller 1060. Impellers 1060 work to maintain homogeneity of the liquid held in Reservoir 1010, et seq. Fluid Lines 1160 establish liquid communication between Reservoirs 1010 through 1040 with Pre-Mixer 1050 and Spiral Mixer 1140. Each Fluid Line 1160 has associated therewith Pump 1070 and Flow Controller 1080 to pump coating suspension and to regulate liquid flow, respectively, as coating suspension moves into Pre-Mixer 1150. Motors 1050, Pumps 1070, and Flow Controllers 1080 are under computer control through Controller 1090 that is in communication with Computer 1100 to create different combinations in accordance with a computer program running on Computer 1100. The coating suspension is pumped from Pre-Mixer 1150 on through Spiral Mixer 1140 that further mixes the coating suspension and through Feed Tube 1130 into Spray Head 1120 and Spray Nozzle 1110. Other deposition methods known to those of ordinary skill in the art and as provided for by the invention described herein.

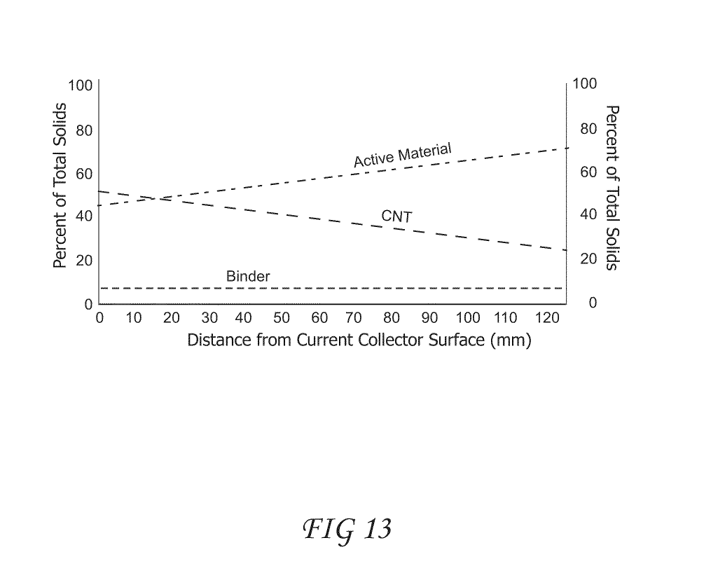

Electrodes made using the preferred methods of the invention may have their composition represented graphically. FIGS. 13 through 25 graphically depict different scenarios of changes made in composition of an electrode matrix wherein the electrode matrix composition changes as a function of distance from the electrode support.

In some embodiments, ratio of active material particles to conductive particles may change as a function of distance from the electrode support or current collector. FIG. 13 graphically depicts an exemplary electrode where the ratio of active material to conductive particles, here carbon nanotubes, changes as a function of distance from the current collector surface. The electrode, in regions proximal to the surface of the current collector contains higher amounts of conductive particles than region proximal to the surface of the current collector surface. Conversely, the regions of the electrode proximal to the current collector surface contains lower amounts of active material particles than regions of the electrode distal to the surface of the current collector.

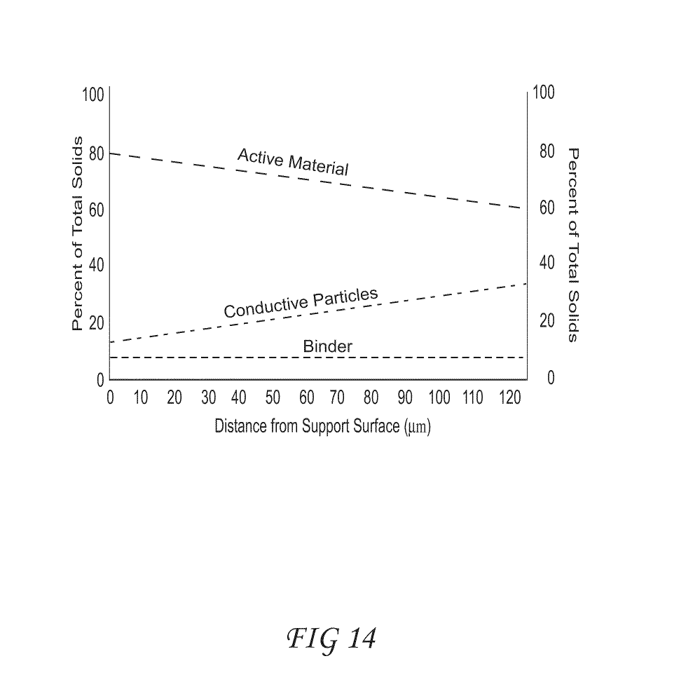

FIG. 14 depicts a preferred gradient profile wherein, as a function of distance from the electrode support, in some instances, the current collector. Here, the concentration of active material particles and conductive material particles changes as a function of distance from the electrode support surface, wherein the active material particle concentration decreases as the distance from the electrode support surface increases, and the conductive particle concentration increases as the distance from the electrode support surface increases.

In another embodiment, between each active material containing layer within the electrode matrix is a layer comprising relatively high concentrations of conductive particles. FIG. 15 graphically depicts how occasionally, and as a function of distance from the electrode support surface, the percentage of total solids of active material sharply drops while the percentage of total solids for conductive particles rises sharply for a short distance, then returning to high active material particle percentages shortly thereafter. Not wishing to be bound by theory, it is believed that the thin intermittent conductive layers help to improve electron conductivity within the electrode matrix.

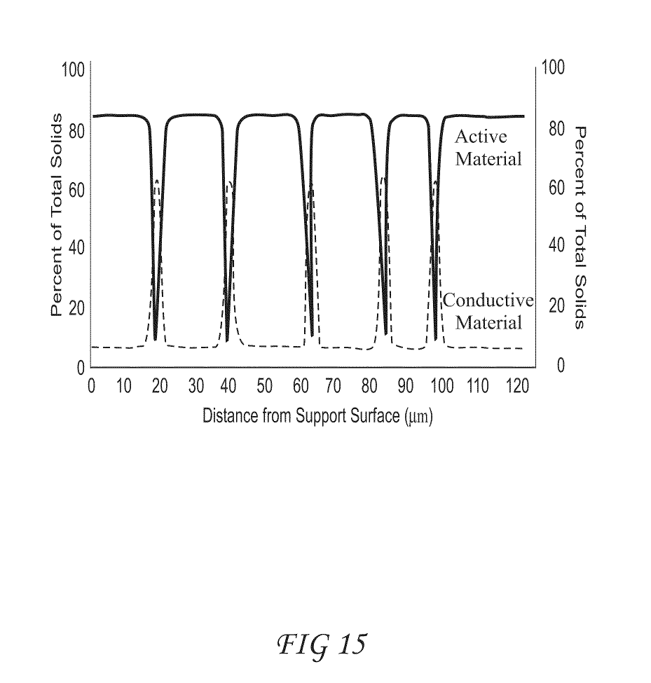

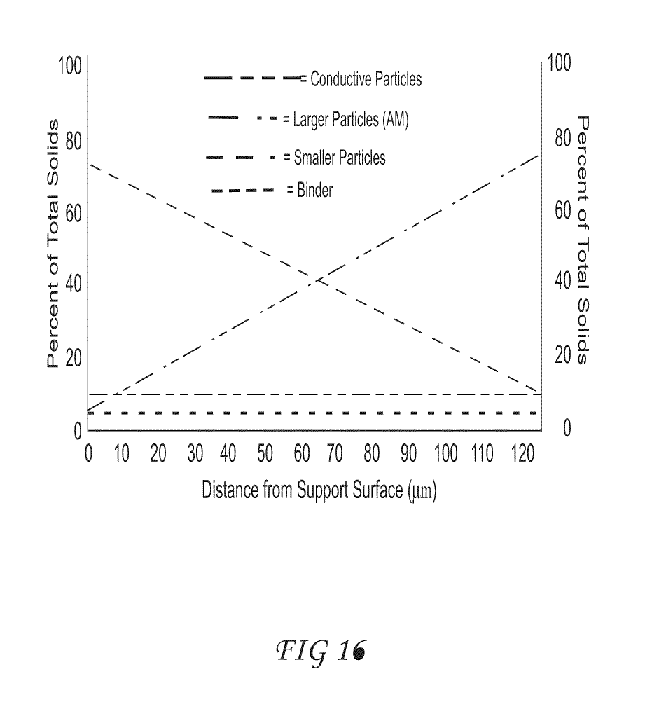

In some embodiments, it is desirable to alter the average size of active material particles as a function of distance from the electrode support surface. In FIG. 16, the percentage of total solids for smaller active material particles decreases as the distance from the electrode support surface increases, and the percentage of total solids for larger active material particles increases as the distance from the electrode support surface increases. Not wishing to be bound by theory, it is believed that increasing the active material particle size as a function of distance from the electrode support surface creates an electrode having greater ion permeability throughout the electrode matrix. In the electrode of FIG. 15, the percentage of solids for the binder polymer and conductive particles remained constant.

Using an opposite strategy to that described for FIG. 116, FIG. 17 graphically depicts the percentage of total solids for larger active material particles decreases as the distance from the electrode support surface increases, and the percentage of total solids for smaller active material particles increases as the distance from the electrode support surface increases. In the electrode of FIG. 16, the percentage of solids for the binder polymer and conductive particles remained constant.

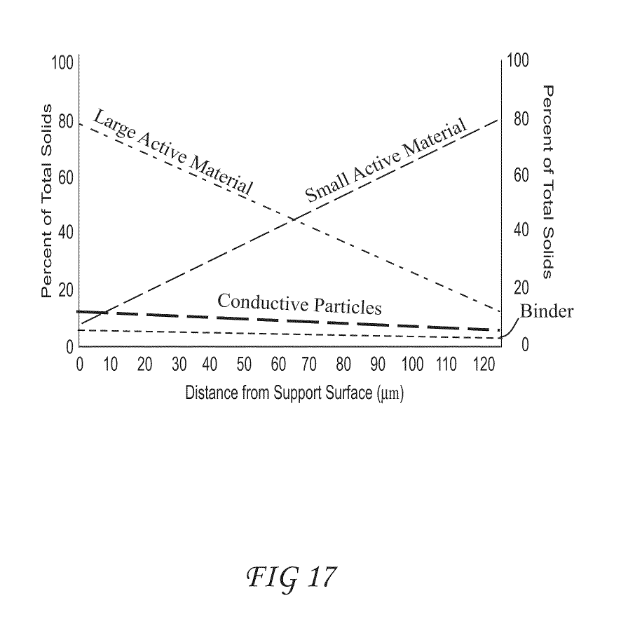

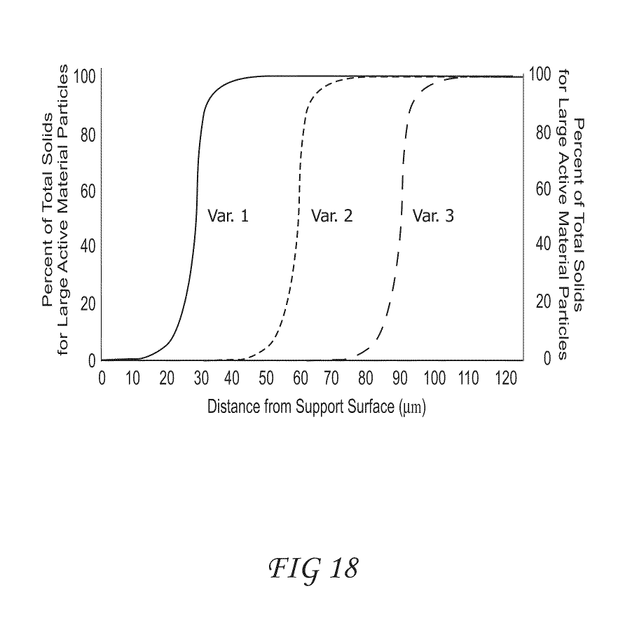

When electrodes are made with gradients having an “S” shape, the gradients change abruptly from one layer in the electrode matrix to another in contrast to the gradients having more linear of slopes. In FIG. 18, three variations are presented wherein the ratio of larger active material particles to smaller active material particles follow abrupt changes at the boundary between two layers. In some embodiments, such abrupt changes occur two or more times through the axis (z) running about normal to the electrode support surface.

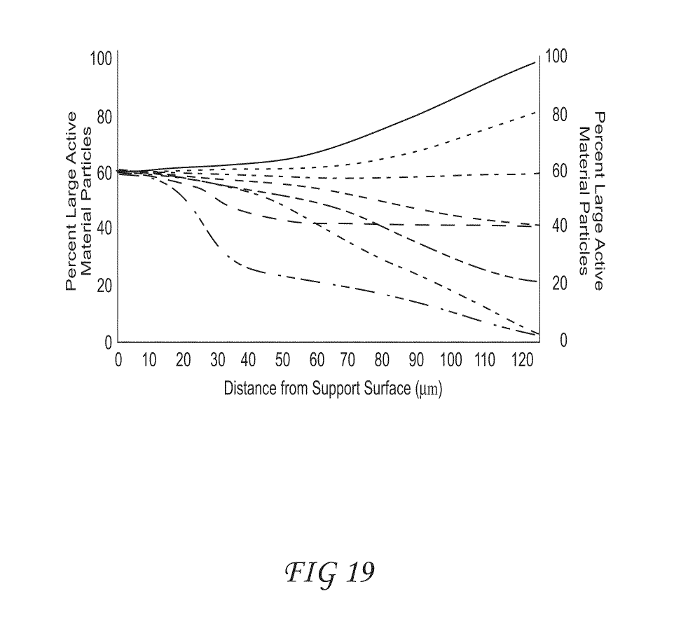

FIG. 19 shows eight different profiles for the change of particle size ratios as a function of distance from the electrode support surface. Different curves are shown to represent the many possibilities for gradient profiles within an electrode matrix.

In some embodiments, the gradients formed within an electrode matrix may be stepped gradients. By way of non-limiting example, in certain embodiments where coating suspensions are deposited by spray or electrophoretic deposition, the resulting electrode may have therein a stepped gradient. In other embodiments, a step gradient can be formed by using calendaring between application of layers wherein the amount of force used to calendar, or compress, the electrode matrix, or incomplete electrode matrix, can be varied to form an electrode having therein a plurality of layers wherein at least two layers have different density, represented as percent of maximum theoretical density. In the electrode represented in FIG. 20, each subsequent calendaring or compression step resulted in lower and lower densification for each subsequent layer.

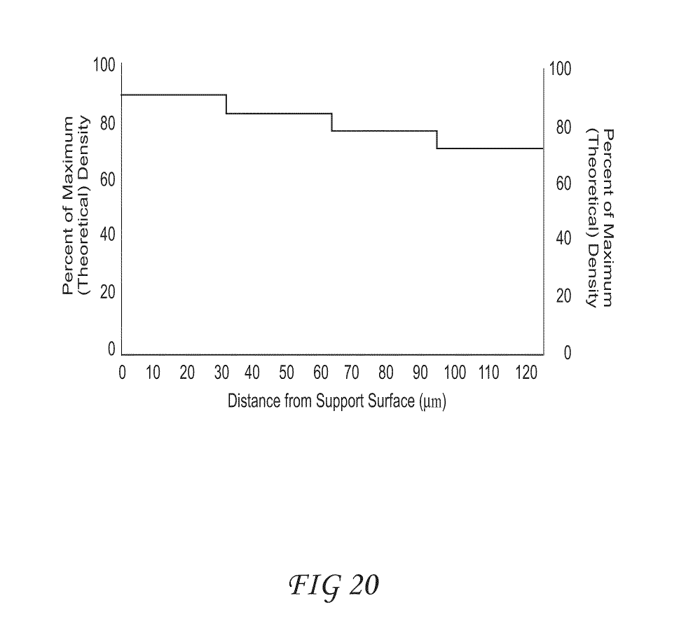

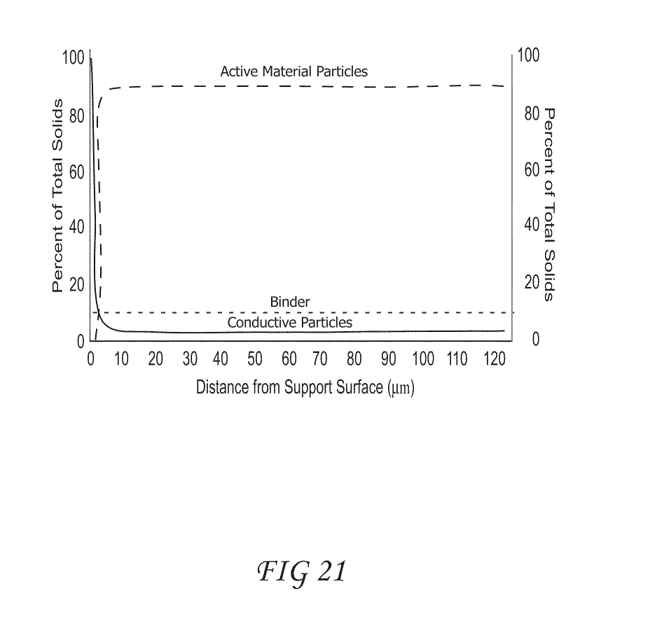

In some embodiments, it may be desired to form a conductive particle layer first upon the surface of an electrode support to facilitate improve conductivity, and/or adhesion, among other things. The graph in FIG. 21 shows an initial high percentage of total solids for conductive particles with a low initial percentage for active material particles that within a few micrometers distance from the surface of the electrode support reciprocates to where there is a relatively high percentage of total solids for active material particles and a lower percentage of conductive particles. As shown, the percent of total solids for the binder remains constant through the electrode thickness.

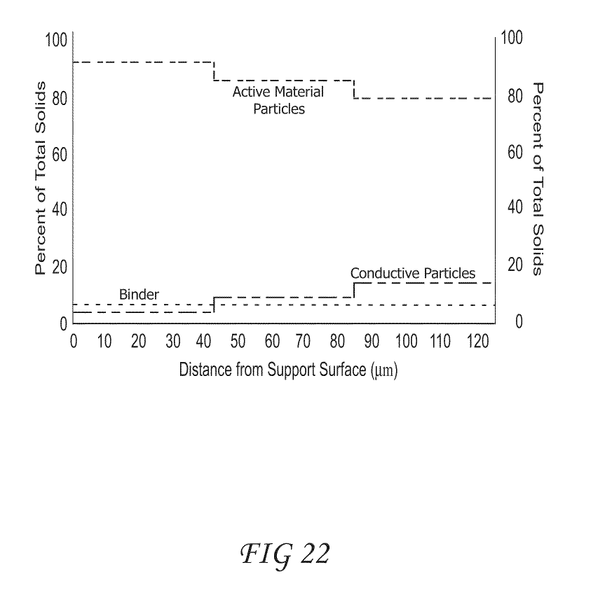

The theme represented in FIG. 21 was varied as represented in FIG. 22 where active material particles and conductive material particles percent of total solids changes in a step-wise manner, the rise or drop in each step indicating a layer boundary, whether or not the electrode matrix is monolithic or seamless in structure.

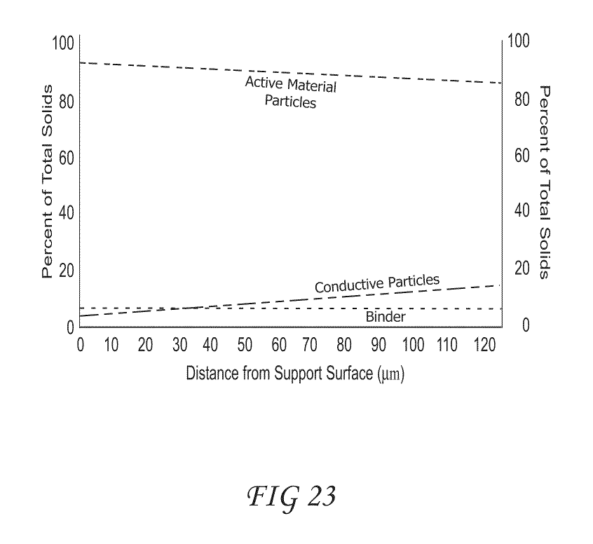

FIG. 23 represents a slight slope in change of particle percent of total solids for the active material and conductive particles.

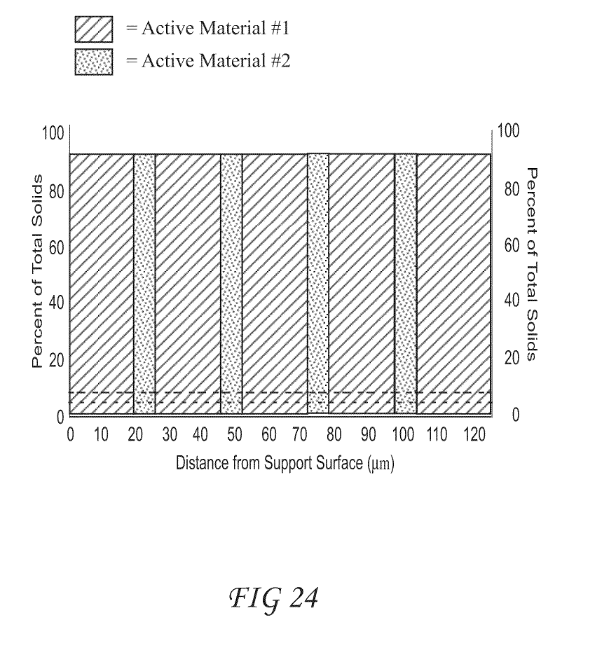

In some embodiments of the invention, electrode comprising two or more different active material particles may be formed using the methods and apparatuses of the invention. FIG. 24 graphically depicts an electrode having layers alternating between a first type of active material particles and a second type. A non-limiting example includes forming layers of carbon containing active material particles with layers formed from silicon active material particles. Not wishing to be bound by theory, but it is believed that one benefit of such an arrangement would be that the silicon expands when lithiated to exert force upon the carbonaceous layers to promote their integrity over repeated charge/discharge cycles.

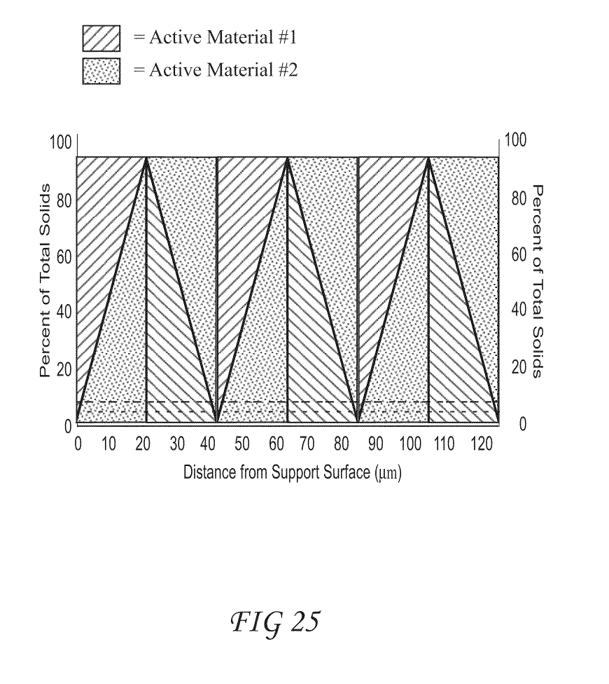

In some embodiments of the invention, the electrode may comprise layers, each layer comprising two or more different types of active material particles. An example of this scenario is represented in FIG. 25. Here, although each layer comprises two different types of active material particles, within each layer, the relative ratio of each particle varies as a function of distance from the surface of the electrode support.

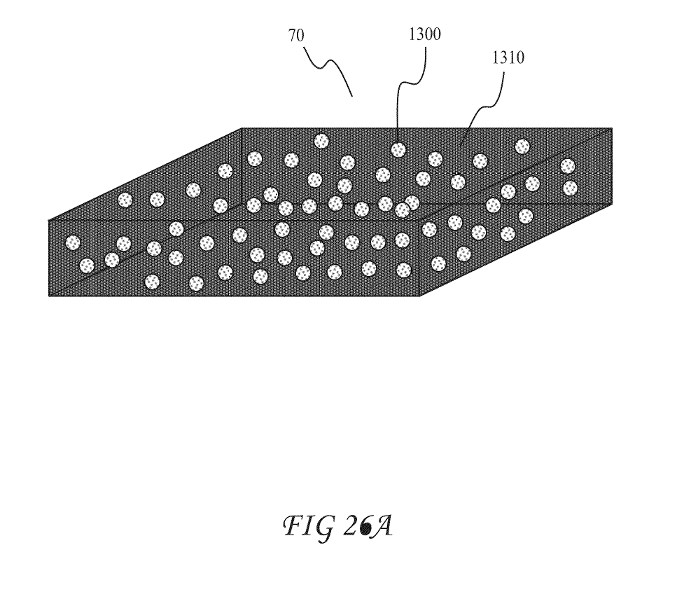

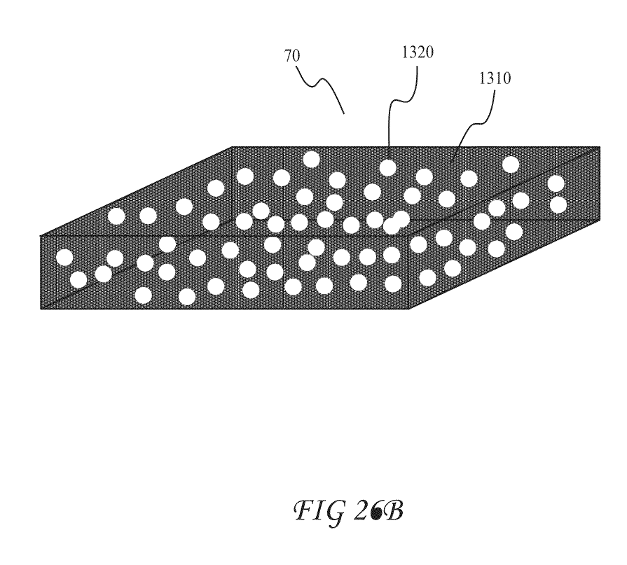

Electrode porosity can be varied, in one embodiment of the invention, by the inclusion of void forming particles into the electrode matrix, wherein the void forming particles provide regions of high ion mobility within the electrode when compared to regions not containing the void forming particles. A non-limiting example is provided in FIGS. 26A and 26B where, as shown in FIG. 26A, Void Forming Particles 1300 comprise a portion of Electrode 70, each Void Forming Particle 1300 being surrounded by Active Material Particle Matrix 1310. In some embodiments, Void Forming Particles 1300 are highly porous structures. In some embodiments, Void Forming Particles 1300 may, as shown in FIG. 26B, be dissolved away by a solvent that leaves Active Material Particle Matrix 1310 intact with Voids 1320 present where the Void Forming Particles 1300 once were situated. In use, Voids 1320 fill with electrolyte and solvent and serve as regions of high ion mobility within Electrode 70. Preferred void forming particles include, but are not limited to, gas-filled microballoons having a dimension below about 1 μm, preferably below about 500 nm. Other particles may suitable for forming voids are polymer particles capable of being dissolved using a solvent and/or glass microballoons that can be broken open during a calendaring step to create voids within the electrode matrix. Preferably, the voids form a gradient within an electrode, preferably a multi-layered electrode where the concentration of voids is greater in one layer than of at least one other layer.

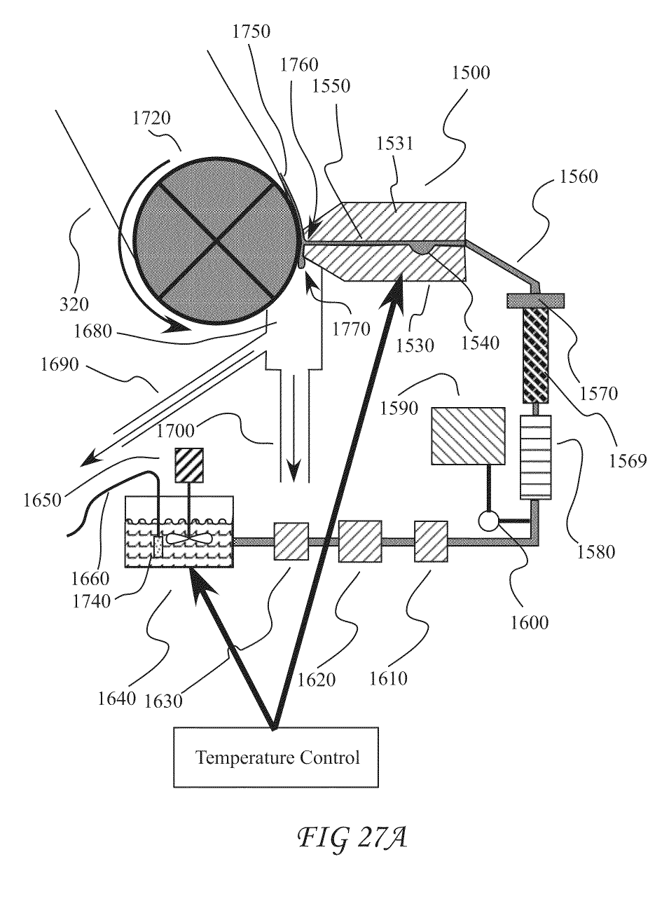

Another method for introducing voids within an electrode is shown in FIGS. 27A and 27B where dissolved gas forms Bubbles 1533 that grow in size as the pressure of the coating slurry decreases. Using the slot-die method, voids can be introduced into the electrode by dissolving gas under pressure into an electrode coating slurry prior to deposition onto an electrode support. FIG. 27A shows an exemplary slot-die coating system modified to produce electrodes having voids therein. Slot-Die 1500 comprises Top Die Plate 1531 and Bottom Die Plate 1530 having therebetween Flow Channel 1550 in fluid communication with Distribution Manifold 1540. Slot-Die 1500 is situated adjacent Roller 1720 that guides Roll Stock Current Collector 320 about Roller 1720 and in close proximity to Slot-Die 1500. Vacuum Box 1680 is in fluid communication with Vacuum Source 1690 and Waste Receiver 1700. Vacuum Box 1680 is situated adjacent Roller 1720 and Slot-Die 150 such that the lower pressure in Vacuum Box 1680 causes a Coating Slurry Eddy 1770 to form in a direction opposite of the movement of Roll Stock Current Collector 320. Coating slurry is mixed in Holding Tank 1640 by Mixer 1650. Air, or another gas is introduced into the coating slurry through Aerator 1740 which receives gas under pressure from Gas Supply Line 1660. The aerated coating slurry is pumped towards Slot-Die Coater 1500 by Pump 1630. The extent of aeration is controlled through a feedback-loop in conjunction with Bubble Controller 1610. If additional air or other additives are to-be added to the coating slurry, Inline Injector 1580 introduces the additional air/gas or additives held in Additive Tank 1590. The additional air/gas and/or additives are mixed into the coating slurry using Inline Mixer 1569. Flow rates are controlled by Flow Controller 1570 from which the coating slurry is introduced into Slot-Die 1500 through Feed Line 1560. Coating slurry emits from Slot 1760 to create Coating 1750 on Roll Stock Current Collector 320 as it passes by Slot 1760.

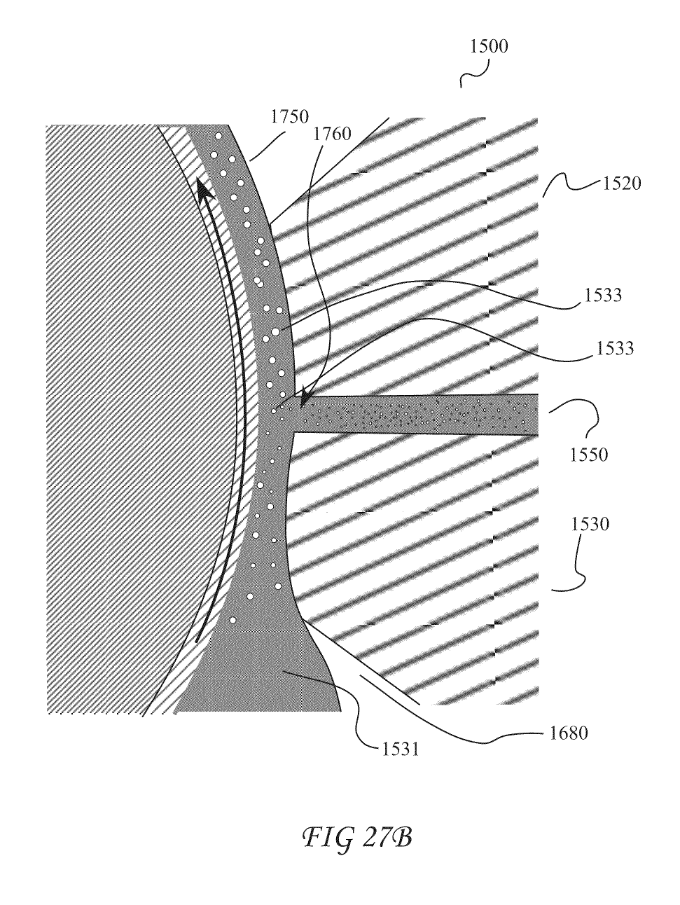

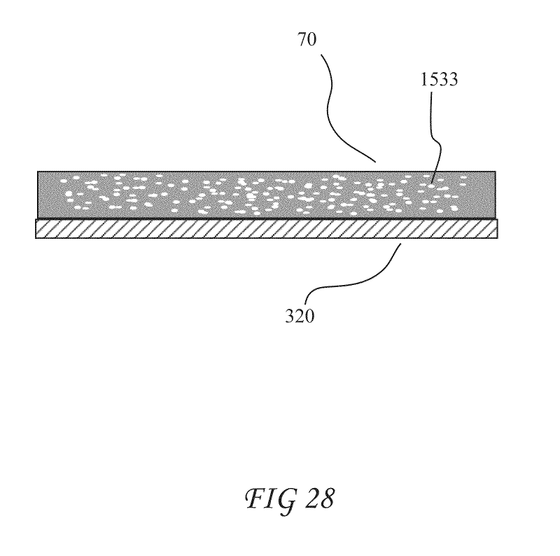

An exemplary electrode formed by dissolved gas depressurization is shown in FIG. 28 where Electrode 70 has Bubbles 1533 entrapped therein after drying. Other methods for forming voids from gas bubbles includes heating a wet-formed electrode to the boiling point of the solvent to cause gas bubble to form and remain entrapped due to the electrode being near dry. A variant is to introduce a bubble entrapping material such as binders. A preferred binder used to entrap bubbles into the electrode matrix is carboxymethyl cellulose combined with styrene/butadiene in an aqueous solvent or water. A non-limiting example includes adding 6% w/w of a 15% w/v solution of CMC/SBR obtained from LICO Technology Corporation, Taiwan, product number LHB-108P, to the electrode coating slurry and homogenized for about 30 minutes to entrap air and mix the mixture. No degassing step was performed, however, large bubbles on the surface of the slurry were removed with a drop of ethanol.

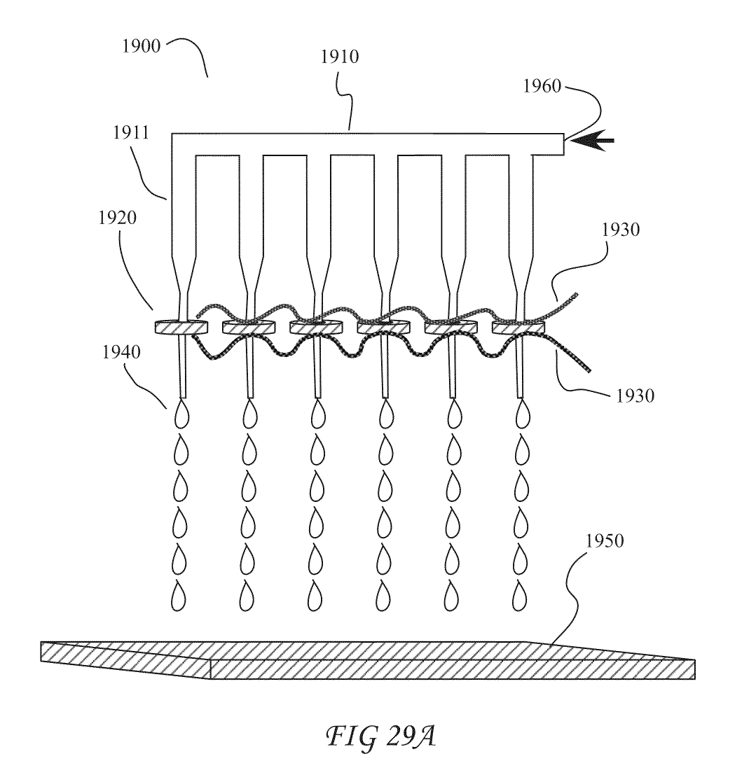

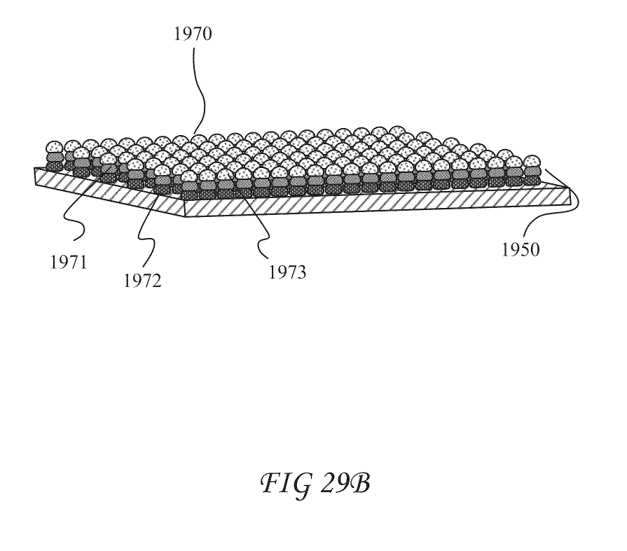

In another aspect of the invention, electrodes are formed by forming a plurality of small droplets. Ideally, drops ranging from 0.5 to 10 picoliters are preferred. Other sizes and ranges of sizes are suitable. In some embodiments, a droplet may have a diameter of about 100 nm to about 1.0 μl. FIG. 29A depicts an exemplary drop forming machine wherein drops are formed due to intermittent radial compression. Drop dispenser 1900 comprises Fluid Manifold 1910 having Inlet 1960 that coating suspension may enter Fluid Manifold 1910. Each Leg 1911 has associated therewith Ring Element 1920 that when energized by applying an electrical potential to Leads 1930, Ring Element 1920 compresses Leg 1911 to cause a fluidic shock wave that results in Droplet 1940 being ejected from the end of Leg 1911. By forming droplets, it is possible to arrange electrode formation in the x,y plane. By sequentially dropping different electrode compositions, a multi-layer electrode having x,y, and z spatial organization is possible. An example of an x,y and z dimension array is Arrayed Electrode 1970, shown in FIG. 29B, having individual Electrode Pillars 1950, each Pillar 1950 having multiple layers of Different Compositions 1971-1973 resembling a multi-layer, multi-flavor ice cream cone.

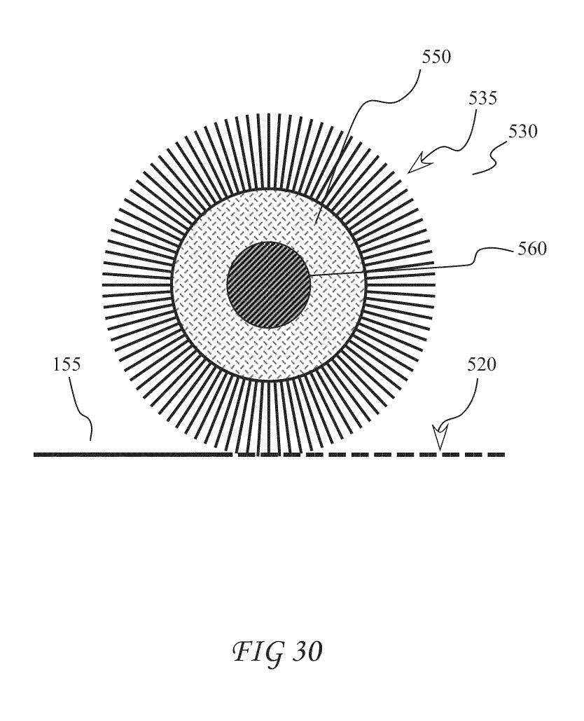

The invention provides, in another aspect, for apparatuses, methods and devices arising therefrom that have electrodes comprising gradients running in the x,y plane of the electrode, that is, parallel to the surface of the electrode support. In one embodiment, the invention provides for an electrode perforator. FIG. 30 depicts a side view of an Electrode Matrix Perforator 530 comprising an axle or shaft-way for supporting Perforator 530 above Roll Stock Current Collector 155. Pins 535 emanate from Core Roller 550 and when contacted with Roll Stock 155, form Perforations 520. In some embodiments, Pin 535 penetrates through the entire thickness of the electrode and electrode support. In other embodiments, Pin 535 penetrates only through the thickness of the electrode but not the electrode support. In some embodiments, Pin 535 may penetrate only part way through the electrode. In some embodiments, the partial electrode penetration by Pin 535 may be to a layer beneath a non-perforated subsequent layer, that is, a layer closer to the electrode support is perforated while at least one of the subsequent layers is not perforated. In some embodiments, an electrode or layer or layers of an electrode is perforated prior to drying, or while the electrode matrix is soft due to moisture, heat, or the presence of a solvent or solvent vapor.

FIG. 31 depicts a perspective view of an electrode matrix perforator similar to that shown in FIG. 30. Here, Perforator 530 rolls across the surface of a formed electrode or layer of an electrode and Perforations 520 result. Perforations 520 may later be filled with materials having desired properties. In some embodiments, Pores 520 may be filled with a electrolyte solution. In some embodiments, Pore 520 may be filled with a polymer electrolyte solution. In yet other embodiments, Pore 520 may be filled with a solid polymer electrolyte. In some embodiments, Pore 520 may be filled with an ion permeable material, a electrically conductive material, or a combination of both.

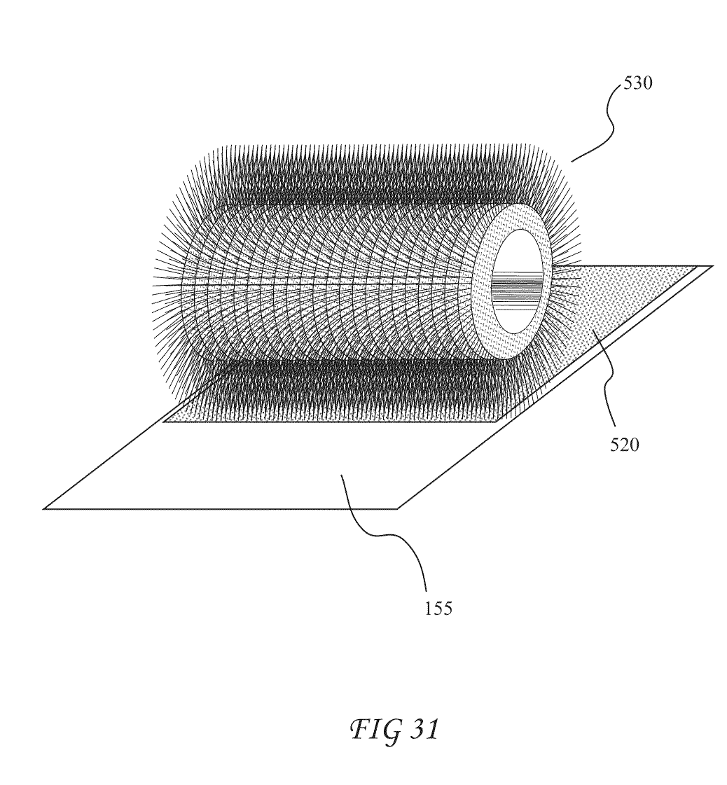

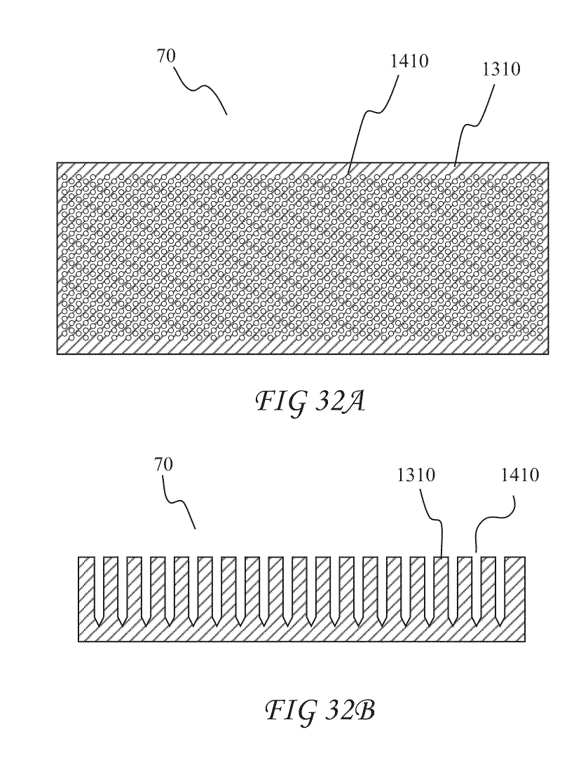

Plan and cross-sectional views of a perforated electrode or electrode layer are shown in FIGS. 32A and 32B. Electrode 70 comprising Active Material Particle Matrix 1310 with Pores 1410 are shown in plan view in FIG. 32A. The pores may be patterned or not patterned, and/or may be of different depths. FIG. 32B shows a cross-sectional view of Electrode 70 with Pores 1410 between walls of Active Material Particle Matrix 1310.

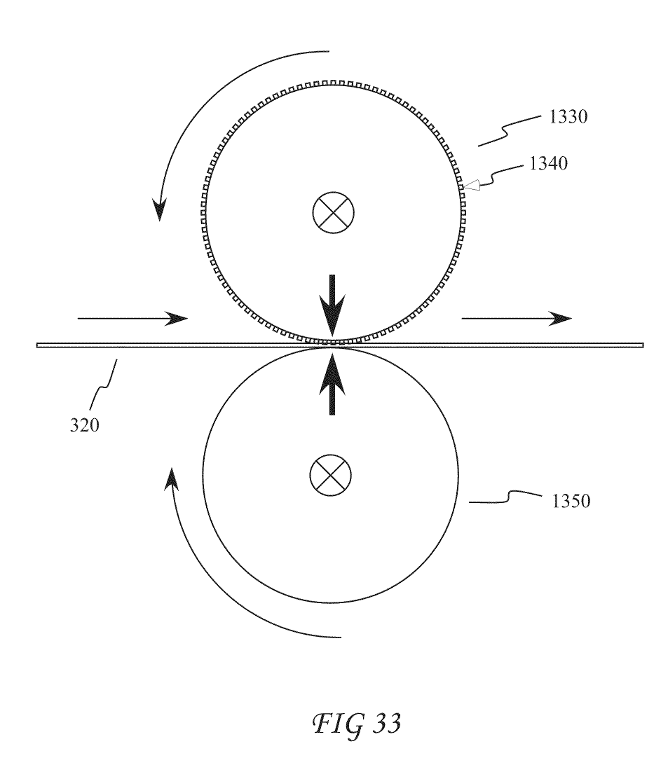

In another embodiments, an electrode or layer of an electrode may be dimpled by calendaring with a dimple roller. As shown in FIG. 33, instead of pins of a perforator, Protrusions 1340 of Dimple Roller 1330 press against an electrode coating on Roll Stock Current Collector 320 which is supported by Smooth Roller 1350. In some embodiments, Smooth Roller 33 may be replaced with another Dimple Roller 1330, not shown. In some embodiments, the Dimple Rollers 1330 may be synchronized to mate Protrusions 1340 during rolling. In some embodiments, Dimple Rollers 1330 may not be synchronized and/or may be asynchronous.

A perspective view of Dimple Roller 1330 and Smooth Roller 1350 is shown in FIG. 34 where Roll Stock Current Collector 320 having an electrode or layer of an electrode coated thereupon is being calendared to produce Dimples 1345.

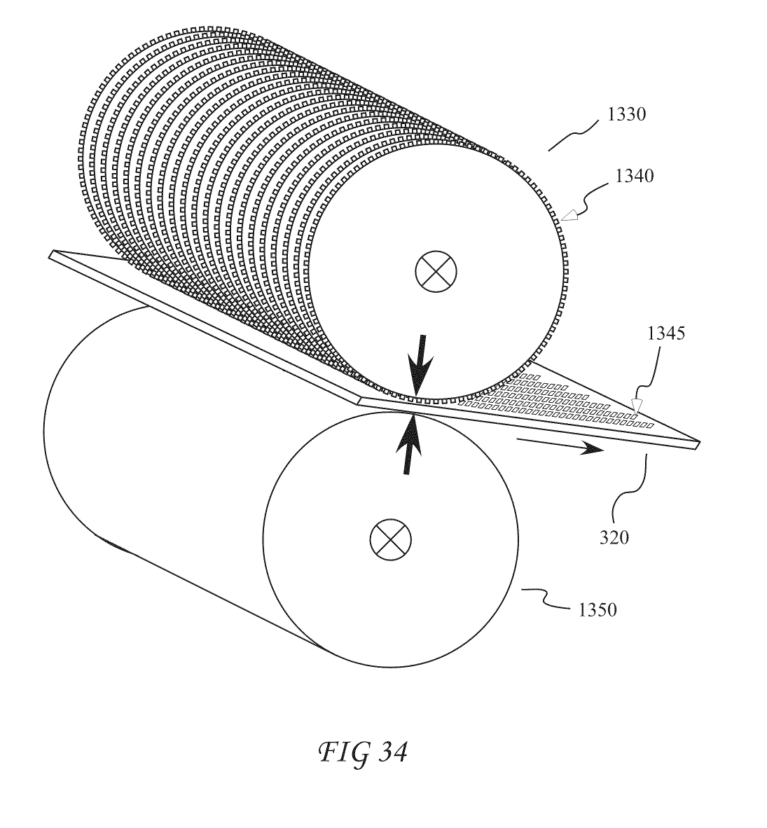

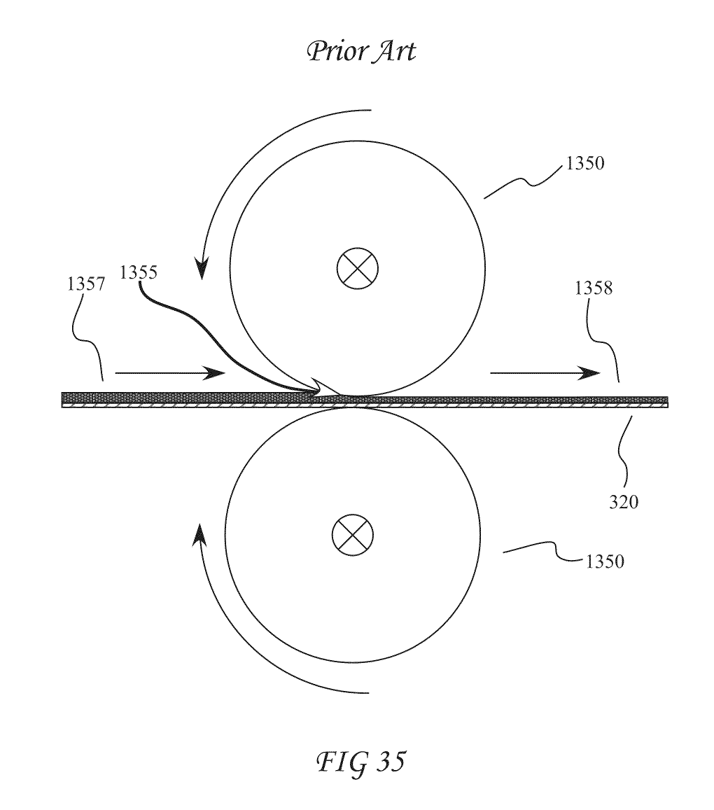

Calendaring is often an important step in the manufacture of an electrode. FIG. 35 shows a Calendaring Set-Up of the Prior Art where two Smooth Rollers 1350 are pressed together to compress and densify Electrode Coating 1357 into Densified Electrode Coating 1358 usually having a reduced z dimension and increased density. Densification occurs at Nip 1355 where Smooth Rollers 1350 reach their closest point or pinch point. The pressure applied at the nip typically is around 6000 pounds per linear inch of nip for energy cells, and about 3000 pounds per linear inch of nip for power cells.

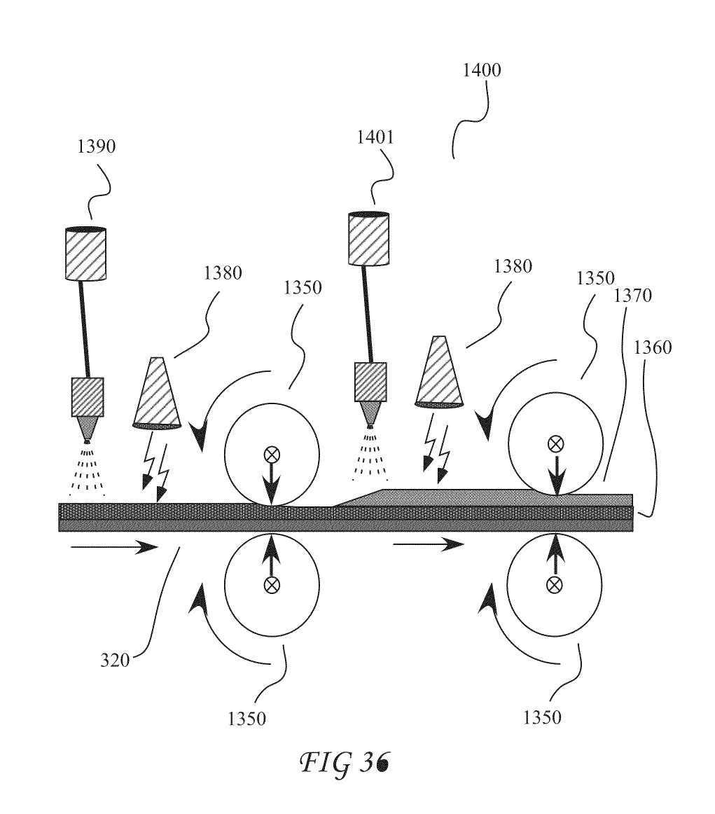

The invention, in one aspect, provides for a multi-calendar process wherein calendaring is performed after a layer is deposited and prior to the next layer being deposited. FIG. 36 depicts a coating/drying line that has intervening calendaring steps. Coating Line 1400 comprises First Spray System 1390 and Second Spray System 1401, each followed by Dryers 1380. After each Dryer 1380 is a calendar system. First Calendar System 1387 calendars First Layer 1360 prior to the deposition of Second Layer 1370 by Second Spray System 1401. After Second Layer 1370 is deposited and dried, Second Calendar System 1389 calendars Second Layer 1370 as well as First Layer 1360. Because First Layer 1360 has already been densified by First Calendar System 1387, the amount of further calendaring that subsequent calendaring steps, for example, Second Calendar System 1389 may, in some embodiments, be significant, or, in some embodiments, insignificant. Not wishing to be bound by theory, it is believed that step-wise calendaring of layers, rather than complete electrode matrices, provides for better control of denisification at each layer and throughout the electrode matrix. Moreover, step-wise calendaring allows for different layers having different compositions to be calendared to different extents. For example, calendaring forces may be lessened on layers farther away from the current collector to yield an electrode having a functional gradient of density (organizational and/or structural) that runs in about the z dimension of the electrode.

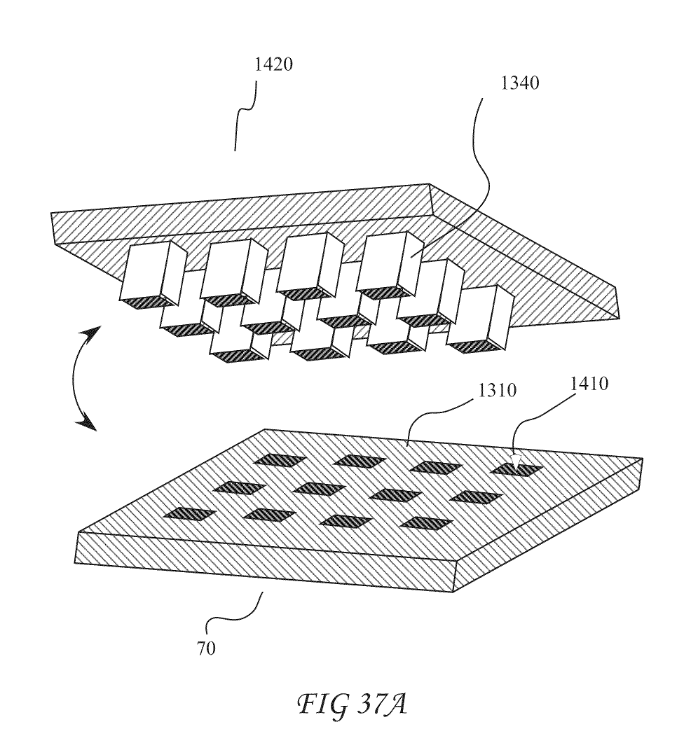

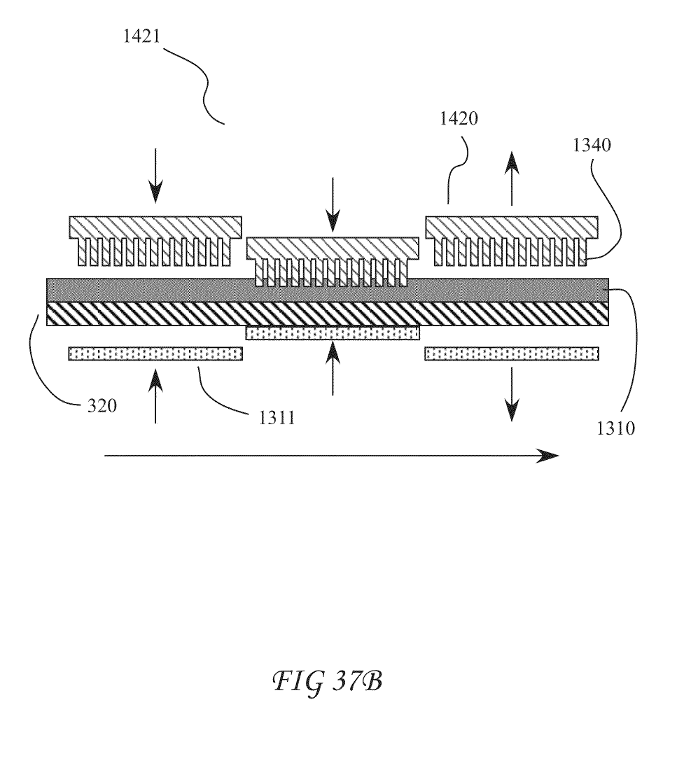

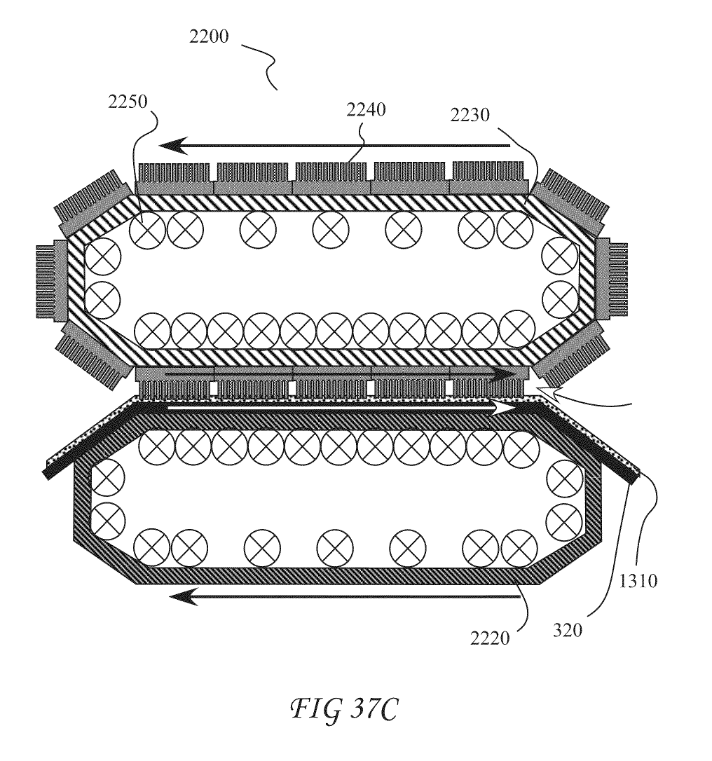

In another aspect, the invention provides methods and apparatus for calendaring electrodes. FIG. 37A shows a component of a calendaring system that instead of calendaring by compressing an electrode by passing it through the nip of two smooth rollers, as shown in FIG. 35, the electrode, and its support or current collector, is compressed between two platens to reduce or eliminate extruding the electrode out of the nip region. In FIG. 37A, Platen 1420 has Protrusions 1340 that simultaneously contact the surface of Electrode 70 to form Indentations 1410 surrounded by Active Material Particle Matrix 1310. When the method of FIG. 37A is applied to a moving Roll Stock Current Collector, as shown in FIG. 37B, Platen 1420 travels parallel and with Roll Stock Current Collector 320 having thereon Active Material Particle Matrix 1310. At the moment of calendaring, Platen 1420 in forced downward as Backing Plate 1311 is urged upward compress Active Material Particle Matrix 1310 followed by Platen 1420 and Backing Plate 1311 withdrawing away from Roll Stock Current Collector 320 once calendaring has occurred. In one embodiment, as shown in FIG. 37C, Continuous Track Calendar System 2200 comprises a plurality of Platens 1420 are associated with Track 2230 and Rollers 2250, similar to that of a tank or tractor track system, to move Platen 1420 along at the same pace of Roll Stock Current Collector 320 to calendar Active Material Particle Matrix 1310. Backing Plates 1311 are likewise associated with another Track 2230 and Rollers 2250 to provide a traveling support for calendaring. FIG. 37D shows a resulting calendared Roll Stock 320 having thereon Active Material Particle Matrix 1310 with Impressions 1410 therein. Electrodes produced using Continuous Track Calendar System 2200 can be continuous, or discontinuous, as shown in FIG. 37D wherein each electrode is spaced along Roll Stock Current Collector 320.

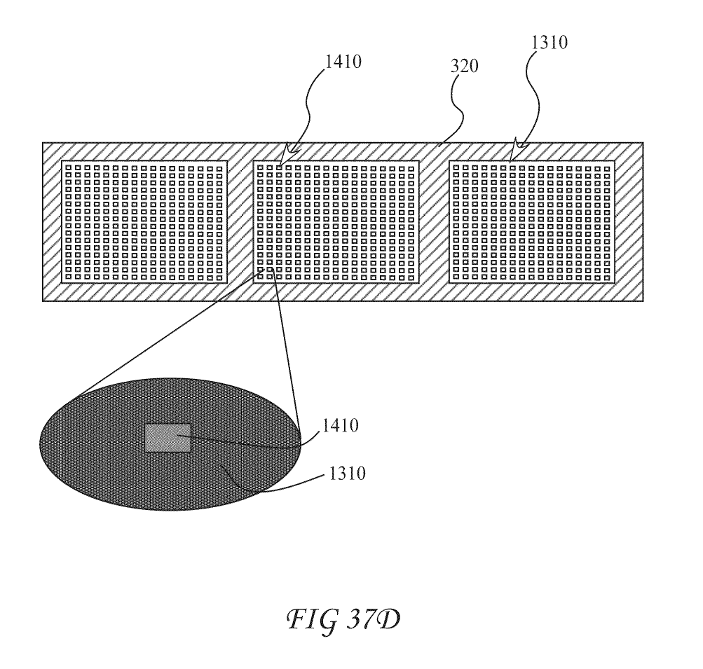

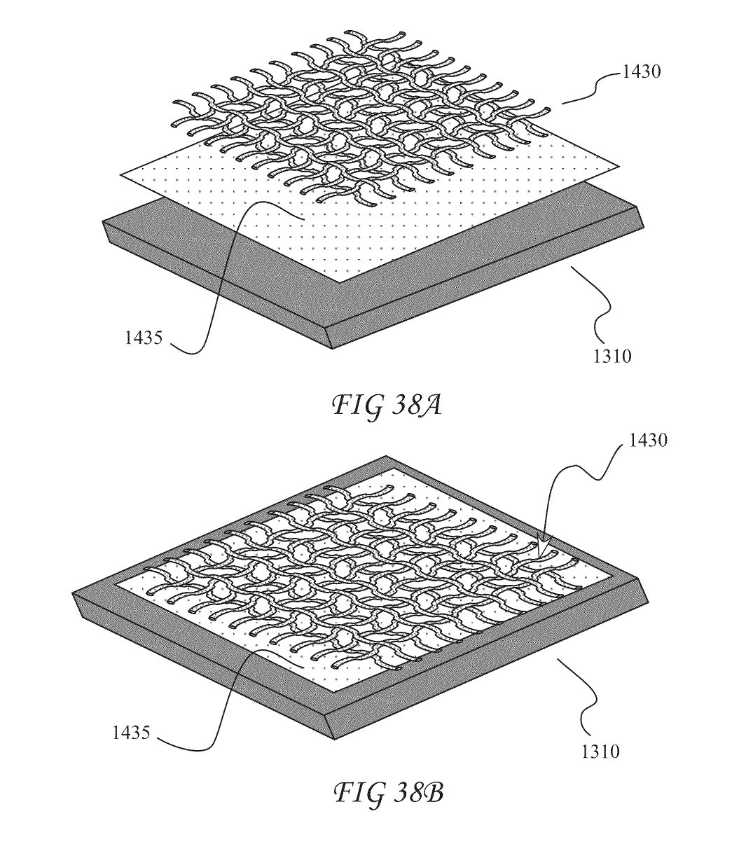

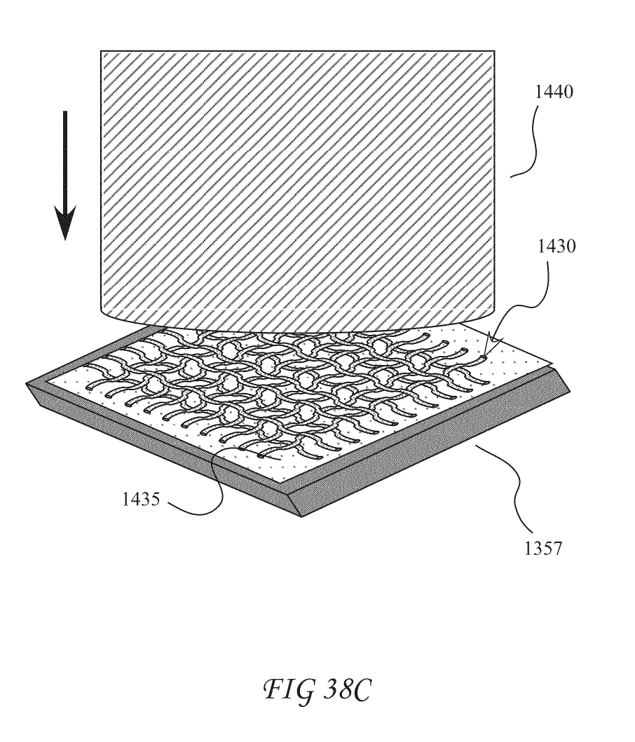

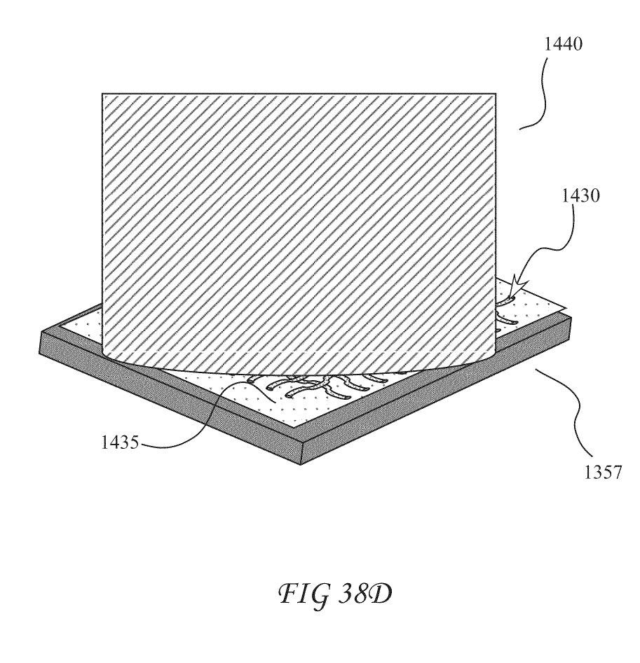

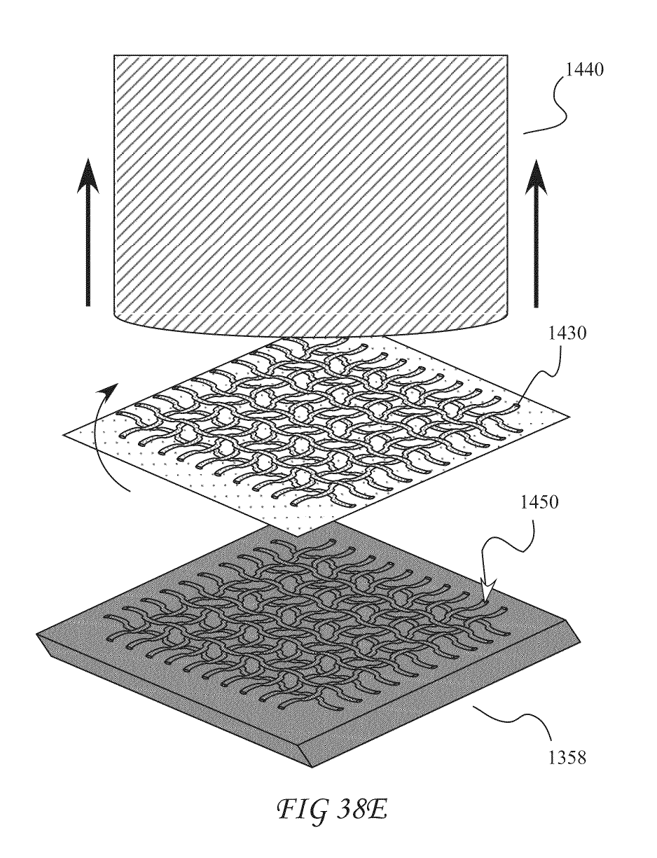

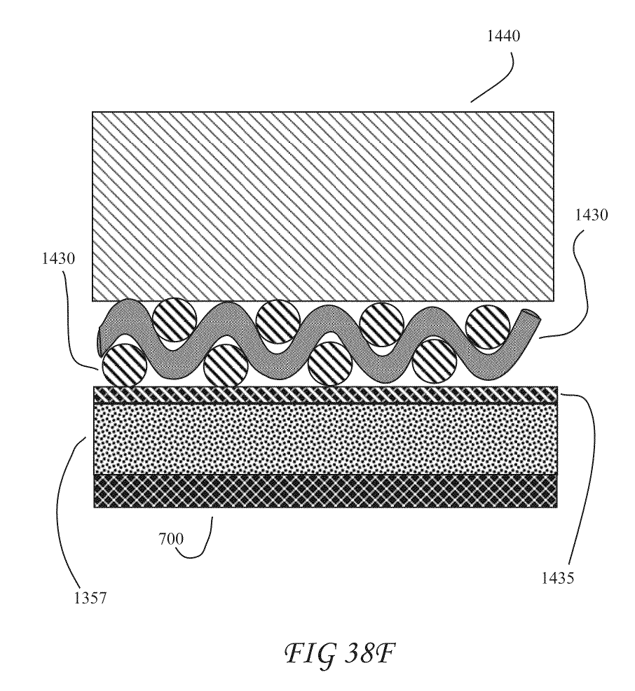

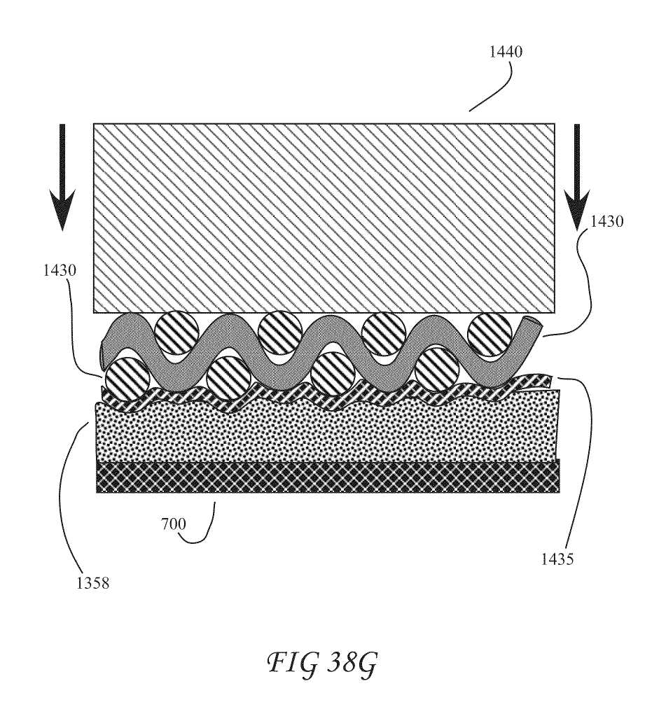

Impression patterns of high complexity can be calendared into electrodes using an embodiment of the invention as shown in FIGS. 38A through 38G. Here, Woven Mesh 1430 is used to imprint a complex pattern into Active Material Particle Matrix 1310 by direct embossment, or as shown in FIGS. 38A and 38B, indirect embossment where Flexible Sheet 1435 is placed between Woven Mesh 1430 and Active Material Particle Matrix 1310. FIG. 38C shows Press Piston 1440 being lowered upon the combination of FIG. 38B. FIG. 38D shows Press Piston 1440 making contact with the combination of FIG. 38B. FIG. 38E shows Press Piston 1440, along with Woven Mesh 1430 and Flexible Sheet 1435 being withdrawn from Active Material Particle Matrix 1310, leaving therein, Impression 1450. A cross-sectional view of the aforementioned process is shown in FIGS. 38F and 38G where the roll of Flexible Sheet 1435 is exemplified in FIG. 38G where Flexible Sheet 1435 serves to prevent Active Material Particle Matrix 1310 from pressing into and through Woven Mesh 1430.

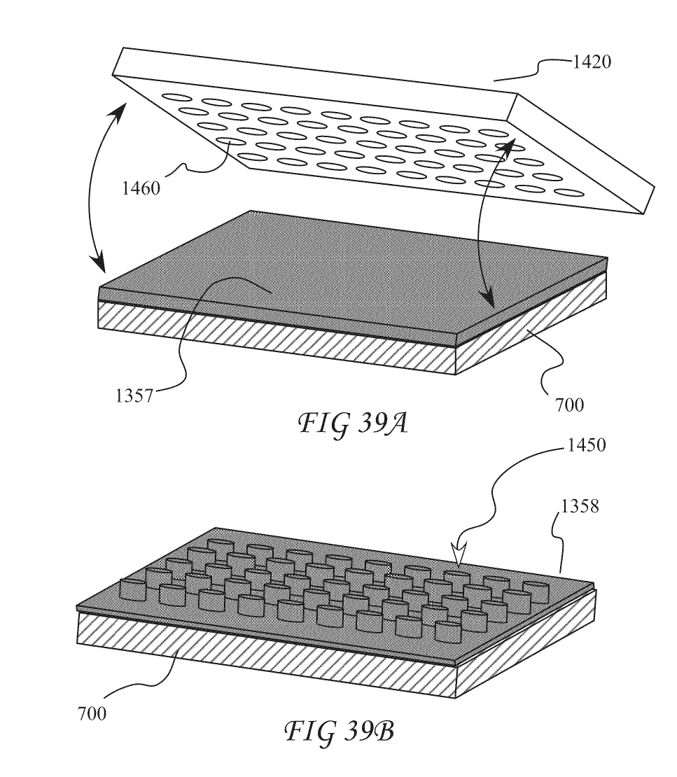

Yet another embodiment of the invention provides for a calendaring method and apparatus as shown in FIGS. 39A and 39B. Here, instead of Protrusions 1340 of Platen 1420 in FIG. 37A, Platen 1420 has Apertures 1460 that, when pressed into Active Material Particle Matrix 1357 upon Support 700, Pillars 1450 are formed with the surrounding regions being compressed, and, optionally, Pillars 1450 being compressed.

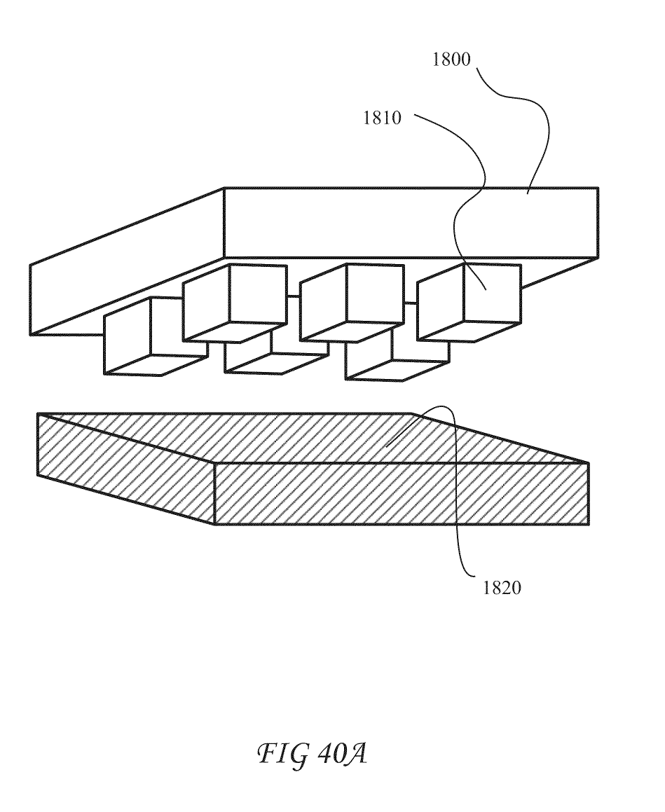

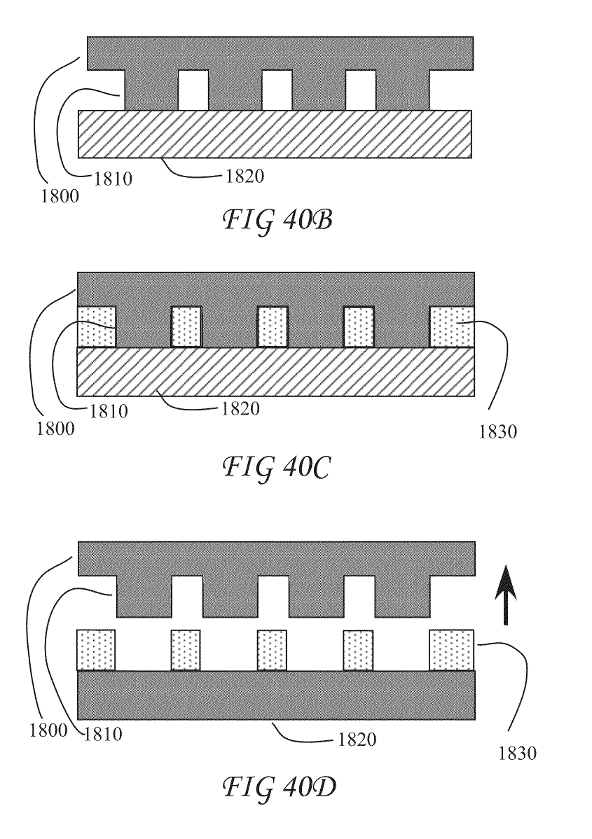

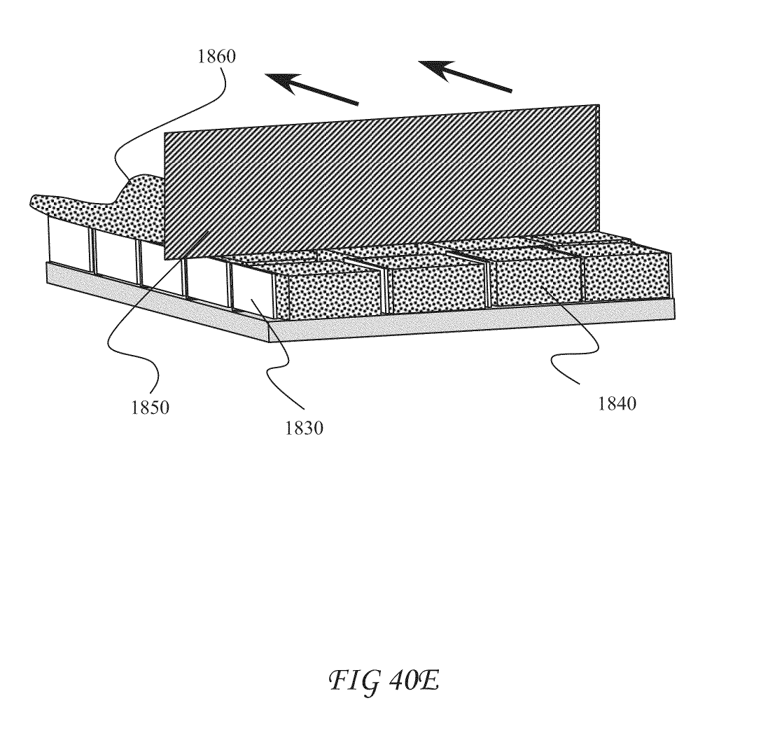

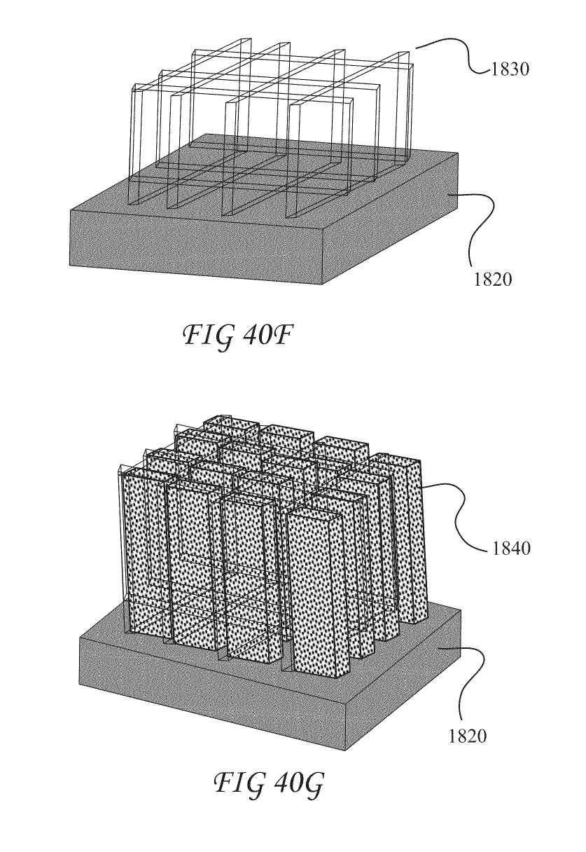

In another aspect, the invention provides for an electrode having a plurality of active material containing regions, each region separated from others by partitions, the partitions having a different composition than the active material containing regions and being ion permeable, and/or, electrically conductive. In some embodiments, the partitions may further comprise active material but having an overall composition different than the active material regions. FIGS. 40A through 40G show an exemplary method and apparatus for making electrodes having active material containing regions surrounded by partitions having a composition different from the active material regions, the partitions being ion permeable, and/or, electrically conductive.

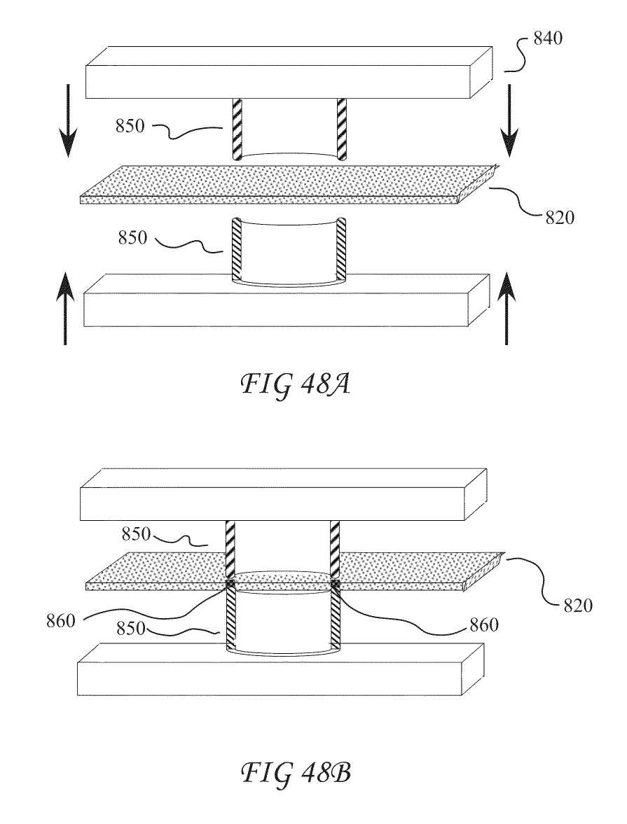

To form the partitions, Micromold 1800 having Protrusions 1810 is mated against Electrode Support 1820, as shown in FIG. 40A. FIG. 40B shows Micromold 1800 mated with Electrode Support 1820 in cross-sectional view. Once mated to form a mold, Partition Material 1830 is injected into the mold to form the partitions as shown in FIG. 48C. Once cured, Micromold 1800 is removed leaving cured Partitions 1830 adhered to Electrode Support 1820 as shown in FIG. 40D. Examples of suitable partition materials include polymers, organic and naturally occurring, gels, and slurries. The partition materials may include, but are not limited to, conductive particles, ion permeable materials, and, in some embodiments, active material particles. In highly preferred embodiments, the partitions comprises ion conductive polymers and electrically conductive particles. Ion conductive polymers include, but are not limited to, polymers used to make solid electrolytes for lithium ion batteries. In other embodiments, the partitions are temporary and are removed, dissolved, or otherwise converted to another material that remains in the partition location, and/or are diffused out of the electrode once formed. Active Material Composition 1860 is then filled into the spaces between Partitions 1830 to form Partitioned Active Material Compositions 1840. In some embodiments, Active Material Composition is introduced into the spaces defined by Partitions 1830 using Screed 1850, as shown in FIG. 40E. For clarity, FIG. 40F shows in wire frame Partitions 1830 adhered to Electrode Support 1820. FIG. 40G shows filled in Partitions 1830 with Partitioned Active Material Composition 1840 therebetween.

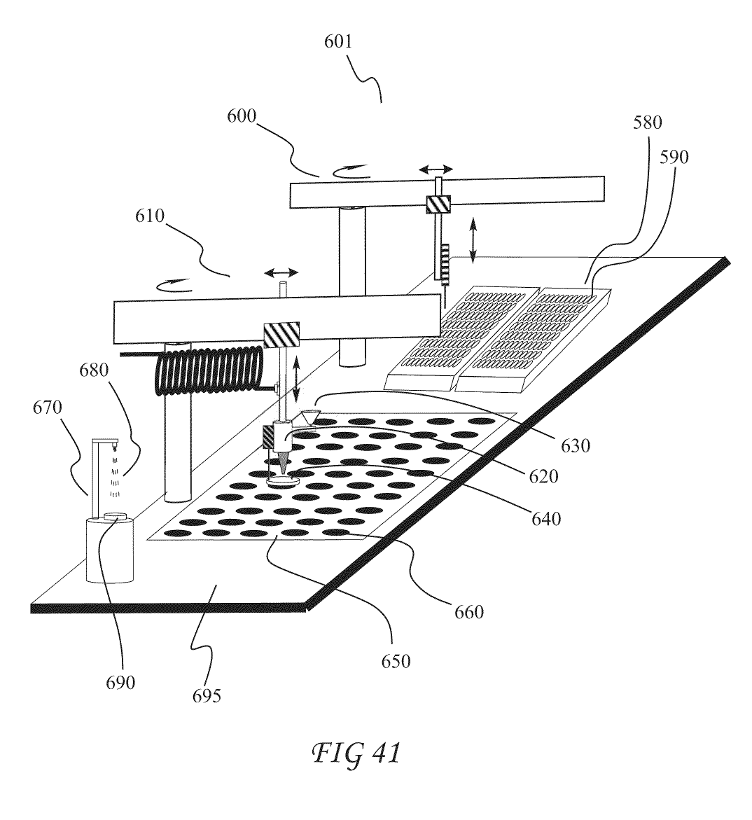

The invention provides, in another aspect, for apparatuses and methods for making arrays of electrodes wherein at least two of the electrodes in the array are different. Non-limiting examples of differences include compositional, organizational, structural, functional, loading, layer count, and other types of differences typically manifested when screening electrode candidates. FIG. 41 depicts a perspective view of an exemplary electrode array former used for high-throughput screening of candidate electrode configurations. Array Former 601 comprises Robot Sample Collector 600 having x, y, and z movement capability to aspirate and dispense solutions and suspensions residing in Wells 590 of Sample Plates 580. Once a sample has been acquired, Robot 600 transfers the sample to Sample Collection Cup 630 of Sprayer 620. Associated with Sprayer 620 is Spray/Drip Shield 640 that can articulate to block or unblock the spray path of Sprayer 620. Electrode Sheet Array 650 awaits deposition of the sample in an arrayed manner to form Electrodes 660 in a desired pattern. Between each deposition, Sprayer 620 self-cleans by situating Sample Collection Cup 630 under Washer 670 that sprays a Washing Solvent 680 into Sample Collection Cup 630 while activating Sprayer 620 and collecting the resulting wash spray in Waste Receptacle 690 to rinse out the prior sample. Once the wash step is complete, Sample Collection Cup is again reloaded with another sample acquired by Robot Sample Collector 600 from Plate 580. Array Former 601 can be manually operated, or, preferably, automated using a computer. In preferred embodiments, the computer includes a database to track sample location, information about spray depositions, and information about the formed Electrode Array 650, in particular, the nature and composition of each Electrode 660.

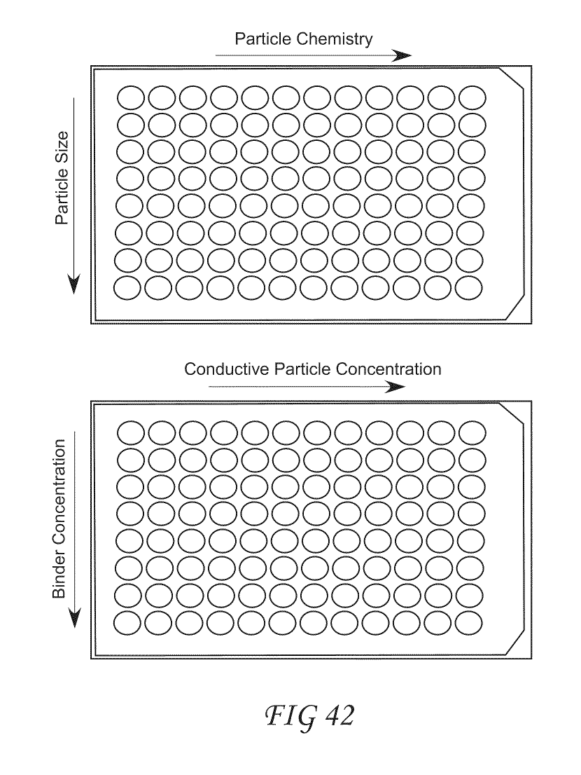

A close up view of Sample Plates 580 is shown in FIG. 42 which depicts two 96 well microtiter-type plates containing arrays of electrode coating suspensions for use with an array former such as the one depicted in FIG. 41. The upper Sample Plate 580 is arrayed by particle size and particle chemistry, whereas the lower Sample Plate 580 is arrayed with suspensions of differing binder concentration and conductive particle concentration.

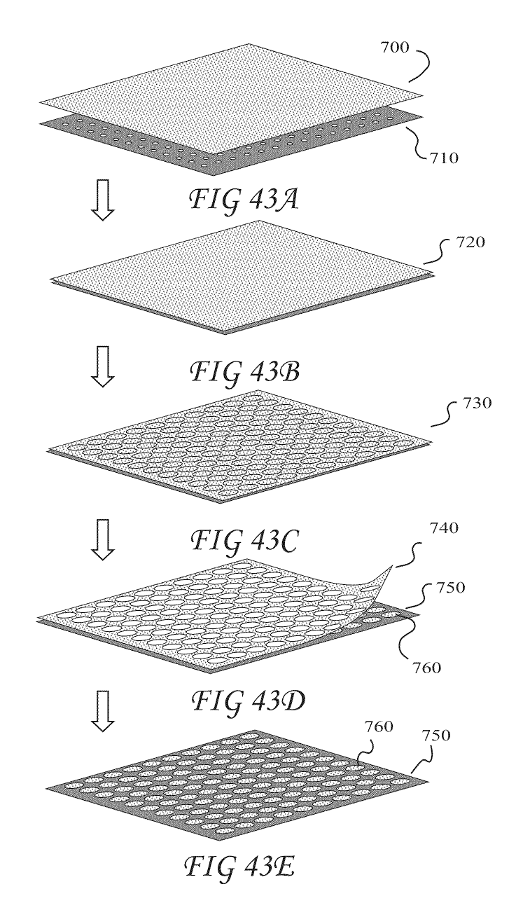

In another aspect, the invention provides for Sheet Electrode Arrays as shown in FIG. 43E. In FIGS. 43A through 43B, the method for making a Sheet Electrode Array is depicted. The Sheet Electrode Arrays shown in FIG. 43E can be used with an array former such as the one shown in FIG. 41. In FIGS. 43A through 43E, the process for making a Sheet Electrode Array 750 is shown in order of steps. In FIGS. 43A and 43B, depicted is the step of bonding Electrode Support Sheet 700, preferably a conductive electrode support to Perforated Backing Sheet 710 which has an adhesive thereupon to form a Perforated Backed Electrode Support Sheet 720. The perforations in Perforated Backing Sheet 710 allow for backside electrical access to Electrode Support Sheet 700, and its remnants as discussed below. Once bonded, Electrode Support Sheet 700 is die cut to form an array of shapes cut from Electrode Support Sheet 700 while leaving Perforated Backing Sheet 710 intact to form a die cut Electrode Support Array 730 as shown in FIG. 43C. The next step, shown in FIG. 43D is to remove Excess Electrode Support Sheet 740 leaving behind remnants thereof which become Electrode Supports 760 arrayed upon Sheet Electrode Array 750 wherein each Electrode Support 760 is in electrical and ionic isolation from the other Electrode Supports 760. Shown in FIG. 43E, Sheet Electrode Array 750 can then be coated using the array coater described above, or any other coating system or manually.

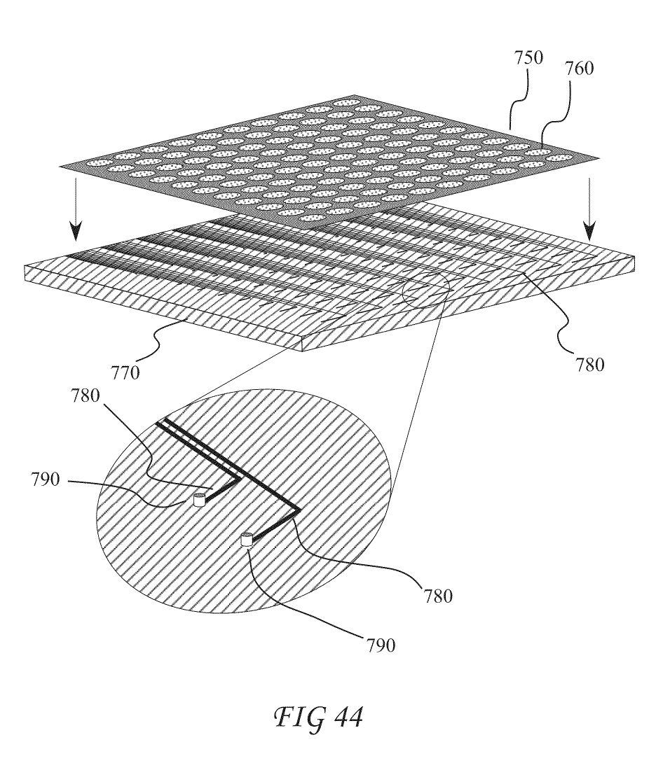

To facilitate the use of Sheet Electrode Arrays 750 as shown in FIG. 43E, the invention provides, in one embodiment, for Conductor Support Block 770, shown in FIG. 44. Here, a non-conductive support has associated therewith a plurality of Electrical Traces 780, each leading from a selected position within or upon Conductor Support Block 770 to a position within or upon Conductor Support Block 770 corresponding to a perforation within Perforated Backing Sheet 710 of Sheet Electrode Array 750 to establish electrical communication with Electrode Support 760 at the corresponding position within the array of Electrode Supports 760. Contact 790 facilitate establishing electrical communication between Electrode Support 760's back side that is exposed through the perforation of Perforated Backing Sheet 710. In preferred embodiments, Contact 790 is a spring loaded contact, preferably gold coated. Conductor Support Block 770 may comprise a plurality of layers to facilitate Electrical Traces 780, other mechanical items such as an electrical connector to connect Conductor Support Block to an external device, preferably a computer and/or battery tester apparatus, and to retain and support Contacts 790.

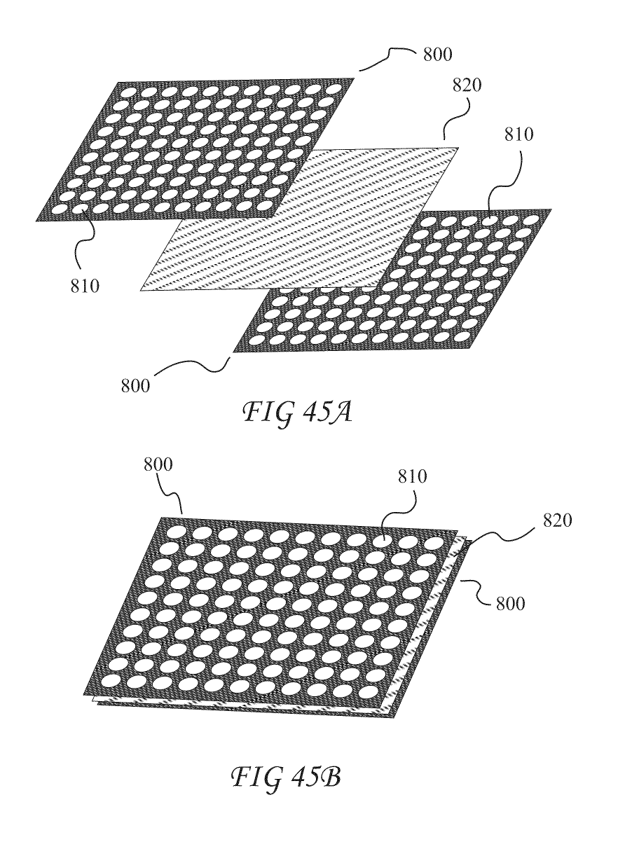

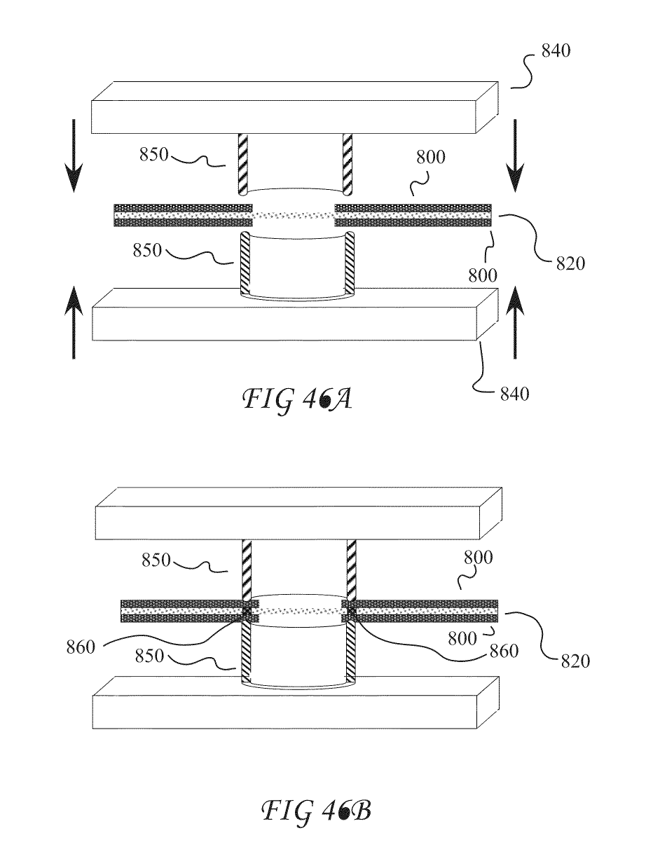

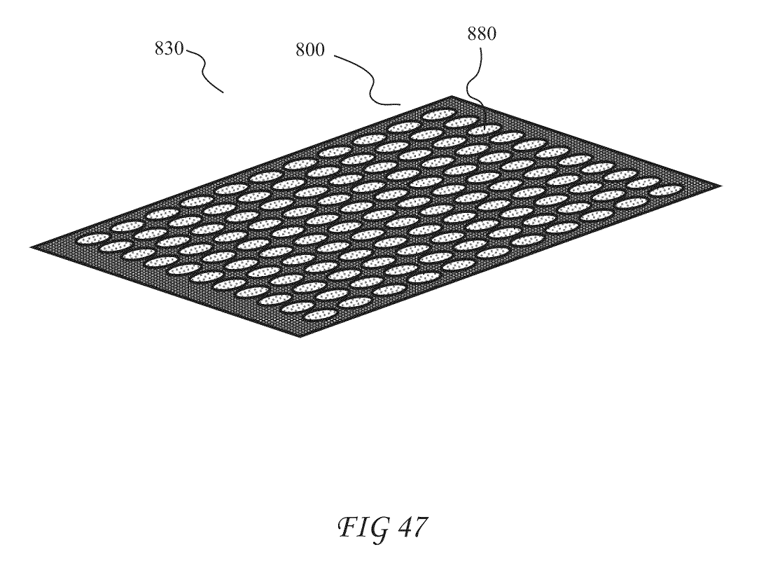

To facilitate the formation of battery cell arrays using Electrode Sheet Arrays 750, the invention provides, in another aspect, for methods and apparatuses for making arrays of individual separators. FIGS. 45A & 45B depict one embodiment of a separator array in exploded perspective and assembled perspective views. Here, Laminated Separator Array 830, Shown in complete in FIG. 47, is formed, by laminating Separator Sheet 820, comprising a heat deformable material that is ion permeable yet electrically non-conductive across its thickness, between Backing Sheets 800, each having Apertures 810 therein arrayed therein. Backing Sheets 800 can be made from any non-porous material, preferably polyester or polyimide. During lamination, as shown in FIGS. 46A & 46B, Seals 860 are formed within Separator Sheet 820 profiling Apertures 810. In some embodiments, one or both of Backing Sheets 800 partially melt to form all or part of Seal 860 around Apertures 810. In some embodiments, neither Backing Sheet 800 melts.

To electrically, fluidically, and ionically isolate each Separator 880 of Separator Sheet Array 830, a heat sealing die array is used. FIGS. 46A & 46B depict a jig and process used for making an embodiment of a separator array. Heat Seal Jigs 840 with Raised Shapes 850 are aligned to cause Raised Shapes 850 from a first Heat Seal Jig 840 to be in alignment with the Raised Shapes 850 of a second Heat Seal Jig 840 with Apertures 810 on the to-be-formed, and its Apertures 810 centered within Raised Shapes 850. Upon compression, the heat from Heat Seal Jigs 840 forms Seal 860 around Aperture by causing a small portion of Separator Sheet 820 to melt to close the pores or channels with the immediate area surrounding Aperture 810 to ionically, electrically, and fluidically isolate the separator material region with Aperture 810. The resulting Separator Sheet Array 830 is shown in FIG. 47 wherein Separator Aperture Array 800

FIGS. 48A & 48B depict a jig and process for making another embodiment of a separator array. Heat Seal Jigs 840 with Raised Shapes 850 are aligned to cause Raised Shapes 850 from a first Heat Seal Jig 840 to be in alignment with the Raised Shapes 850 of a second Heat Seal Jig 840 with Separator Sheet Array 830, and its Apertures 810 centered within Raised Shapes 850. Upon compression, the heat from Heat Seal Jigs 840 forms Seal 860 around Aperture 810 by causing a small portion of Separator Sheet 820 to melt to close the pores or channels with the immediate area surrounding Aperture 810 to ionically, electrically, and fluidically isolate the separator material region with Aperture 810.

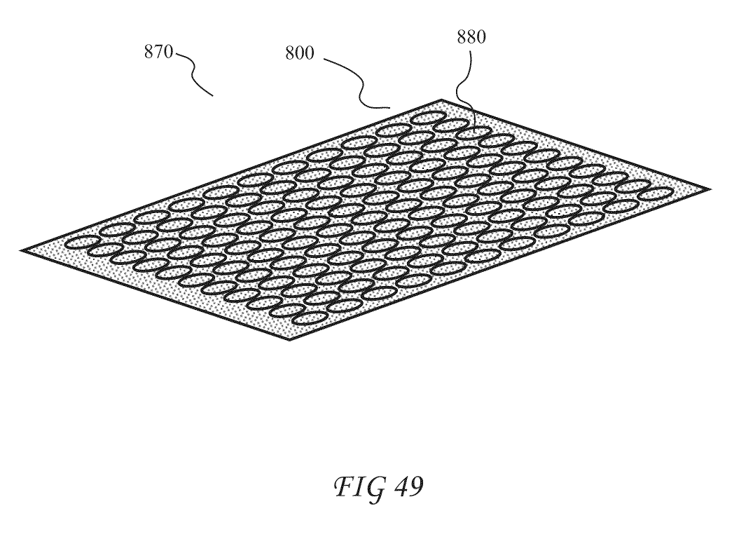

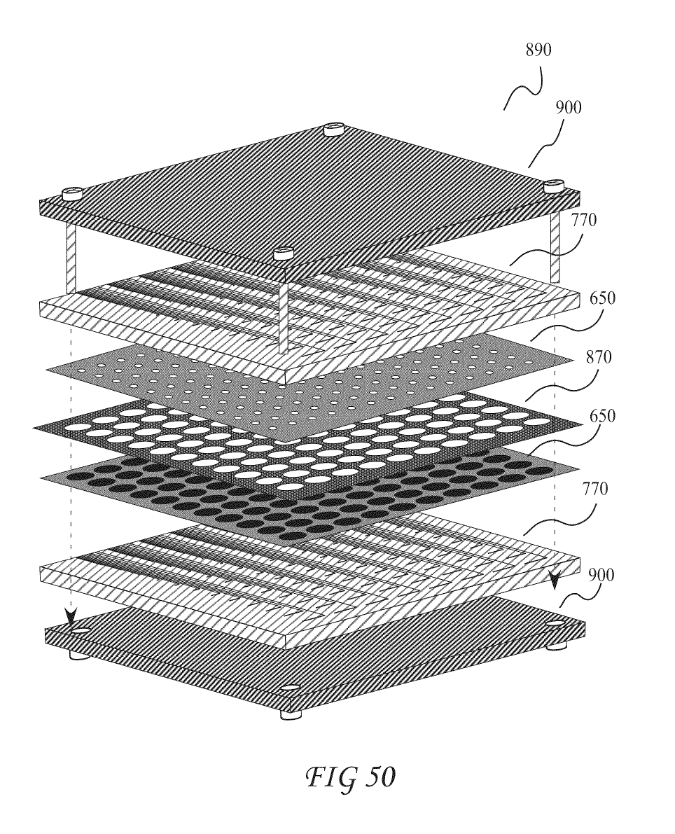

The result of the method depicted in FIGS. 48A & 48B is shown in FIG. 49 where Separator Array 870 formed from Separator Sheet 820 has a plurality of Separators 810

FIG. 50 depicts, in exploded perspective view, an electrode array testing apparatus useful with the electrode arrays, separator array, and other components depicted in FIGS. 43 through 49.

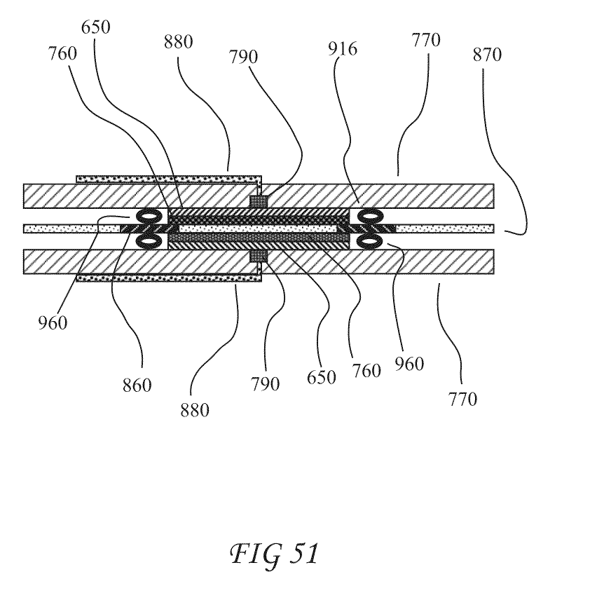

FIG. 51 depicts a cross-sectional view of an assembled electrode array testing apparatus.

We claim:

1. An electrode comprising:
a) a plurality of layers, each layer comprising:
i) active material particles capable of reversibly storing ions; and,
ii) conductive particles,
b) wherein said plurality of layers has at least one layer being functionally different from at least one other layer,
wherein the electrode comprises at least one functional gradient therein.

2. The electrode of claim 1 wherein said conductive particles comprise a conductive material selected from the group consisting of: buckyballs; buckminsterfullerenes; carbon; carbon black; ketjan black; carbon nanostructures; carbon nanotubes; carbon nanoballs; carbon fiber; graphite; graphene; graphitic sheets; graphite nanoparticles; and, potato graphite.

3. The electrode of claim 1 further comprising
a) a current collector having first and second sides; and,
b) a second electrode comprising:
i) active material particles capable of reversibly storing ions; and,
ii) conductive particles,
wherein said first electrode is attached to said first side of said current collector, and said second electrode is attached to said second side of said current collector.

4. The electrode of claim 1 further comprising
c) a current collector having first and second sides; and,
d) a second electrode comprising a plurality of layers, each layer comprising:
i) active material particles capable of reversibly storing ions; and,
ii) conductive particles,
wherein said plurality of layers has at least one layer being functionally different from at least one other layer,
wherein said first electrode is attached to said first side of said current collector, and said second electrode is attached to said second side of said current collector.

5.-42. (canceled)

43. The electrode of claim 1 wherein said active material particles comprise a titanium containing compound selected from the group consisting of: Li₂TiO₃; Li₄Ti₅O₁₂; Li₇Ti₅O₁₂; Li₄Ti₅₋ₓMₓO₁₂; Li₄Ti₅—ZM¹_{z1}M²_{z2}M³_{z3} . . . M^{k}_{zk}O₁₂; Li₄Ti_{5-x-b}MₓB_{b}O₁₂; Li₃₊ₐTi₆₋ₐ₋ₓMₓO₁₂, Li₃₊ₐTi_{6-a-x-b}MₓB_{b}O₁₂, and Li_{4-c}Mg_{c}Ti₅₋ₓMₓO₁₂, wherein _{Z} has a value from about 0.1 to about 2.5; _{z1, z2, z3, . . . zk} independently have a value from about 0 to about 2.5; Z and _{z1, z2, z3, . . . zk} satisfy the equation: Z=z1+z2+z3+ . . . zk; ₓ has a value from about 0.1 to about 2.5, ₐ has a value from about 0 to about 1, _{b} has a value from about 0 to about 2.5, and c has a value from about 0 to about 1.5; M is one or more cations selected from the group of V, Cr, Nb, Mo, Ta, and W; _{M1, M2, M3, . . .} _{Mk} are cations independently selected from the group of V, Cr, Nb, Mo, Ta, and W; and B is one or more cations selected from the group of Zr, Ce, Si, and Ge.

44.-79. (canceled)

80. The electrode of claim 1 wherein said active material particles comprise an olivine lithium metal phosphate material having the formula LixM′yM″zPO4,
iii) wherein M′ comprises a metal selected from the group consisting of: manganese and iron,
iv) wherein M′ comprises a metal selected from the group consisting of: manganese; cobalt; and, nickel,
v) wherein M′ is not the same as M″, and,
vi) wherein x is greater than or equal to 0, and x is less than or equal to 1.2; y is greater than or equal to 0.7, and y is less than or equal to 0.95; z is greater than or equal to 0.02, and z is greater than or equal to 0.3; and, said the sum of y and z is greater than or equal to 0.8, and the sum of y and z is less than or equal to 1.2.
vii)

81.-143. (canceled)

144. A method for making a battery electrode comprising said steps of:
a) providing an electrode support having a surface;
b) forming an electrode matrix upon said surface of the electrode support, said electrode matrix comprising:
i) active material particles, said active material particles being able to reversibly store ions; and,
ii) conductive particles,
wherein said electrode matrix has a gradient therein.

145. The method of claim 144 wherein said gradient is a functional gradient.

146. The method of claim 144 wherein said gradient runs substantially perpendicular to said surface of the electrode support.

147. The method of claim 144 wherein said electrode matrix is seamlessly formed.

148. The method of claim 144 wherein said gradient is continuous.

149. The method of claim 144 wherein said gradient is discontinuous.

150. The method of claim 144 wherein said electrode matrix is formed by spraying.

151. The method of claim 150 wherein said spraying is electro-spraying.

152. The method of claim 150 wherein said spraying is powder coating.

153.-189. (canceled)

190. A method for forming a plurality of electrodes, The method comprising said steps of:
a) providing a sheet array having first and second sides and comprising:
i) a non-electrically conductive support having a plurality of apertures arrayed within said sheet array, each aperture traversing from said first side to said second side; and,
ii) a plurality of electrode supports positionally arrayed upon said first side of said sheet array, the electrodes each comprising an electrode support comprising an electrically conductive material, the electrode support having first and second sides;
b) depositing a first electrode material upon said first side of a first of said plurality of the electrode supports;
c) depositing a second electrode material upon said first side of a second of said plurality of the electrode supports;
wherein said first electrode material is different from said second electrode material.

191.-213. (canceled)
